(19) United States
(12) Patent Application Publication
(10) Pub. No.: US 2026/0122700 A1
(43) Pub. Date: Apr. 30, 2026

(54) Extended Reality Media Management

(71) Applicant: Ofinno, LLC, Reston, VA (US)

(72) Inventors: SungDuck Chun, Fairfax, VA (US); Jian Xu, McLean, VA (US); Esmael Hejazi Dinan, McLean, VA (US); Kyungmin Park, Vienna, VA (US); Jinsook Ryu, Oakton, VA (US); Taehun Kim, Fairfax, VA (US); Stanislav Filin, Chantilly, VA (US); Sivapathalingham Sivavakeesar, Reston, VA (US)

(21) Appl. No.: 19/370,266

(22) Filed: Oct. 27, 2025

Related U.S. Application Data
(60) Provisional application No. 63/712,241, filed on Oct. 25, 2024.

(51) Int. Cl. H04W 76/12; H04W 24/08; H04W 76/30

(52) U.S. Cl. CPC H04W 76/12; H04W 24/08; H04W 76/30

(57) ABSTRACT

A first base station (BS) sends a first parameter indicating that the first BS configures protocol data unit (PDU) set importance (PSI) based discarding, for a PDU session, of a wireless device, terminated at the first BS. The first BS determines that resources of the first BS are congested, for the PDU session, and sends a general packet radio service tunneling protocol (GTP) message comprising a second parameter indicating activation of PSI based discarding for the PDU session.

### CROSS-REFERENCE TO RELATED APPLICATIONS

This application claims the benefit of U.S. Provisional Application No. 63/712,241, filed Oct. 25, 2024, which is hereby incorporated by reference in its entirety.

### BRIEF DESCRIPTION OF THE DRAWINGS

Examples of several of the various embodiments of the present disclosure are described herein with reference to the drawings.

Examples of several of the various embodiments of the present disclosure are described herein with reference to the drawings.

FIG. 1A and FIG. 1B illustrate example communication networks including an access network and a core network.

FIG. 2A, FIG. 2B, FIG. 2C, and FIG. 2D illustrate various examples of a framework for a service-based architecture within a core network.

FIG. 3 illustrates an example communication network including core network functions.

FIG. 4A and FIG. 4B illustrate example of core network architecture with multiple user plane functions and untrusted access.

FIG. 5 illustrates an example of a core network architecture for a roaming scenario.

FIG. 6 illustrates an example of network slicing.

FIG. 7A, FIG. 7B, and FIG. 7C illustrate a user plane protocol stack, a control plane protocol stack, and services provided between protocol layers of the user plane protocol stack.

FIG. 8 illustrates an example of a quality of service model for data exchange.

FIG. 9A, FIG. 9B, FIG. 9C, and FIG. 9D illustrate example states and state transitions of a wireless device.

FIG. 10 illustrates an example of a registration procedure for a wireless device.

FIG. 11 illustrates an example of a service request procedure for a wireless device.

FIG. 12 illustrates an example of a protocol data unit session establishment procedure for a wireless device.

FIG. 13 illustrates examples of components of the elements in a communications network.

FIG. 14A, FIG. 14B, FIG. 14C, and FIG. 14D illustrate various examples of physical core network deployments, each having one or more network functions or portions thereof.

FIG. 15 illustrates an aspect of an example embodiment according to the present disclosure.

FIG. 16 illustrates an aspect of an example embodiment according to the present disclosure.

FIG. 17 illustrates an aspect of an example embodiment according to the present disclosure.

FIG. 18 illustrates an aspect of an example embodiment according to the present disclosure.

FIG. 19 illustrates an aspect of an example embodiment according to the present disclosure.

FIG. 20A, and FIG. 20B are diagrams of an example multi connectivity as per an aspect of an embodiment of the present disclosure.

FIG. 21 illustrates an aspect of an example embodiment according to the present disclosure.

FIG. 22 illustrates an aspect of an example embodiment according to the present disclosure.

FIG. 23 illustrates an aspect of an example embodiment according to the present disclosure.

FIG. 24 illustrates an aspect of an example embodiment according to the present disclosure.

FIG. 25 illustrates an aspect of an example embodiment according to the present disclosure.

FIG. 26 illustrates an aspect of an example embodiment according to the present disclosure.

FIG. 27 illustrates an aspect of an example embodiment according to the present disclosure.

FIG. 28 illustrates an aspect of an example embodiment according to the present disclosure.

FIG. 29 illustrates an aspect of an example embodiment according to the present disclosure.

FIG. 30 illustrates an aspect of an example embodiment according to the present disclosure.

FIG. 31 illustrates an aspect of an example embodiment according to the present disclosure.

FIG. 32 illustrates an aspect of an example embodiment according to the present disclosure.

FIG. 33 illustrates an aspect of an example embodiment according to the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have one or more specific capabilities. When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases refer to a single instance of a particular element, but should not be interpreted to exclude other instances of that element. For example, a bicycle with two wheels may be described as having “a wheel”. Any term that ends with the suffix “(s)” is to be interpreted as “at least one” and/or “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described.

The phrases “based on”, “in response to”, “depending on”, “employing”, “using”, and similar phrases indicate the presence and/or influence of a particular factor and/or condition on an event and/or action, but do not exclude unenumerated factors and/or conditions from also being present and/or influencing the event and/or action. For example, if action X is performed “based on” condition Y, this is to be interpreted as the action being performed “based at least on” condition Y. For example, if the performance of action X is performed when conditions Y and Z are both satisfied, then the performing of action X may be described as being “based on Y”.

The term “configured” may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, a parameter may comprise one or more information objects, and an information object may comprise one or more other objects. For example, if parameter J comprises parameter K, and parameter K comprises parameter L, and parameter L comprises parameter M, then J comprises L, and J comprises M. A parameter may be referred to as a field or information element. In an example embodiment, when one or more messages comprise a plurality of parameters, it implies that a parameter in the plurality of parameters is in at least one of the one or more messages, but does not have to be in each of the one or more messages.

This disclosure may refer to possible combinations of enumerated elements. For the sake of brevity and legibility, the present disclosure does not explicitly recite each and every permutation that may be obtained by choosing from a set of optional features. The present disclosure is to be interpreted as explicitly disclosing all such permutations. For example, the seven possible combinations of enumerated elements A, B, C consist of: (1) “A”; (2) “B”; (3) “C”; (4) “A and B”; (5) “A and C”; (6) “B and C”; and (7) “A, B, and C”. For the sake of brevity and legibility, these seven possible combinations may be described using any of the following interchangeable formulations: “at least one of A, B, and C”; “at least one of A, B, or C”; “one or more of A, B, and C”; “one or more of A, B, or C”; “A, B, and/or C”. It will be understood that impossible combinations are excluded. For example, “X and/or not-X” should be interpreted as “X or not-X”. It will be further understood that these formulations may describe alternative phrasings of overlapping and/or synonymous concepts, for example, “identifier, identification, and/or ID number”.

This disclosure may refer to sets and/or subsets. As an example, set X may be a set of elements comprising one or more elements. If every element of X is also an element of Y, then X may be referred to as a subset of Y. In this disclosure, only non-empty sets and subsets are considered. For example, if Y consists of the elements Y1, Y2, and Y3, then the possible subsets of Y are {Y1, Y2, Y3}, {Y1, Y2}, {Y1, Y3}, {Y2, Y3}, {Y1}, {Y2}, and {Y3}.

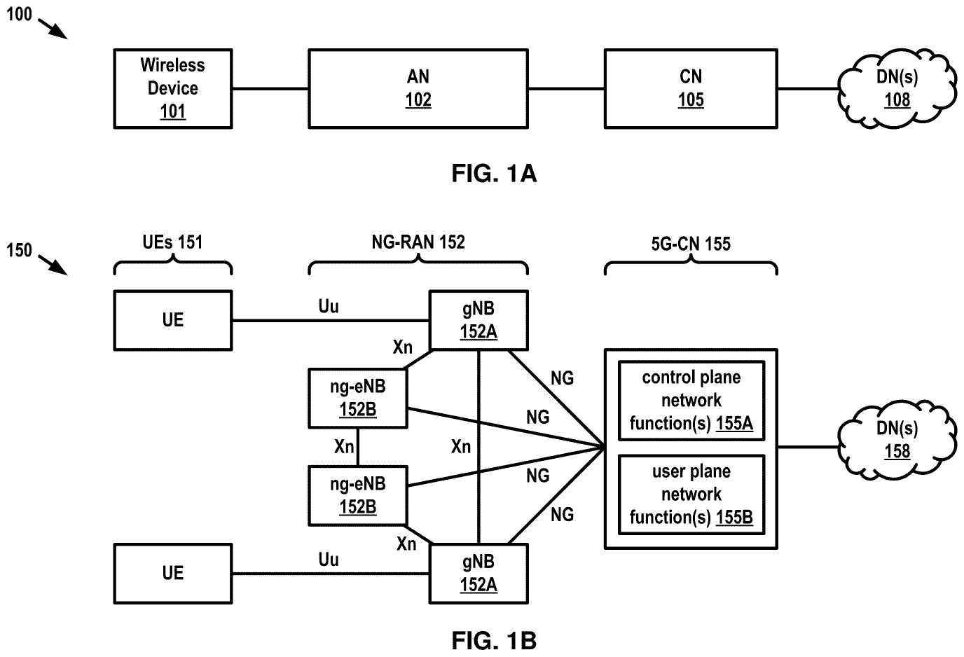

FIG. 1A illustrates an example of a communication network 100 in which embodiments of the present disclosure may be implemented. The communication network 100 may comprise, for example, a public land mobile network (PLMN) run by a network operator. As illustrated in FIG. 1A, the communication network 100 includes a wireless device 101, an access network (AN) 102, a core network (CN) 105, and one or more data network (DNs) 108.

The wireless device 101 may communicate with DNs 108 via AN 102 and CN 105. In the present disclosure, the term wireless device may refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, unmanned aerial vehicle, urban air mobility, and/or any combination thereof. The term wireless device encompasses other terminology, including user equipment (UE), user terminal (UT), access terminal (AT), mobile station, handset, wireless transmit and receive unit (WTRU), and/or wireless communication device.

The AN 102 may connect wireless device 101 to CN 105 in any suitable manner. The communication direction from the AN 102 to the wireless device 101 is known as the downlink and the communication direction from the wireless device 101 to AN 102 is known as the uplink. Downlink transmissions may be separated from uplink transmissions using frequency division duplexing (FDD), time-division duplexing (TDD), and/or some combination of the two duplexing techniques. The AN 102 may connect to wireless device 101 through radio communications over an air interface. An access network that at least partially operates over the air interface may be referred to as a radio access network (RAN). The CN 105 may set up one or more end-to-end connection between wireless device 101 and the one or more DNs 108. The CN 105 may authenticate wireless device 101 and provide charging functionality.

In the present disclosure, the term base station may refer to and encompass any element of AN 102 that facilitates communication between wireless device 101 and AN 102. Access networks and base stations have many different names and implementations. The base station may be a terrestrial base station fixed to the earth. The base station may be a mobile base station with a moving coverage area. The base station may be in space, for example, on board a satellite. For example, WiFi and other standards may use the term access point. As another example, the Third-Generation Partnership Project (3GPP) has produced specifications for three generations of mobile networks, each of which uses different terminology. Third Generation (3G) and/or Universal Mobile Telecommunications System (UMTS) standards may use the term Node B. 4G, Long Term Evolution (LTE), and/or Evolved Universal Terrestrial Radio Access (E-UTRA) standards may use the term Evolved Node B (eNB). 5G and/or New Radio (NR) standards may describe AN 102 as a next-generation radio access network (NG-RAN) and may refer to base stations as Next Generation eNB (ng-eNB) and/or Generation Node B (gNB). Future standards (for example, 6G, 7G, 8G) may use new terminology to refer to the elements which implement the methods described in the present disclosure (e.g., wireless devices, base stations, ANs, CNs, and/or components thereof). A base station may be implemented as a repeater or relay node used to extend the coverage area of a donor node. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The AN 102 may include one or more base stations, each having one or more coverage areas. The geographical size and/or extent of a coverage area may be defined in terms of a range at which a receiver of AN 102 can successfully receive transmissions from a transmitter (e.g., wireless device 101) operating within the coverage area (and/or vice-versa). The coverage areas may be referred to as sectors or cells (although in some contexts, the term cell refers to the carrier frequency used in a particular coverage area, rather than the coverage area itself). Base stations with large coverage areas may be referred to as macrocell base stations. Other base stations cover smaller areas, for example, to provide coverage in areas with weak macrocell coverage, or to provide additional coverage in areas with high traffic (sometimes referred to as hotspots). Examples of small cell base stations include, in order of decreasing coverage area, microcell base stations, picocell base stations, and femtocell base stations or home base stations. Together, the coverage areas of the base stations may provide radio coverage to wireless device 101 over a wide geographic area to support wireless device mobility.

A base station may include one or more sets of antennas for communicating with the wireless device 101 over the air interface. Each set of antennas may be separately controlled by the base station. Each set of antennas may have a corresponding coverage area. As an example, a base station may include three sets of antennas to respectively control three coverage areas on three different sides of the base station. The entirety of the base station (and its corresponding antennas) may be deployed at a single location. Alternatively, a controller at a central location may control one or more sets of antennas at one or more distributed locations. The controller may be, for example, a baseband processing unit that is part of a centralized or cloud RAN architecture. The baseband processing unit may be either centralized in a pool of baseband processing units or virtualized. A set of antennas at a distributed location may be referred to as a remote radio head (RRH).

FIG. 1B illustrates another example communication network 150 in which embodiments of the present disclosure may be implemented. The communication network 150 may comprise, for example, a PLMN run by a network operator. As illustrated in FIG. 1B, communication network 150 includes UEs 151, a next generation radio access network (NG-RAN) 152, a 5G core network (5G-CN) 155, and one or more DNs 158. The NG-RAN 152 includes one or more base stations, illustrated as generation node Bs (gNBs) 152A and next generation evolved Node Bs (ng eNBs) 152B. The 5G-CN 155 includes one or more network functions (NFs), including control plane functions 155A and user plane functions 155B. The one or more DNs 158 may comprise public DNs (e.g., the Internet), private DNs, and/or intra-operator DNs. Relative to corresponding components illustrated in FIG. 1A, these components may represent specific implementations and/or terminology.

The base stations of the NG-RAN 152 may be connected to the UEs 151 via Uu interfaces. The base stations of the NG-RAN 152 may be connected to each other via Xn interfaces. The base stations of the NG-RAN 152 may be connected to 5G CN 155 via NG interfaces. The Uu interface may include an air interface. The NG and Xn interfaces may include an air interface, or may consist of direct physical connections and/or indirect connections over an underlying transport network (e.g., an internet protocol (IP) transport network).

Each of the Uu, Xn, and NG interfaces may be associated with a protocol stack. The protocol stacks may include a user plane (UP) and a control plane (CP). Generally, user plane data may include data pertaining to users of the UEs 151, for example, internet content downloaded via a web browser application, sensor data uploaded via a tracking application, or email data communicated to or from an email server. Control plane data, by contrast, may comprise signaling and messages that facilitate packaging and routing of user plane data so that it can be exchanged with the DN(s). The NG interface, for example, may be divided into an NG user plane interface (NG-U) and an NG control plane interface (NG-C). The NG-U interface may provide delivery of user plane data between the base stations and the one or more user plane network functions 155B. The NG-C interface may be used for control signaling between the base stations and the one or more control plane network functions 155A. The NG-C interface may provide, for example, NG interface management, UE context management, UE mobility management, transport of NAS messages, paging, PDU session management, and configuration transfer and/or warning message transmission. In some cases, the NG C interface may support transmission of user data (for example, a small data transmission for an IoT device).

One or more of the base stations of the NG-RAN 152 may be split into a central unit (CU) and one or more distributed units (DUs). A CU may be coupled to one or more DUs via an F1 interface. The CU may handle one or more upper layers in the protocol stack and the DU may handle one or more lower layers in the protocol stack. For example, the CU may handle RRC, PDCP, and SDAP, and the DU may handle RLC, MAC, and PHY. The one or more DUs may be in geographically diverse locations relative to the CU and/or each other. Accordingly, the CU/DU split architecture may permit increased coverage and/or better coordination.

The gNBs 152A and ng-eNBs 152B may provide different user plane and control plane protocol termination towards the UEs 151. For example, the gNB 154A may provide new radio (NR) protocol terminations over a Uu interface associated with a first protocol stack. The ng eNBs 152B may provide Evolved UMTS Terrestrial Radio Access (E UTRA) protocol terminations over a Uu interface associated with a second protocol stack.

The 5G-CN 155 may authenticate UEs 151, set up end-to-end connections between UEs 151 and the one or more DNs 158, and provide charging functionality. The 5G-CN 155 may be based on a service-based architecture, in which the NFs making up the 5G-CN 155 offer services to each other and to other elements of the communication network 150 via interfaces. The 5G-CN 155 may include any number of other NFs and any number of instances of each NF.

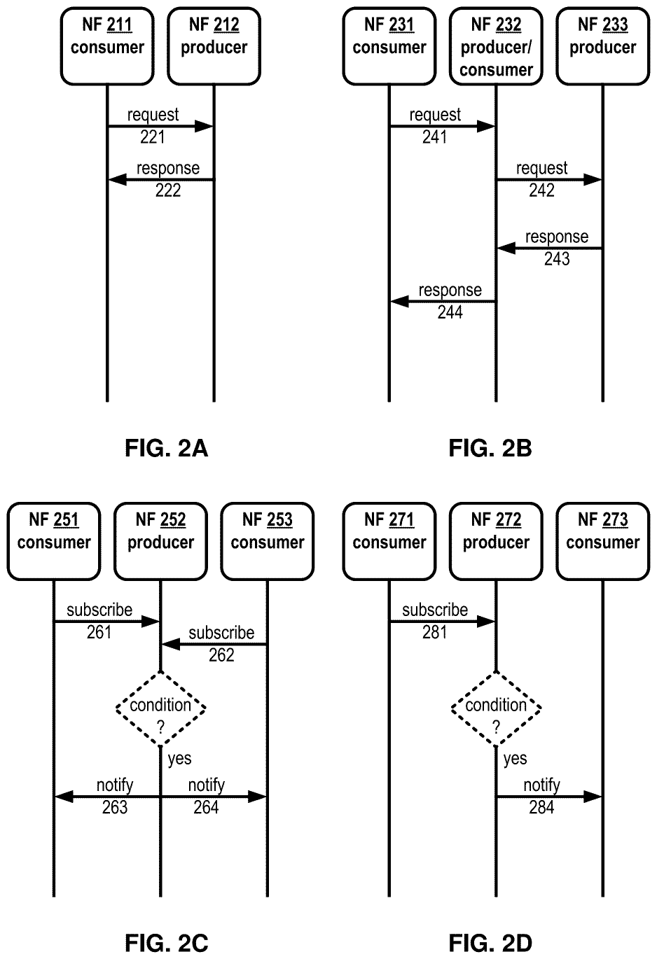

FIG. 2A, FIG. 2B, FIG. 2C, and FIG. 2D illustrate various examples of a framework for a service-based architecture within a core network. In a service-based architecture, a service may be sought by a service consumer and provided by a service producer. Prior to obtaining a particular service, an NF may determine where such a service can be obtained. To discover a service, the NF may communicate with a network repository function (NRF). As an example, an NF that provides one or more services may register with a network repository function (NRF). The NRF may store data relating to the one or more services that the NF is prepared to provide to other NFs in the service-based architecture. A consumer NF may query the NRF to discover a producer NF (for example, by obtaining from the NRF a list of NF instances that provide a particular service).

In the example of FIG. 2A, an NF 211 (a consumer NF in this example) may send a request 221 to an NF 212 (a producer NF). The request 221 may be a request for a particular service and may be sent based on a discovery that NF 212 is a producer of that service. The request 221 may comprise data relating to NF 211 and/or the requested service. The NF 212 may receive request 221, perform one or more actions associated with the requested service (e.g., retrieving data), and provide a response 221. The one or more actions performed by the NF 212 may be based on request data included in the request 221, data stored by NF 212, and/or data retrieved by NF 212. The response 222 may notify NF 211 that the one or more actions have been completed. The response 222 may comprise response data relating to NF 212, the one or more actions, and/or the requested service.

In the example of FIG. 2B, an NF 231 sends a request 241 to an NF 232. In this example, part of the service produced by NF 232 is to send a request 242 to an NF 233. The NF 233 may perform one or more actions and provide a response 243 to NF 232. Based on response 243, NF 232 may send a response 244 to NF 231. It will be understood from FIG. 2B that a single NF may perform the role of producer of services, consumer of services, or both. A particular NF service may include any number of nested NF services produced by one or more other NFs.

FIG. 2C illustrates examples of subscribe-notify interactions between a consumer NF and a producer NF. In FIG. 2C, an NF 251 sends a subscription 261 to an NF 252. An NF 253 sends a subscription 262 to the NF 252. Two NFs are shown in FIG. 2C for illustrative purposes (to demonstrate that the NF 252 may provide multiple subscription services to different NFs), but it will be understood that a subscribe-notify interaction only requires one subscriber. The NFs 251, 253 may be independent from one another. For example, the NFs 251, 253 may independently discover NF 252 and/or independently determine to subscribe to the service offered by NF 252. In response to receipt of a subscription, the NF 252 may provide a notification to the subscribing NF. For example, NF 252 may send a notification 263 to NF 251 based on subscription 261 and may send a notification 264 to NF 253 based on subscription 262.

As shown in the example illustration of FIG. 2C, the sending of the notifications 263, 264 may be based on a determination that a condition has occurred. For example, the notifications 263, 264 may be based on a determination that a particular event has occurred, a determination that a particular condition is outstanding, and/or a determination that a duration of time associated with the subscription has elapsed (for example, a period associated with a subscription for periodic notifications). As shown in the example illustration of FIG. 2C, NF 252 may send notifications 263, 264 to NFs 251, 253 simultaneously and/or in response to the same condition. However, it will be understood that the NF 252 may provide notifications at different times and/or in response to different notification conditions. In an example, the NF 251 may request a notification when a certain parameter, as measured by the NF 252, exceeds a first threshold, and the NF 252 may request a notification when the parameter exceeds a second threshold different from the first threshold. In an example, a parameter of interest and/or a corresponding threshold may be indicated in the subscriptions 261, 262.

FIG. 2D illustrates another example of a subscribe-notify interaction. In FIG. 2D, an NF 271 sends a subscription 281 to an NF 272. In response to receipt of subscription 281 and/or a determination that a notification condition has occurred, NF 272 may send a notification 284. The notification 284 may be sent to an NF 273. Unlike the example in FIG. 2C (in which a notification is sent to the subscribing NF), FIG. 2D demonstrates that a subscription and its corresponding notification may be associated with different NFs. For example, NF 271 may subscribe to the service provided by NF 272 on behalf of NF 273.

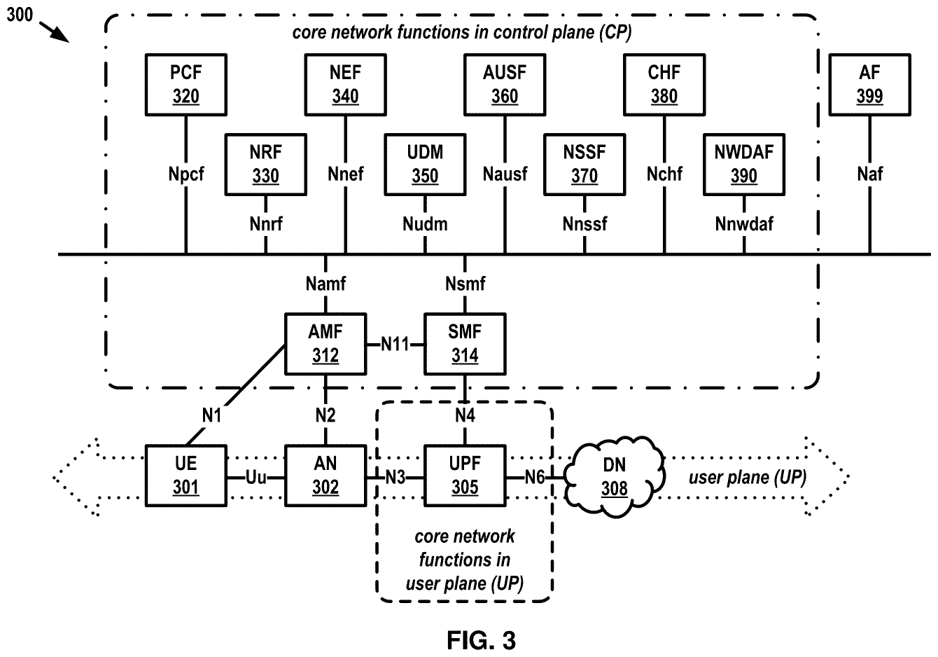

FIG. 3 illustrates another example communication network 300 in which embodiments of the present disclosure may be implemented. Communication network 300 includes a user equipment (UE) 301, an access network (AN) 302, and a data network (DN) 308. The remaining elements depicted in FIG. 3 may be included in and/or associated with a core network. Each element of the core network may be referred to as a network function (NF).

The NFs depicted in FIG. 3 include a user plane function (UPF) 305, an access and mobility management function (AMF) 312, a session management function (SMF) 314, a policy control function (PCF) 320, a network repository function (NRF) 330, a network exposure function (NEF) 340, a unified data management (UDM) 350, an authentication server function (AUSF) 360, a network slice selection function (NSSF) 370, a charging function (CHF) 380, a network data analytics function (NWDAF) 390, and an application function (AF) 399. The UPF 305 may be a user-plane core network function, whereas the NFs 312, 314, and 320-390 may be control-plane core network functions. Although not shown in the example of FIG. 3, the core network may include additional instances of any of the NFs depicted and/or one or more different NF types that provide different services. Other examples of NF type include a gateway mobile location center (GMLC), a location management function (LMF), an operations, administration, and maintenance function (OAM), a public warning system (PWS), a short message service function (SMSF), a unified data repository (UDR), and an unstructured data storage function (UDSF).

Each element depicted in FIG. 3 has an interface with at least one other element. The interface may be a logical connection rather than, for example, a direct physical connection. Any interface may be identified using a reference point representation and/or a service-based representation. In a reference point representation, the letter ‘N’ is followed by a numeral, indicating an interface between two specific elements. For example, as shown in FIG. 3, AN 302 and UPF 305 interface via ‘N3’, whereas UPF 305 and DN 308 interface via ‘N6’. By contrast, in a service-based representation, the letter ‘N’ is followed by letters. The letters identify an NF that provides services to the core network. For example, PCF 320 may provide services via interface ‘Npcf’. The PCF 320 may provide services to any NF in the core network via ‘Npcf’. Accordingly, a service-based representation may correspond to a bundle of reference point representations. For example, the Npcf interface between PCF 320 and the core network generally may correspond to an N7 interface between PCF 320 and SMF 314, an N30 interface between PCF 320 and NEF 340, etc.

The UPF 305 may serve as a gateway for user plane traffic between AN 302 and DN 308. The UE 301 may connect to UPF 305 via a Uu interface and an N3 interface (also described as NG U interface). The UPF 305 may connect to DN 308 via an N6 interface. The UPF 305 may connect to one or more other UPFs (not shown) via an N9 interface. The UE 301 may be configured to receive services through a protocol data unit (PDU) session, which is a logical connection between UE 301 and DN 308. The UPF 305 (or a plurality of UPFs if desired) may be selected by SMF 314 to handle a particular PDU session between UE 301 and DN 308. The SMF 314 may control the functions of UPF 305 with respect to the PDU session. The SMF 314 may connect to UPF 305 via an N4 interface. The UPF 305 may handle any number of PDU sessions associated with any number of UEs (via any number of ANs). For purposes of handling the one or more PDU sessions, UPF 305 may be controlled by any number of SMFs via any number of corresponding N4 interfaces.

The AMF 312 depicted in FIG. 3 may control UE access to the core network. The UE 301 may register with the network via AMF 312. It may be necessary for UE 301 to register prior to establishing a PDU session. The AMF 312 may manage a registration area of UE 301, enabling the network to track the physical location of UE 301 within the network. For a UE in connected mode, AMF 312 may manage UE mobility, for example, handovers from one AN or portion thereof to another. For a UE in idle mode, AMF 312 may perform registration updates and/or page the UE to transition the UE to connected mode.

The AMF 312 may receive, from UE 301, non-access stratum (NAS) messages transmitted in accordance with NAS protocol. NAS messages relate to communications between UE 301 and the core network. Although NAS messages may be relayed to AMF 312 via AN 302, they may be described as communications via the N1 interface. NAS messages may facilitate UE registration and mobility management, for example, by authenticating, identifying, configuring, and/or managing a connection of UE 301. NAS messages may support session management procedures for maintaining user plane connectivity and quality of service (QoS) of a session between UE 301 and DN 309. If the NAS message involves session management, AMF 312 may send the NAS message to SMF 314. NAS messages may be used to transport messages between UE 301 and other components of the core network (e.g., core network components other than AMF 312 and SMF 314). The AMF 312 may act on a particular NAS message itself, or alternatively, forward the NAS message to an appropriate core network function (e.g., SMF 314, etc.)

The SMF 314 depicted in FIG. 3 may establish, modify, and/or release a PDU session based on messaging received UE 301. The SMF 314 may allocate, manage, and/or assign an IP address to UE 301, for example, upon establishment of a PDU session. There may be multiple SMFs in the network, each of which may be associated with a respective group of wireless devices, base stations, and/or UPFs. A UE with multiple PDU sessions may be associated with a different SMF for each PDU session. As noted above, SMF 314 may select one or more UPFs to handle a PDU session and may control the handling of the PDU session by the selected UPF by providing rules for packet handling (PDR, FAR, QER, etc.). Rules relating to QoS and/or charging for a particular PDU session may be obtained from PCF 320 and provided to UPF 305.

The PCF 320 may provide, to other NFs, services relating to policy rules. The PCF 320 may use subscription data and information about network conditions to determine policy rules and then provide the policy rules to a particular NF which may be responsible for enforcement of those rules. Policy rules may relate to policy control for access and mobility, and may be enforced by the AMF. Policy rules may relate to session management, and may be enforced by the SMF 314. Policy rules may be, for example, network-specific, wireless device-specific, session-specific, or data flow-specific.

The NRF 330 may provide service discovery. The NRF 330 may belong to a particular PLMN. The NRF 330 may maintain NF profiles relating to other NFs in the communication network 300. The NF profile may include, for example, an address, PLMN, and/or type of the NF, a slice identifier, a list of the one or more services provided by the NF, and the authorization required to access the services.

The NEF 340 depicted in FIG. 3 may provide an interface to external domains, permitting external domains to selectively access the control plane of the communication network 300. The external domain may comprise, for example, third-party network functions, application functions, etc. The NEF 340 may act as a proxy between external elements and network functions such as AMF 312, SMF 314, PCF 320, UDM 350, etc. As an example, NEF 340 may determine a location or reachability status of UE 301 based on reports from AMF 312, and provide status information to an external element. As an example, an external element may provide, via NEF 340, information that facilitates the setting of parameters for establishment of a PDU session. The NEF 340 may determine which data and capabilities of the control plane are exposed to the external domain. The NEF 340 may provide secure exposure that authenticates and/or authorizes an external entity to which data or capabilities of the communication network 300 are exposed. The NEF 340 may selectively control the exposure such that the internal architecture of the core network is hidden from the external domain.

The UDM 350 may provide data storage for other NFs. The UDM 350 may permit a consolidated view of network information that may be used to ensure that the most relevant information can be made available to different NFs from a single resource. The UDM 350 may store and/or retrieve information from a unified data repository (UDR). For example, UDM 350 may obtain user subscription data relating to UE 301 from the UDR.

The AUSF 360 may support mutual authentication of UE 301 by the core network and authentication of the core network by UE 301. The AUSF 360 may perform key agreement procedures and provide keying material that can be used to improve security.

The NSSF 370 may select one or more network slices to be used by the UE 301. The NSSF 370 may select a slice based on slice selection information. For example, the NSSF 370 may receive Single Network Slice Selection Assistance Information (S NSSAI) and map the S NSSAI to a network slice instance identifier (NSI).

The CHF 380 may control billing-related tasks associated with UE 301. For example, UPF 305 may report traffic usage associated with UE 301 to SMF 314. The SMF 314 may collect usage data from UPF 305 and one or more other UPFs. The usage data may indicate how much data is exchanged, what DN the data is exchanged with, a network slice associated with the data, or any other information that may influence billing. The SMF 314 may share the collected usage data with the CHF. The CHF may use the collected usage data to perform billing-related tasks associated with UE 301. The CHF may, depending on the billing status of UE 301, instruct SMF 314 to limit or influence access of UE 301 and/or to provide billing-related notifications to UE 301.

The NWDAF 390 may collect and analyze data from other network functions and offer data analysis services to other network functions. As an example, NWDAF 390 may collect data relating to a load level for a particular network slice instance from UPF 305, AMF 312, and/or SMF 314. Based on the collected data, NWDAF 390 may provide load level data to the PCF 320 and/or NSSF 370, and/or notify the PC 220 and/or NSSF 370 if load level for a slice reaches and/or exceeds a load level threshold.

The AF 399 may be outside the core network, but may interact with the core network to provide information relating to the QoS requirements or traffic routing preferences associated with a particular application. The AF 399 may access the core network based on the exposure constraints imposed by the NEF 340. However, an operator of the core network may consider the AF 399 to be a trusted domain that can access the network directly.

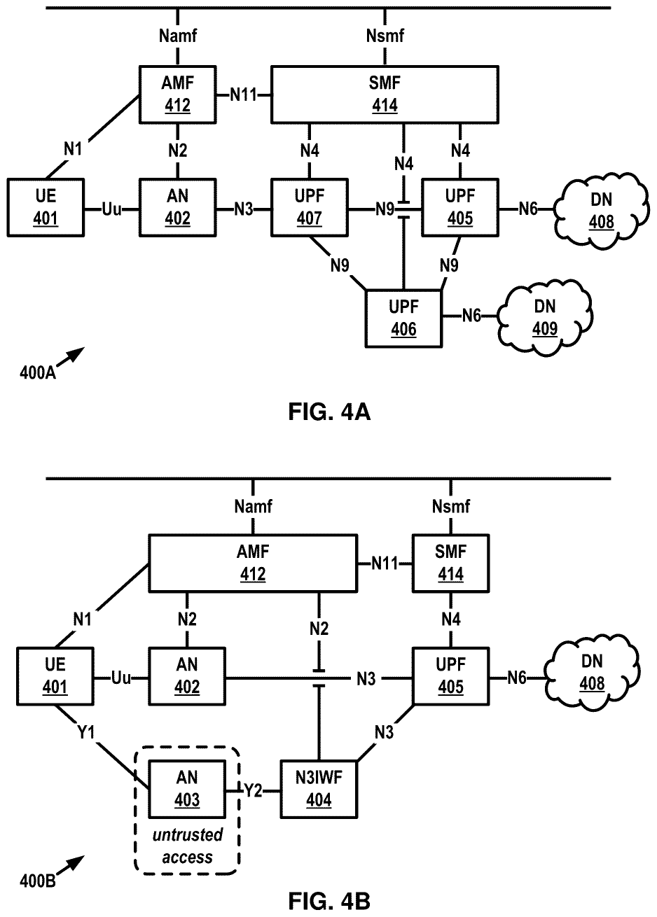

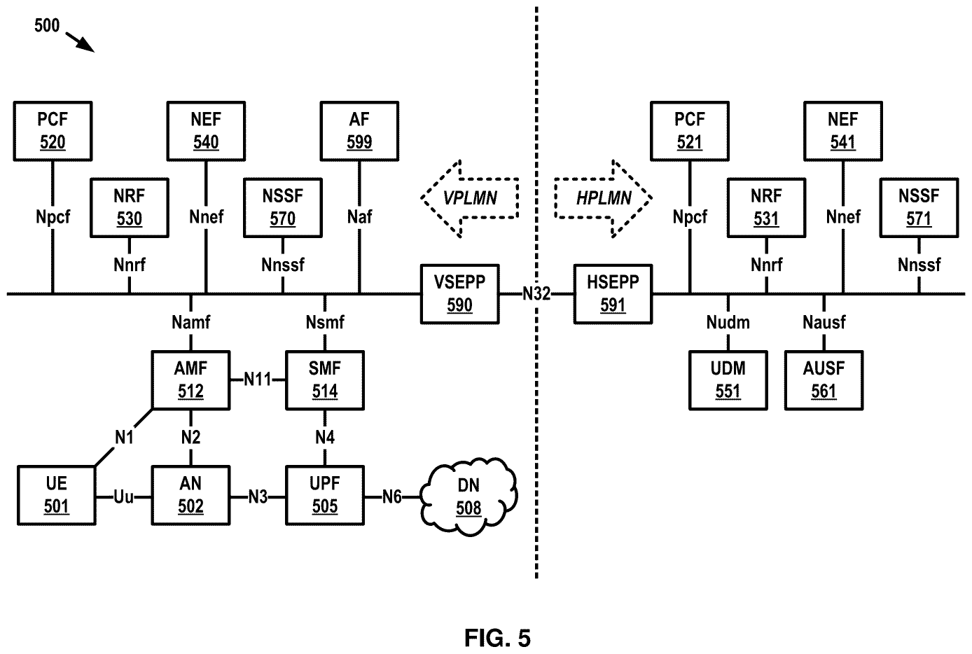

FIGS. 4A, 4B, and 5 illustrate other examples of core network architectures that are analogous in some respects to the core network architecture 300 depicted in FIG. 3. For conciseness, some of the core network elements depicted in FIG. 3 are omitted. Many of the elements depicted in FIGS. 4A, 4B, and 5 are analogous in some respects to elements depicted in FIG. 3. For conciseness, some of the details relating to their functions or operation are omitted.

FIG. 4A illustrates an example of a core network architecture 400A comprising an arrangement of multiple UPFs. Core network architecture 400A includes a UE 401, an AN 402, an AMF 412, and an SMF 414. Unlike previous examples of core network architectures described above, FIG. 4A depicts multiple UPFs, including a UPF 405, a UPF 406, and a UPF 407, and multiple DNs, including a DN 408 and a DN 409. Each of the multiple UPFs 405, 406, 407 may communicate with the SMF 414 via an N4 interface. The DNs 408, 409 communicate with the UPFs 405, 406, respectively, via N6 interfaces. As shown in FIG. 4A, the multiple UPFs 405, 406, 407 may communicate with one another via N9 interfaces.

The UPFs 405, 406, 407 may perform traffic detection, in which the UPFs identify and/or classify packets. Packet identification may be performed based on packet detection rules (PDR) provided by the SMF 414. A PDR may include packet detection information comprising one or more of: a source interface, a UE IP address, core network (CN) tunnel information (e.g., a CN address of an N3/N9 tunnel corresponding to a PDU session), a network instance identifier, a quality of service flow identifier (QFI), a filter set (for example, an IP packet filter set or an ethernet packet filter set), and/or an application identifier.

In addition to indicating how a particular packet is to be detected, a PDR may further indicate rules for handling the packet upon detection thereof. The rules may include, for example, forwarding action rules (FARs), multi-access rules (MARs), usage reporting rules (URRs), QoS enforcement rules (QERs), etc. For example, the PDR may comprise one or more FAR identifiers, MAR identifiers, URR identifiers, and/or QER identifiers. These identifiers may indicate the rules that are prescribed for the handling of a particular detected packet.

The UPF 405 may perform traffic forwarding in accordance with a FAR. For example, the FAR may indicate that a packet associated with a particular PDR is to be forwarded, duplicated, dropped, and/or buffered. The FAR may indicate a destination interface, for example, “access” for downlink or “core” for uplink. If a packet is to be buffered, the FAR may indicate a buffering action rule (BAR). As an example, UPF 405 may perform data buffering of a certain number of downlink packets if a PDU session is deactivated.

The UPF 405 may perform QoS enforcement in accordance with a QER. For example, the QER may indicate a guaranteed bitrate that is authorized and/or a maximum bitrate to be enforced for a packet associated with a particular PDR. The QER may indicate that a particular guaranteed and/or maximum bitrate may be for uplink packets and/or downlink packets. The UPF 405 may mark packets belonging to a particular QoS flow with a corresponding QFI. The marking may enable a recipient of the packet to determine a QoS of the packet.

The UPF 405 may provide usage reports to the SMF 414 in accordance with a URR. The URR may indicate one or more triggering conditions for generation and reporting of the usage report, for example, immediate reporting, periodic reporting, a threshold for incoming uplink traffic, or any other suitable triggering condition. The URR may indicate a method for measuring usage of network resources, for example, data volume, duration, and/or event.

As noted above, the DNs 408, 409 may comprise public DNs (e.g., the Internet), private DNs (e.g., private, internal corporate-owned DNs), and/or intra-operator DNs. Each DN may provide an operator service and/or a third-party service. The service provided by a DN may be the Internet, an IP multimedia subsystem (IMS), an augmented or virtual reality network, an edge computing or mobile edge computing (MEC) network, etc. Each DN may be identified using a data network name (DNN). The UE 401 may be configured to establish a first logical connection with DN 408 (a first PDU session), a second logical connection with DN 409 (a second PDU session), or both simultaneously (first and second PDU sessions).

Each PDU session may be associated with at least one UPF configured to operate as a PDU session anchor (PSA, or “anchor”). The anchor may be a UPF that provides an N6 interface with a DN.

In the example of FIG. 4A, UPF 405 may be the anchor for the first PDU session between UE 401 and DN 408, whereas the UPF 406 may be the anchor for the second PDU session between UE 401 and DN 409. The core network may use the anchor to provide service continuity of a particular PDU session (for example, IP address continuity) as UE 401 moves from one access network to another. For example, suppose that UE 401 establishes a PDU session using a data path to the DN 408 using an access network other than AN 402. The data path may include UPF 405 acting as anchor. Suppose further that the UE 401 later moves into the coverage area of the AN 402. In such a scenario, SMF 414 may select a new UPF (UPF 407) to bridge the gap between the newly-entered access network (AN 402) and the anchor UPF (UPF 405). The continuity of the PDU session may be preserved as any number of UPFs are added or removed from the data path. When a UPF is added to a data path, as shown in FIG. 4A, it may be described as an intermediate UPF and/or a cascaded UPF.

As noted above, UPF 406 may be the anchor for the second PDU session between UE 401 and DN 409. Although the anchor for the first and second PDU sessions are associated with different UPFs in FIG. 4A, it will be understood that this is merely an example. It will also be understood that multiple PDU sessions with a single DN may correspond to any number of anchors. When there are multiple UPFs, a UPF at the branching point (UPF 407 in FIG. 4A) may operate as an uplink classifier (UL-CL). The UL-CL may divert uplink user plane traffic to different UPFs.

The SMF 414 may allocate, manage, and/or assign an IP address to UE 401, for example, upon establishment of a PDU session. The SMF 414 may maintain an internal pool of IP addresses to be assigned. The SMF 414 may, if necessary, assign an IP address provided by a dynamic host configuration protocol (DHCP) server or an authentication, authorization, and accounting (AAA) server. IP address management may be performed in accordance with a session and service continuity (SSC) mode. In SSC mode 1, an IP address of UE 401 may be maintained (and the same anchor UPF may be used) as the wireless device moves within the network. In SSC mode 2, the IP address of UE 401 changes as UE 401 moves within the network (e.g., the old IP address and UPF may be abandoned and a new IP address and anchor UPF may be established). In SSC mode 3, it may be possible to maintain an old IP address (similar to SSC mode 1) temporarily while establishing a new IP address (similar to SSC mode 2), thus combining features of SSC modes 1 and 2. Applications that are sensitive to IP address changes may operate in accordance with SSC mode 1.

UPF selection may be controlled by SMF 414. For example, upon establishment and/or modification of a PDU session between UE 401 and DN 408, SMF 414 may select UPF 405 as the anchor for the PDU session and/or UPF 407 as an intermediate UPF. Criteria for UPF selection include path efficiency and/or speed between AN 402 and DN 408. The reliability, load status, location, slice support and/or other capabilities of candidate UPFs may also be considered.

FIG. 4B illustrates an example of a core network architecture 400B that accommodates untrusted access. Similar to FIG. 4A, UE 401 as depicted in FIG. 4B connects to DN 408 via AN 402 and UPF 405. The AN 402 and UPF 405 constitute trusted (e.g., 3GPP) access to the DN 408. By contrast, UE 401 may also access DN 408 using an untrusted access network, AN 403, and a non-3GPP interworking function (N3IWF) 404.

The AN 403 may be, for example, a wireless land area network (WLAN) operating in accordance with the IEEE 802.11 standard. The UE 401 may connect to AN 403, via an interface Y1, in whatever manner is prescribed for AN 403. The connection to AN 403 may or may not involve authentication. The UE 401 may obtain an IP address from AN 403. The UE 401 may determine to connect to core network 400B and select untrusted access for that purpose. The AN 403 may communicate with N3IWF 404 via a Y2 interface. After selecting untrusted access, the UE 401 may provide N3IWF 404 with sufficient information to select an AMF. The selected AMF may be, for example, the same AMF that is used by UE 401 for 3GPP access (AMF 412 in the present example). The N3IWF 404 may communicate with AMF 412 via an N2 interface. The UPF 405 may be selected and N3IWF 404 may communicate with UPF 405 via an N3 interface. The UPF 405 may be a PDU session anchor (PSA) and may remain the anchor for the PDU session even as UE 401 shifts between trusted access and untrusted access.

FIG. 5 illustrates an example of a core network architecture 500 in which a UE 501 is in a roaming scenario. In a roaming scenario, UE 501 is a subscriber of a first PLMN (a home PLMN, or HPLMN) but attaches to a second PLMN (a visited PLMN, or VPLMN). Core network architecture 500 includes UE 501, an AN 502, a UPF 505, and a DN 508. The AN 502 and UPF 505 may be associated with a VPLMN. The VPLMN may manage the AN 502 and UPF 505 using core network elements associated with the VPLMN, including an AMF 512, an SMF 514, a PCF 520, an NRF 530, an NEF 540, and an NSSF 570. An AF 599 may be adjacent the core network of the VPLMN.

The UE 501 may not be a subscriber of the VPLMN. The AMF 512 may authorize UE 501 to access the network based on, for example, roaming restrictions that apply to UE 501. In order to obtain network services provided by the VPLMN, it may be necessary for the core network of the VPLMN to interact with core network elements of a HPLMN of UE 501, in particular, a PCF 521, an NRF 531, an NEF 541, a UDM 551, and/or an AUSF 561. The VPLMN and HPLMN may communicate using an N32 interface connecting respective security edge protection proxies (SEPPs). In FIG. 5, the respective SEPPs are depicted as a VSEPP 590 and an HSEPP 591.

The VSEPP 590 and the HSEPP 591 communicate via an N32 interface for defined purposes while concealing information about each PLMN from the other. The SEPPs may apply roaming policies based on communications via the N32 interface. The PCF 520 and PCF 521 may communicate via the SEPPs to exchange policy-related signaling. The NRF 530 and NRF 531 may communicate via the SEPPs to enable service discovery of NFs in the respective PLMNs. The VPLMN and HPLMN may independently maintain NEF 540 and NEF 541. The NSSF 570 and NSSF 571 may communicate via the SEPPs to coordinate slice selection for UE 501. The HPLMN may handle all authentication and subscription related signaling. For example, when the UE 501 registers or requests service via the VPLMN, the VPLMN may authenticate UE 501 and/or obtain subscription data of UE 501 by accessing, via the SEPPs, the UDM 551 and AUSF 561 of the HPLMN.

The core network architecture 500 depicted in FIG. 5 may be referred to as a local breakout configuration, in which UE 501 accesses DN 508 using one or more UPFs of the VPLMN (i.e., UPF 505). However, other configurations are possible. For example, in a home-routed configuration (not shown in FIG. 5), UE 501 may access a DN using one or more UPFs of the HPLMN. In the home-routed configuration, an N9 interface may run parallel to the N32 interface, crossing the frontier between the VPLMN and the HPLMN to carry user plane data. One or more SMFs of the respective PLMNs may communicate via the N32 interface to coordinate session management for UE 501. The SMFs may control their respective UPFs on either side of the frontier.

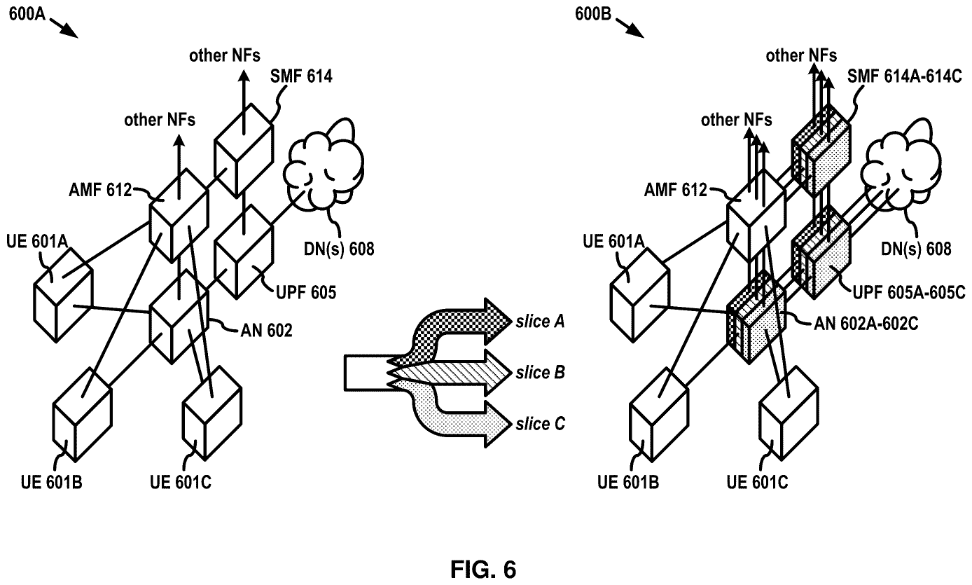

FIG. 6 illustrates an example of network slicing. Network slicing may refer to division of shared infrastructure (e.g., physical infrastructure) into distinct logical networks. These distinct logical networks may be independently controlled, isolated from one another, and/or associated with dedicated resources.

Network architecture 600A illustrates an un-sliced physical network corresponding to a single logical network. The network architecture 600A comprises a user plane wherein UEs 601A, 601B, 601C (collectively, UEs 601) have a physical and logical connection to a DN 608 via an AN 602 and a UPF 605. The network architecture 600A comprises a control plane wherein an AMF 612 and a SMF 614 control various aspects of the user plane.

The network architecture 600A may have a specific set of characteristics (e.g., relating to maximum bit rate, reliability, latency, bandwidth usage, power consumption, etc.). This set of characteristics may be affected by the nature of the network elements themselves (e.g., processing power, availability of free memory, proximity to other network elements, etc.) or the management thereof (e.g., optimized to maximize bit rate or reliability, reduce latency or power bandwidth usage, etc.). The characteristics of network architecture 600A may change over time, for example, by upgrading equipment or by modifying procedures to target a particular characteristic. However, at any given time, network architecture 600A will have a single set of characteristics that may or may not be optimized for a particular use case. For example, UEs 601A, 601B, 601C may have different requirements, but network architecture 600A can only be optimized for one of the three.

Network architecture 600B is an example of a sliced physical network divided into multiple logical networks. In FIG. 6, the physical network is divided into three logical networks, referred to as slice A, slice B, and slice C. For example, UE 601A may be served by AN 602A, UPF 605A, AMF 612, and SMF 614A. UE 601B may be served by AN 602B, UPF 605B, AMF 612, and SMF 614B. UE 601C may be served by AN 602C, UPF 605C, AMF 612, and SMF 614C. Although the respective UEs 601 communicate with different network elements from a logical perspective, these network elements may be deployed by a network operator using the same physical network elements.

Each network slice may be tailored to network services having different sets of characteristics. For example, slice A may correspond to enhanced mobile broadband (eMBB) service. Mobile broadband may refer to internet access by mobile users, commonly associated with smartphones. Slice B may correspond to ultra-reliable low-latency communication (URLLC), which focuses on reliability and speed. Relative to eMBB, URLLC may improve the feasibility of use cases such as autonomous driving and telesurgery. Slice C may correspond to massive machine type communication (mMTC), which focuses on low-power services delivered to a large number of users. For example, slice C may be optimized for a dense network of battery-powered sensors that provide small amounts of data at regular intervals. Many mMTC use cases would be prohibitively expensive if they operated using an eMBB or URLLC network.

If the service requirements for one of the UEs 601 changes, then the network slice serving that UE can be updated to provide better service. Moreover, the set of network characteristics corresponding to eMBB, URLLC, and mMTC may be varied, such that differentiated species of eMBB, URLLC, and mMTC are provided. Alternatively, network operators may provide entirely new services in response to, for example, customer demand.

In FIG. 6, each of the UEs 601 has its own network slice. However, it will be understood that a single slice may serve any number of UEs and a single UE may operate using any number of slices. Moreover, in the example network architecture 600B, the AN 602, UPF 605 and SMF 614 are separated into three separate slices, whereas the AMF 612 is unsliced. However, it will be understood that a network operator may deploy any architecture that selectively utilizes any mix of sliced and unsliced network elements, with different network elements divided into different numbers of slices. Although FIG. 6 only depicts three core network functions, it will be understood that other core network functions may be sliced as well. A PLMN that supports multiple network slices may maintain a separate network repository function (NFR) for each slice, enabling other NFs to discover network services associated with that slice.

Network slice selection may be controlled by an AMF, or alternatively, by a separate network slice selection function (NSSF). For example, a network operator may define and implement distinct network slice instances (NSIs). Each NSI may be associated with single network slice selection assistance information (S NSSAI). The S NSSAI may include a particular slice/service type (SST) indicator (indicating eMBB, URLLC, mMTC, etc.). As an example, a particular tracking area may be associated with one or more configured S NSSAIs. UEs may identify one or more requested and/or subscribed S NSSAIs (e.g., during registration). The network may indicate to the UE one or more allowed and/or rejected S NSSAIs.

The S NSSAI may further include a slice differentiator (SD) to distinguish between different tenants of a particular slice and/or service type. For example, a tenant may be a customer (e.g., vehicle manufacture, service provider, etc.) of a network operator that obtains (for example, purchases) guaranteed network resources and/or specific policies for handling its subscribers. The network operator may configure different slices and/or slice types, and use the SD to determine which tenant is associated with a particular slice.

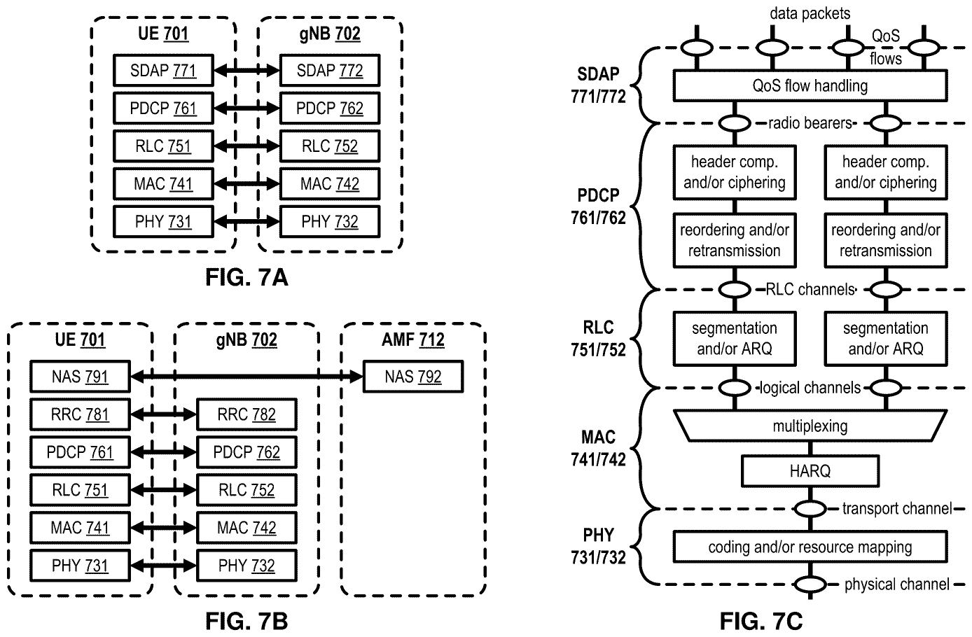

FIG. 7A, FIG. 7B, and FIG. 7C illustrate a user plane (UP) protocol stack, a control plane (CP) protocol stack, and services provided between protocol layers of the UP protocol stack.

The layers may be associated with an open system interconnection (OSI) model of computer networking functionality. In the OSI model, layer 1 may correspond to the bottom layer, with higher layers on top of the bottom layer. Layer 1 may correspond to a physical layer, which is concerned with the physical infrastructure used for transfer of signals (for example, cables, fiber optics, and/or radio frequency transceivers). In New Radio (NR), layer 1 may comprise a physical layer (PHY). Layer 2 may correspond to a data link layer. Layer 2 may be concerned with packaging of data (into, e.g., data frames) for transfer, between nodes of the network, using the physical infrastructure of layer 1. In NR, layer 2 may comprise a media access control layer (MAC), a radio link control layer (RLC), a packet data convergence layer (PDCP), and a service data application protocol layer (SDAP).

Layer 3 may correspond to a network layer. Layer 3 may be concerned with routing of the data which has been packaged in layer 2. Layer 3 may handle prioritization of data and traffic avoidance. In NR, layer 3 may comprise a radio resource control layer (RRC) and a non-access stratum layer (NAS). Layers 4 through 7 may correspond to a transport layer, a session layer, a presentation layer, and an application layer. The application layer interacts with an end user to provide data associated with an application. In an example, an end user implementing the application may generate data associated with the application and initiate sending of that information to a targeted data network (e.g., the Internet, an application server, etc.). Starting at the application layer, each layer in the OSI model may manipulate and/or repackage the information and deliver it to a lower layer. At the lowest layer, the manipulated and/or repackaged information may be exchanged via physical infrastructure (for example, electrically, optically, and/or electromagnetically). As it approaches the targeted data network, the information will be unpackaged and provided to higher and higher layers, until it once again reaches the application layer in a form that is usable by the targeted data network (e.g., the same form in which it was provided by the end user). To respond to the end user, the data network may perform this procedure in reverse.

FIG. 7A illustrates a user plane protocol stack. The user plane protocol stack may be a new radio (NR) protocol stack for a Uu interface between a UE 701 and a gNB 702. In layer 1 of the UP protocol stack, the UE 701 may implement PHY 731 and the gNB 702 may implement PHY 732. In layer 2 of the UP protocol stack, the UE 701 may implement MAC 741, RLC 751, PDCP 761, and SDAP 771. The gNB 702 may implement MAC 742, RLC 752, PDCP 762, and SDAP 772.

FIG. 7B illustrates a control plane protocol stack. The control plane protocol stack may be an NR protocol stack for the Uu interface between the UE 701 and the gNB 702 and/or an N1 interface between the UE 701 and an AMF 712. In layer 1 of the CP protocol stack, the UE 701 may implement PHY 731 and the gNB 702 may implement PHY 732. In layer 2 of the CP protocol stack, the UE 701 may implement MAC 741, RLC 751, PDCP 761, RRC 781, and NAS 791. The gNB 702 may implement MAC 742, RLC 752, PDCP 762, and RRC 782. The AMF 712 may implement NAS 792.

The NAS may be concerned with the non-access stratum, in particular, communication between the UE 701 and the core network (e.g., the AMF 712). Lower layers may be concerned with the access stratum, for example, communication between the UE 701 and the gNB 702. Messages sent between the UE 701 and the core network may be referred to as NAS messages. In an example, a NAS message may be relayed by the gNB 702, but the content of the NAS message (e.g., information elements of the NAS message) may not be visible to the gNB 702.

FIG. 7C illustrates an example of services provided between protocol layers of the NR user plane protocol stack illustrated in FIG. 7A. The UE 701 may receive services through a PDU session, which may be a logical connection between the UE 701 and a data network (DN). The UE 701 and the DN may exchange data packets associated with the PDU session. The PDU session may comprise one or more quality of service (QoS) flows. SDAP 771 and SDAP 772 may perform mapping and/or demapping between the one or more QoS flows of the PDU session and one or more radio bearers (e.g., data radio bearers). The mapping between the QoS flows and the data radio bearers may be determined in the SDAP 772 by the gNB 702, and the UE 701 may be notified of the mapping (e.g., based on control signaling and/or reflective mapping). For reflective mapping, the SDAP 772 of the gNB 220 may mark downlink packets with a QoS flow indicator (QFI) and deliver the downlink packets to the UE 701. The UE 701 may determine the mapping based on the QFI of the downlink packets.

PDCP 761 and PDCP 762 may perform header compression and/or decompression. Header compression may reduce the amount of data transmitted over the physical layer. The PDCP 761 and PDCP 762 may perform ciphering and/or deciphering. Ciphering may reduce unauthorized decoding of data transmitted over the physical layer (e.g., intercepted on an air interface), and protect data integrity (e.g., to ensure control messages originate from intended sources). The PDCP 761 and PDCP 762 may perform retransmissions of undelivered packets, in-sequence delivery and reordering of packets, duplication of packets, and/or identification and removal of duplicate packets. In a dual connectivity scenario, PDCP 761 and PDCP 762 may perform mapping between a split radio bearer and RLC channels.

RLC 751 and RLC 752 may perform segmentation, retransmission through Automatic Repeat Request (ARQ). The RLC 751 and RLC 752 may perform removal of duplicate data units received from MAC 741 and MAC 742, respectively. The RLCs 213 and 223 may provide RLC channels as a service to PDCPs 214 and 224, respectively.

MAC 741 and MAC 742 may perform multiplexing and/or demultiplexing of logical channels. MAC 741 and MAC 742 may map logical channels to transport channels. In an example, UE 701 may, in MAC 741, multiplex data units of one or more logical channels into a transport block. The UE 701 may transmit the transport block to the gNB 702 using PHY 731. The gNB 702 may receive the transport block using PHY 732 and demultiplex data units of the transport blocks back into logical channels. MAC 741 and MAC 742 may perform error correction through Hybrid Automatic Repeat Request (HARQ), logical channel prioritization, and/or padding.

PHY 731 and PHY 732 may perform mapping of transport channels to physical channels. PHY 731 and PHY 732 may perform digital and analog signal processing functions (e.g., coding/decoding and modulation/demodulation) for sending and receiving information (e.g., transmission via an air interface). PHY 731 and PHY 732 may perform multi-antenna mapping.

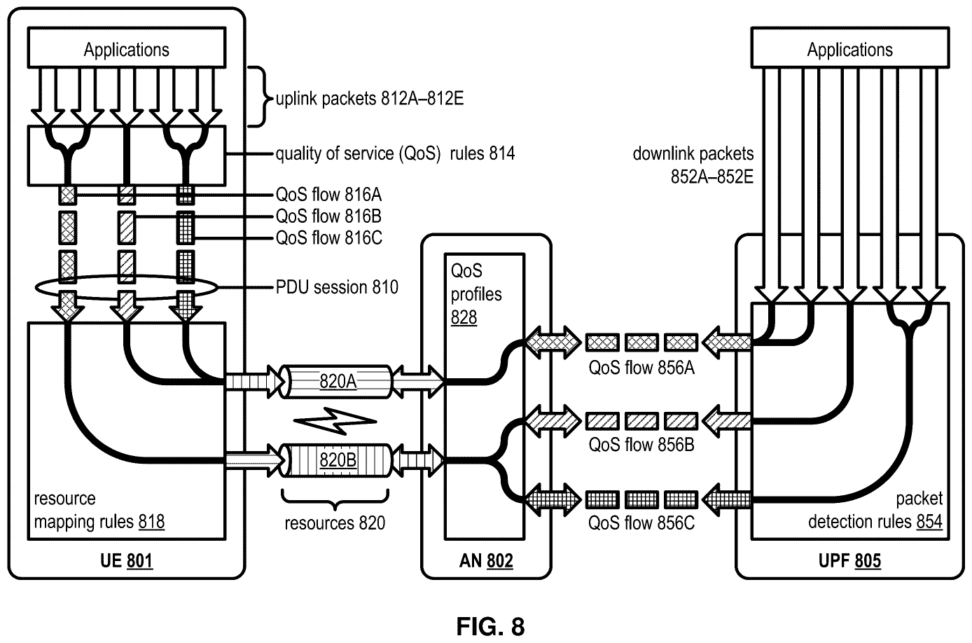

FIG. 8 illustrates an example of a quality of service (QoS) model for differentiated data exchange. In the QoS model of FIG. 8, there are a UE 801, a AN 802, and a UPF 805. The QoS model facilitates prioritization of certain packet or protocol data units (PDUs), also referred to as packets. For example, higher-priority packets may be exchanged faster and/or more reliably than lower-priority packets. The network may devote more resources to exchange of high-QoS packets.

In the example of FIG. 8, a PDU session 810 is established between UE 801 and UPF 805. The PDU session 810 may be a logical connection enabling the UE 801 to exchange data with a particular data network (for example, the Internet). The UE 801 may request establishment of the PDU session 810. At the time that the PDU session 810 is established, the UE 801 may, for example, identify the targeted data network based on its data network name (DNN). The PDU session 810 may be managed, for example, by a session management function (SMF, not shown). In order to facilitate exchange of data associated with the PDU session 810, between the UE 801 and the data network, the SMF may select the UPF 805 (and optionally, one or more other UPFs, not shown).

One or more applications associated with UE 801 may generate uplink packets 812A-812E associated with the PDU session 810. In order to work within the QoS model, UE 801 may apply QoS rules 814 to uplink packets 812A-812E. The QoS rules 814 may be associated with PDU session 810 and may be determined and/or provided to the UE 801 when PDU session 810 is established and/or modified. Based on QoS rules 814, UE 801 may classify uplink packets 812A-812E, map each of the uplink packets 812A-812E to a QoS flow, and/or mark uplink packets 812A-812E with a QoS flow indicator (QFI). As a packet travels through the network, and potentially mixes with other packets from other UEs having potentially different priorities, the QFI indicates how the packet should be handled in accordance with the QoS model. In the present illustration, uplink packets 812A, 812B are mapped to QoS flow 816A, uplink packet 812C is mapped to QoS flow 816B, and the remaining packets are mapped to QoS flow 816C.

The QoS flows may be the finest granularity of QoS differentiation in a PDU session. In the figure, three QoS flows 816A-816C are illustrated. However, it will be understood that there may be any number of QoS flows. Some QoS flows may be associated with a guaranteed bit rate (GBR QoS flows) and others may have bit rates that are not guaranteed (non-GBR QoS flows). QoS flows may also be subject to per-UE and per-session aggregate bit rates. One of the QoS flows may be a default QoS flow. The QoS flows may have different priorities. For example, QoS flow 816A may have a higher priority than QoS flow 816B, which may have a higher priority than QoS flow 816C. Different priorities may be reflected by different QoS flow characteristics. For example, QoS flows may be associated with flow bit rates. A particular QoS flow may be associated with a guaranteed flow bit rate (GFBR) and/or a maximum flow bit rate (MFBR). QoS flows may be associated with specific packet delay budgets (PDBs), packet error rates (PERs), and/or maximum packet loss rates. QoS flows may also be subject to per-UE and per-session aggregate bit rates.

In order to work within the QoS model, UE 801 may apply resource mapping rules 818 to the QoS flows 816A-816C. The air interface between UE 801 and AN 802 may be associated with resources 820. In the present illustration, QoS flow 816A is mapped to resource 820A, whereas QoS flows 816B, 816C are mapped to resource 820B. The resource mapping rules 818 may be provided by the AN 802. In order to meet QoS requirements, the resource mapping rules 818 may designate more resources for relatively high-priority QoS flows. With more resources, a high-priority QoS flow such as QoS flow 816A may be more likely to obtain the high flow bit rate, low packet delay budget, or other characteristic associated with QoS rules 814. The resources 820 may comprise, for example, radio bearers. The radio bearers (e.g., data radio bearers) may be established between the UE 801 and the AN 802. The radio bearers in 5G, between the UE 801 and the AN 802, may be distinct from bearers in LTE, for example, Evolved Packet System (EPS) bearers between a UE and a packet data network gateway (PGW), S1 bearers between an eNB and a serving gateway (SGW), and/or an S5/S8 bearer between an SGW and a PGW.

Once a packet associated with a particular QoS flow is received at AN 802 via resource 820A or resource 820B, AN 802 may separate packets into respective QoS flows 856A-856C based on QoS profiles 828. The QoS profiles 828 may be received from an SMF. Each QoS profile may correspond to a QFI, for example, the QFI marked on the uplink packets 812A-812E. Each QoS profile may include QoS parameters such as 5G QoS identifier (5QI) and an allocation and retention priority (ARP). The QoS profile for non-GBR QoS flows may further include additional QoS parameters such as a reflective QoS attribute (RQA). The QoS profile for GBR QoS flows may further include additional QoS parameters such as a guaranteed flow bit rate (GFBR), a maximum flow bit rate (MFBR), and/or a maximum packet loss rate. The 5QI may be a standardized 5QI which has one-to-one mapping to a standardized combination of 5G QoS characteristics per well-known services. The 5QI may be a dynamically assigned 5QI which the standardized 5QI values are not defined. The 5QI may represent 5G QoS characteristics. The 5QI may comprise a resource type, a default priority level, a packet delay budget (PDB), a packet error rate (PER), a maximum data burst volume, and/or an averaging window. The resource type may indicate a non-GBR QoS flow, a GBR QoS flow or a delay-critical GBR QoS flow. The averaging window may represent a duration over which the GFBR and/or MFBR is calculated. ARP may be a priority level comprising pre-emption capability and a pre-emption vulnerability. Based on the ARP, the AN 802 may apply admission control for the QoS flows in a case of resource limitations.

The AN 802 may select one or more N3 tunnels 850 for transmission of the QoS flows 856A-856C. After the packets are divided into QoS flows 856A-856C, the packet may be sent to UPF 805 (e.g., towards a DN) via the selected one or more N3 tunnels 850. The UPF 805 may verify that the QFIs of the uplink packets 812A-812E are aligned with the QoS rules 814 provided to the UE 801. The UPF 805 may measure and/or count packets and/or provide packet metrics to, for example, a PCF.

The figure also illustrates a process for downlink. In particular, one or more applications may generate downlink packets 852A-852E. The UPF 805 may receive downlink packets 852A-852E from one or more DNs and/or one or more other UPFs. As per the QoS model, UPF 805 may apply packet detection rules (PDRs) 854 to downlink packets 852A-852E. Based on PDRs 854, UPF 805 may map packets 852A-852E into QoS flows. In the present illustration, downlink packets 852A, 852B are mapped to QoS flow 856A, downlink packet 852C is mapped to QoS flow 856B, and the remaining packets are mapped to QoS flow 856C.

The QoS flows 856A-856C may be sent to AN 802. The AN 802 may apply resource mapping rules to the QoS flows 856A-856C. In the present illustration, QoS flow 856A is mapped to resource 820A, whereas QoS flows 856B, 856C are mapped to resource 820B. In order to meet QoS requirements, the resource mapping rules may designate more resources to high-priority QoS flows.

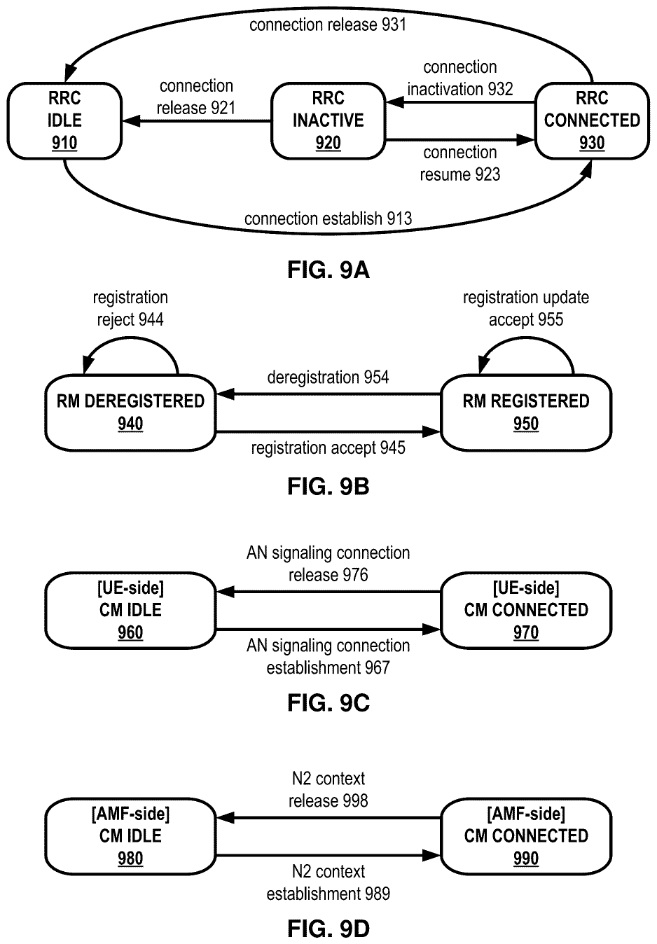

FIGS. 9A-9D illustrate example states and state transitions of a wireless device (e.g., a UE). At any given time, the wireless device may have a radio resource control (RRC) state, a registration management (RM) state, and a connection management (CM) state.

FIG. 9A is an example diagram showing RRC state transitions of a wireless device (e.g., a UE). The UE may be in one of three RRC states: RRC idle 910, (e.g., RRC_IDLE), RRC inactive 920 (e.g., RRC_INACTIVE), or RRC connected 930 (e.g., RRC_CONNECTED). The UE may implement different RAN-related control-plane procedures depending on its RRC state. Other elements of the network, for example, a base station, may track the RRC state of one or more UEs and implement RAN-related control-plane procedures appropriate to the RRC state of each.

In RRC connected 930, it may be possible for the UE to exchange data with the network (for example, the base station). The parameters necessary for exchange of data may be established and known to both the UE and the network. The parameters may be referred to and/or included in an RRC context of the UE (sometimes referred to as a UE context). These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. The base station with which the UE is connected may store the RRC context of the UE.

While in RRC connected 930, mobility of the UE may be managed by the access network, whereas the UE itself may manage mobility while in RRC idle 910 and/or RRC inactive 920. While in RRC connected 930, the UE may manage mobility by measuring signal levels (e.g., reference signal levels) from a serving cell and neighboring cells and reporting these measurements to the base station currently serving the UE. The network may initiate handover based on the reported measurements. The RRC state may transition from RRC connected 930 to RRC idle 910 through a connection release procedure 930 or to RRC inactive 920 through a connection inactivation procedure 932.

In RRC idle 910, an RRC context may not be established for the UE. In RRC idle 910, the UE may not have an RRC connection with a base station. While in RRC idle 910, the UE may be in a sleep state for a majority of the time (e.g., to conserve battery power). The UE may wake up periodically (e.g., once in every discontinuous reception cycle) to monitor for paging messages from the access network. Mobility of the UE may be managed by the UE through a procedure known as cell reselection. The RRC state may transition from RRC idle 910 to RRC connected 930 through a connection establishment procedure 913, which may involve a random access procedure, as discussed in greater detail below.

In RRC inactive 920, the RRC context previously established is maintained in the UE and the base station. This may allow for a fast transition to RRC connected 930 with reduced signaling overhead as compared to the transition from RRC idle 910 to RRC connected 930. The RRC state may transition to RRC connected 930 through a connection resume procedure 923. The RRC state may transition to RRC idle 910 though a connection release procedure 921 that may be the same as or similar to connection release procedure 931.

An RRC state may be associated with a mobility management mechanism. In RRC idle 910 and RRC inactive 920, mobility may be managed by the UE through cell reselection. The purpose of mobility management in RRC idle 910 and/or RRC inactive 920 is to allow the network to be able to notify the UE of an event via a paging message without having to broadcast the paging message over the entire mobile communications network. The mobility management mechanism used in RRC idle 910 and/or RRC inactive 920 may allow the network to track the UE on a cell-group level so that the paging message may be broadcast over the cells of the cell group that the UE currently resides within instead of the entire communication network. Tracking may be based on different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 920 state, the UE may be assigned a RAN notification area. A RAN notification area may comprise one or more cell identities, a list of RAIs, and/or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 920.

FIG. 9B is an example diagram showing registration management (RM) state transitions of a wireless device (e.g., a UE). The states are RM deregistered 940, (e.g., RM-DEREGISTERED) and RM registered 950 (e.g., RM-REGISTERED).

In RM deregistered 940, the UE is not registered with the network, and the UE is not reachable by the network. In order to be reachable by the network, the UE must perform an initial registration. As an example, the UE may register with an AMF of the network. If registration is rejected (registration reject 944), then the UE remains in RM deregistered 940. If registration is accepted (registration accept 945), then the UE transitions to RM registered 950. While the UE is RM registered 950, the network may store, keep, and/or maintain a UE context for the UE. The UE context may be referred to as wireless device context. The UE context corresponding to network registration (maintained by the core network) may be different from the RRC context corresponding to RRC state (maintained by an access network,. e.g., a base station). The UE context may comprise a UE identifier and a record of various information relating to the UE, for example, UE capability information, policy information for access and mobility management of the UE, lists of allowed or established slices or PDU sessions, and/or a registration area of the UE (i.e., a list of tracking areas covering the geographical area where the wireless device is likely to be found).

While the UE is RM registered 950, the network may store the UE context of the UE, and if necessary, use the UE context to reach the UE. Moreover, some services may not be provided by the network unless the UE is registered. The UE may update its UE context while remaining in RM registered 950 (registration update accept 955). For example, if the UE leaves one tracking area and enters another tracking area, the UE may provide a tracking area identifier to the network. The network may deregister the UE, or the UE may deregister itself (deregistration 954). For example, the network may automatically deregister the wireless device if the wireless device is inactive for a certain amount of time. Upon deregistration, the UE may transition to RM deregistered 940.

FIG. 9C is an example diagram showing connection management (CM) state transitions of a wireless device (e.g., a UE), shown from a perspective of the wireless device. The UE may be in CM idle 960 (e.g., CM-IDLE) or CM connected 970 (e.g., CM-CONNECTED).

In CM idle 960, the UE does not have a non access stratum (NAS) signaling connection with the network. As a result, the UE cannot communicate with core network functions. The UE may transition to CM connected 970 by establishing an AN signaling connection (AN signaling connection establishment 967). This transition may be initiated by sending an initial NAS message. The initial NAS message may be a registration request (e.g., if the UE is RM deregistered 940) or a service request (e.g., if the UE is RM registered 950). If the UE is RM registered 950, then the UE may initiate the AN signaling connection establishment by sending a service request, or the network may send a page, thereby triggering the UE to send the service request.

In CM connected 970, the UE can communicate with core network functions using NAS signaling. As an example, the UE may exchange NAS signaling with an AMF for registration management purposes, service request procedures, and/or authentication procedures. As another example, the UE may exchange NAS signaling, with an SMF, to establish and/or modify a PDU session. The network may disconnect the UE, or the UE may disconnect itself (AN signaling connection release 976). For example, if the UE transitions to RM deregistered 940, then the UE may also transition to CM idle 960. When the UE transitions to CM idle 960, the network may deactivate a user plane connection of a PDU session of the UE.

FIG. 9D is an example diagram showing CM state transitions of the wireless device (e.g., a UE), shown from a network perspective (e.g., an AMF). The CM state of the UE, as tracked by the AMF, may be in CM idle 980 (e.g., CM-IDLE) or CM connected 990 (e.g., CM-CONNECTED). When the UE transitions from CM idle 980 to CM connected 990, the AMF many establish an N2 context of the UE (N2 context establishment 989). When the UE transitions from CM connected 990 to CM idle 980, the AMF may release the N2 context of the UE (N2 context release 998).

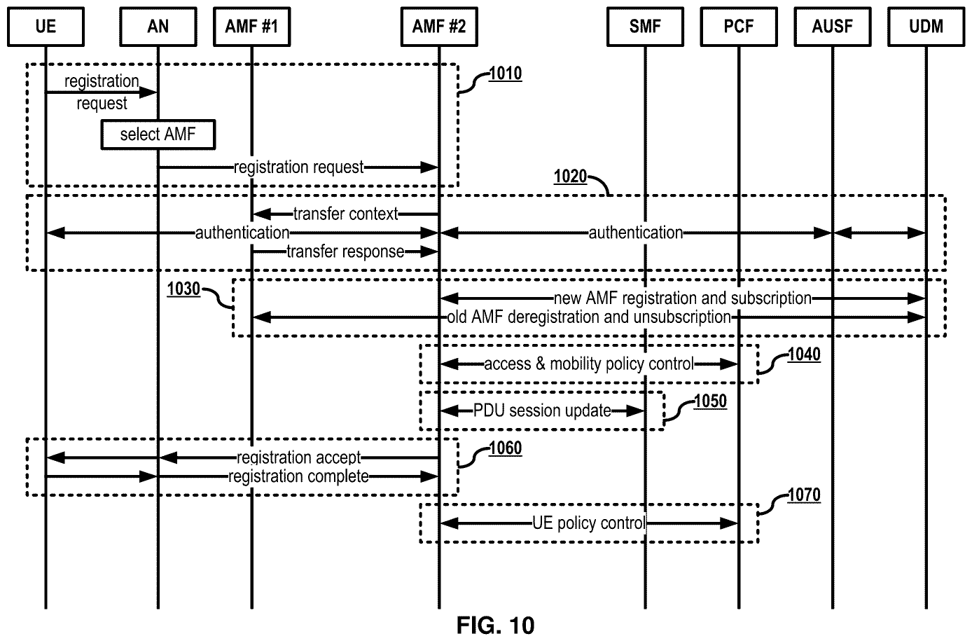

FIGS. 10-12 illustrate example procedures for registering, service request, and PDU session establishment of a UE.

FIG. 10 illustrates an example of a registration procedure for a wireless device (e.g., a UE). Based on the registration procedure, the UE may transition from, for example, RM deregistered 940 to RM registered 950.

Registration may be initiated by a UE for the purposes of obtaining authorization to receive services, enabling mobility tracking, enabling reachability, or other purposes. The UE may perform an initial registration as a first step toward connection to the network (for example, if the UE is powered on, airplane mode is turned off, etc.). Registration may also be performed periodically to keep the network informed of the UE's presence (for example, while in CM-IDLE state), or in response to a change in UE capability or registration area. Deregistration (not shown in FIG. 10) may be performed to stop network access.

At 1010, the UE transmits a registration request to an AN. As an example, the UE may have moved from a coverage area of a previous AMF (illustrated as AMF #1) into a coverage area of a new AMF (illustrated as AMF #2). The registration request may be a NAS message. The registration request may include a UE identifier. The AN may select an AMF for registration of the UE. For example, the AN may select a default AMF. For example, the AN may select an AMF that is already mapped to the UE (e.g., a previous AMF). The NAS registration request may include a network slice identifier and the AN may select an AMF based on the requested slice. After the AMF is selected, the AN may send the registration request to the selected AMF.

At 1020, the AMF that receives the registration request (AMF #2) performs a context transfer. The context may be a UE context, for example, an RRC context for the UE. As an example, AMF #2 may send AMF #1 a message requesting a context of the UE. The message may include the UE identifier. The message may be a Namf_Communication_UEContextTransfer message. AMF #1 may send to AMF #2 a message that includes the requested UE context. This message may be a Namf_Communication_UEContextTransfer message. After the UE context is received, the AMF #2 may coordinate authentication of the UE. After authentication is complete, AMF #2 may send to AMF #1 a message indicating that the UE context transfer is complete. This message may be a Namf_Communication_UEContextTransfer Response message.

Authentication may require participation of the UE, an AUSF, a UDM and/or a UDR (not shown). For example, the AMF may request that the AUSF authenticate the UE. For example, the AUSF may execute authentication of the UE. For example, the AUSF may get authentication data from UDM. For example, the AUSF may send a subscription permanent identifier (SUPI) to the AMF based on the authentication being successful. For example, the AUSF may provide an intermediate key to the AMF. The intermediate key may be used to derive an access-specific security key for the UE, enabling the AMF to perform security context management (SCM). The AUSF may obtain subscription data from the UDM. The subscription data may be based on information obtained from the UDM (and/or the UDR). The subscription data may include subscription identifiers, security credentials, access and mobility related subscription data and/or session related data.

At 1030, the new AMF, AMF #2, registers and/or subscribes with the UDM. AMF #2 may perform registration using a UE context management service of the UDM (Nudm_UECM). AMF #2 may obtain subscription information of the UE using a subscriber data management service of the UDM (Nudm_SDM). AMF #2 may further request that the UDM notify AMF #2 if the subscription information of the UE changes. As the new AMF registers and subscribes, the old AMF, AMF #1, may deregister and unsubscribe. After deregistration, AMF #1 is free of responsibility for mobility management of the UE.

At 1040, AMF #2 retrieves access and mobility (AM) policies from the PCF. As an example, the AMF #2 may provide subscription data of the UE to the PCF. The PCF may determine access and mobility policies for the UE based on the subscription data, network operator data, current network conditions, and/or other suitable information. For example, the owner of a first UE may purchase a higher level of service than the owner of a second UE. The PCF may provide the rules associated with the different levels of service. Based on the subscription data of the respective UEs, the network may apply different policies which facilitate different levels of service.

For example, access and mobility policies may relate to service area restrictions, RAT/frequency selection priority (RFSP, where RAT stands for radio access technology), authorization and prioritization of access type (e.g., LTE versus NR), and/or selection of non-3GPP access (e.g., Access Network Discovery and Selection Policy (ANDSP)). The service area restrictions may comprise a list of tracking areas where the UE is allowed to be served (or forbidden from being served). The access and mobility policies may include a UE route selection policy (URSP)) that influences routing to an established PDU session or a new PDU session. As noted above, different policies may be obtained and/or enforced based on subscription data of the UE, location of the UE (i.e., location of the AN and/or AMF), or other suitable factors.

At 1050, AMF #2 may update a context of a PDU session. For example, if the UE has an existing PDU session, the AMF #2 may coordinate with an SMF to activate a user plane connection associated with the existing PDU session. The SMF may update and/or release a session management context of the PDU session (Nsmf_PDUSession_UpdateSMContext, Nsmf_PDUSession_ReleaseSMContext).

At 1060, AMF #2 sends a registration accept message to the AN, which forwards the registration accept message to the UE. The registration accept message may include a new UE identifier and/or a new configured slice identifier. The UE may transmit a registration complete message to the AN, which forwards the registration complete message to the AMF #2. The registration complete message may acknowledge receipt of the new UE identifier and/or new configured slice identifier.

At 1070, AMF #2 may obtain UE policy control information from the PCF. The PCF may provide an access network discovery and selection policy (ANDSP) to facilitate non-3GPP access. The PCF may provide a UE route selection policy (URSP) to facilitate mapping of particular data traffic to particular PDU session connectivity parameters. As an example, the URSP may indicate that data traffic associated with a particular application should be mapped to a particular SSC mode, network slice, PDU session type, or preferred access type (3GPP or non-3GPP).

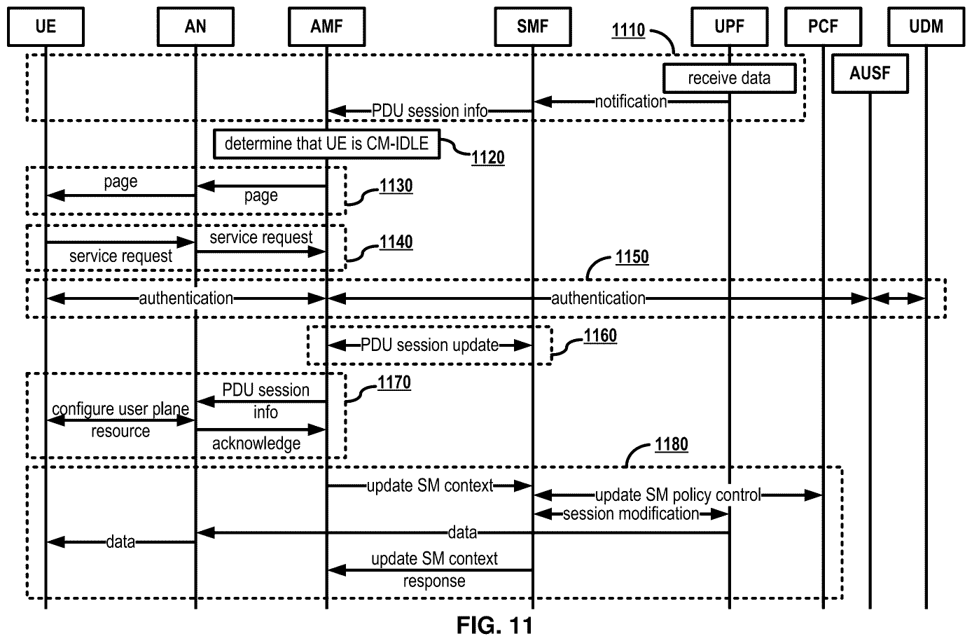

FIG. 11 illustrates an example of a service request procedure for a wireless device (e.g., a UE). The service request procedure depicted in FIG. 11 is a network-triggered service request procedure for a UE in a CM-IDLE state. However, other service request procedures (e.g., a UE-triggered service request procedure) may also be understood by reference to FIG. 11, as will be discussed in greater detail below.

At 1110, a UPF receives data. The data may be downlink data for transmission to a UE. The data may be associated with an existing PDU session between the UE and a DN. The data may be received, for example, from a DN and/or another UPF. The UPF may buffer the received data. In response to the receiving of the data, the UPF may notify an SMF of the received data. The identity of the SMF to be notified may be determined based on the received data. The notification may be, for example, an N4 session report. The notification may indicate that the UPF has received data associated with the UE and/or a particular PDU session associated with the UE. In response to receiving the notification, the SMF may send PDU session information to an AMF. The PDU session information may be sent in an N1N2 message transfer for forwarding to an AN. The PDU session information may include, for example, UPF tunnel endpoint information and/or QoS information.

At 1120, the AMF determines that the UE is in a CM-IDLE state. The determining at 1120 may be in response to the receiving of the PDU session information. Based on the determination that the UE is CM-IDLE, the service request procedure may proceed to 1130 and 1140, as depicted in FIG. 11. However, if the UE is not CM-IDLE (e.g., the UE is CM-CONNECTED), then 1130 and 1140 may be skipped, and the service request procedure may proceed directly to 1150.

At 1130, the AMF pages the UE. The paging at 1130 may be performed based on the UE being CM-IDLE. To perform the paging, the AMF may send a page to the AN. The page may be referred to as a paging or a paging message. The page may be an N2 request message. The AN may be one of a plurality of ANs in a RAN notification area of the UE. The AN may send a page to the UE. The UE may be in a coverage area of the AN and may receive the page.

At 1140, the UE may request service. The UE may transmit a service request to the AMF via the AN. As depicted in FIG. 11, the UE may request service at 1140 in response to receiving the paging at 1130. However, as noted above, this is for the specific case of a network-triggered service request procedure. In some scenarios (for example, if uplink data becomes available at the UE), then the UE may commence a UE-triggered service request procedure. The UE-triggered service request procedure may commence starting at 1140.

At 1150, the network may authenticate the UE. Authentication may require participation of the UE, an AUSF, and/or a UDM, for example, similar to authentication described elsewhere in the present disclosure. In some cases (for example, if the UE has recently been authenticated), the authentication at 1150 may be skipped.

At 1160, the AMF and SMF may perform a PDU session update. As part of the PDU session update, the SMF may provide the AMF with one or more UPF tunnel endpoint identifiers. In some cases (not shown in FIG. 11), it may be necessary for the SMF to coordinate with one or more other SMFs and/or one or more other UPFs to set up a user plane.

At 1170, the AMF may send PDU session information to the AN. The PDU session information may be included in an N2 request message. Based on the PDU session information, the AN may configure a user plane resource for the UE. To configure the user plane resource, the AN may, for example, perform an RRC reconfiguration of the UE. The AN may acknowledge to the AMF that the PDU session information has been received. The AN may notify the AMF that the user plane resource has been configured, and/or provide information relating to the user plane resource configuration.

In the case of a UE-triggered service request procedure, the UE may receive, at 1170, a NAS service accept message from the AMF via the AN. After the user plane resource is configured, the UE may transmit uplink data (for example, the uplink data that caused the UE to trigger the service request procedure).

At 1180, the AMF may update a session management (SM) context of the PDU session. For example, the AMF may notify the SMF (and/or one or more other associated SMFs) that the user plane resource has been configured, and/or provide information relating to the user plane resource configuration. The AMF may provide the SMF (and/or one or more other associated SMFs) with one or more AN tunnel endpoint identifiers of the AN. After the SM context update is complete, the SMF may send an update SM context response message to the AMF.

Based on the update of the session management context, the SMF may update a PCF for purposes of policy control. For example, if a location of the UE has changed, the SMF may notify the PCF of the UE's a new location.

Based on the update of the session management context, the SMF and UPF may perform a session modification. The session modification may be performed using N4 session modification messages. After the session modification is complete, the UPF may transmit downlink data (for example, the downlink data that caused the UPF to trigger the network-triggered service request procedure) to the UE. The transmitting of the downlink data may be based on the one or more AN tunnel endpoint identifiers of the AN.

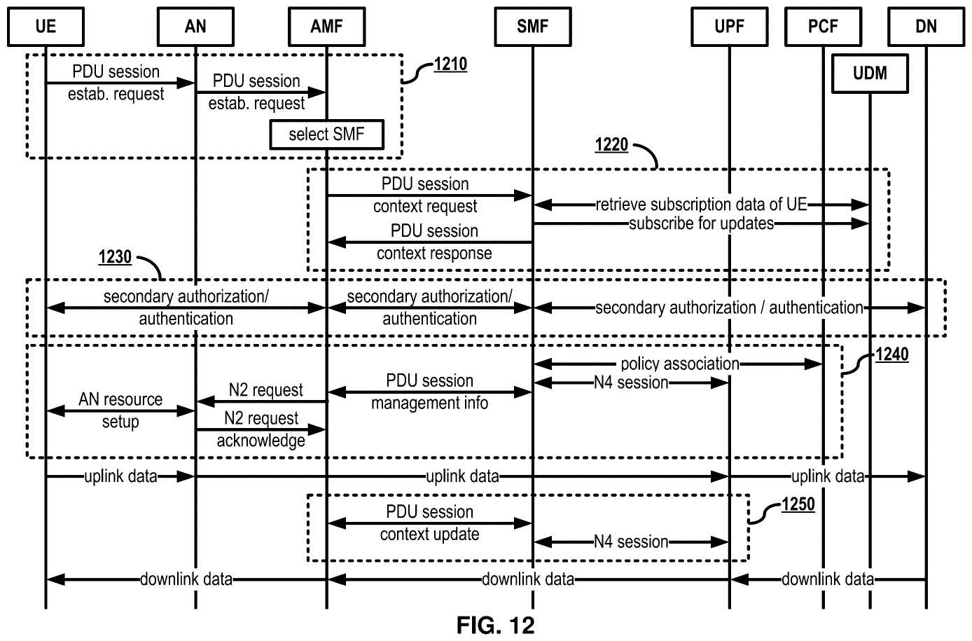

FIG. 12 illustrates an example of a protocol data unit (PDU) session establishment procedure for a wireless device (e.g., a UE). The UE may determine to transmit the PDU session establishment request to create a new PDU session, to hand over an existing PDU session to a 3GPP network, or for any other suitable reason.

At 1210, the UE initiates PDU session establishment. The UE may transmit a PDU session establishment request to an AMF via an AN. The PDU session establishment request may be a NAS message. The PDU session establishment request may indicate: a PDU session ID; a requested PDU session type (new or existing); a requested DN (DNN); a requested network slice (S NSSAI); a requested SSC mode; and/or any other suitable information. The PDU session ID may be generated by the UE. The PDU session type may be, for example, an Internet Protocol (IP)-based type (e.g., IPv4, IPv6, or dual stack IPv4/IPv6), an Ethernet type, or an unstructured type.

The AMF may select an SMF based on the PDU session establishment request. In some scenarios, the requested PDU session may already be associated with a particular SMF. For example, the AMF may store a UE context of the UE, and the UE context may indicate that the PDU session ID of the requested PDU session is already associated with the particular SMF. In some scenarios, the AMF may select the SMF based on a determination that the SMF is prepared to handle the requested PDU session. For example, the requested PDU session may be associated with a particular DNN and/or S NSSAI, and the SMF may be selected based on a determination that the SMF can manage a PDU session associated with the particular DNN and/or S NSSAI.

At 1220, the network manages a context of the PDU session. After selecting the SMF at 1210, the AMF sends a PDU session context request to the SMF. The PDU session context request may include the PDU session establishment request received from the UE at 1210. The PDU session context request may be a Nsmf_PDUSession_CreateSMContext Request and/or a Nsmf_PDUSession_UpdateSMContext Request. The PDU session context request may indicate identifiers of the UE; the requested DN; and/or the requested network slice. Based on the PDU session context request, the SMF may retrieve subscription data from a UDM. The subscription data may be session management subscription data of the UE. The SMF may subscribe for updates to the subscription data, so that the PCF will send new information if the subscription data of the UE changes. After the subscription data of the UE is obtained, the SMF may transmit a PDU session context response to the AMG. The PDU session context response may be a Nsmf_PDUSession_CreateSMContext Response and/or a Nsmf_PDUSession_UpdateSMContext Response. The PDU session context response may include a session management context ID.

At 1230, secondary authorization/authentication may be performed, if necessary. The secondary authorization/authentication may involve the UE, the AMF, the SMF, and the DN. The SMF may access the DN via a Data Network Authentication, Authorization and Accounting (DN AAA) server.

At 1240, the network sets up a data path for uplink data associated with the PDU session. The SMF may select a PCF and establish a session management policy association. Based on the association, the PCF may provide an initial set of policy control and charging rules (PCC rules) for the PDU session. When targeting a particular PDU session, the PCF may indicate, to the SMF, a method for allocating an IP address to the PDU Session, a default charging method for the PDU session, an address of the corresponding charging entity, triggers for requesting new policies, etc. The PCF may also target a service data flow (SDF) comprising one or more PDU sessions. When targeting an SDF, the PCF may indicate, to the SMF, policies for applying QoS requirements, monitoring traffic (e.g., for charging purposes), and/or steering traffic (e.g., by using one or more particular N6 interfaces).

The SMF may determine and/or allocate an IP address for the PDU session. The SMF may select one or more UPFs (a single UPF in the example of FIG. 12) to handle the PDU session. The SMF may send an N4 session message to the selected UPF. The N4 session message may be an N4 Session Establishment Request and/or an N4 Session Modification Request. The N4 session message may include packet detection, enforcement, and reporting rules associated with the PDU session. In response, the UPF may acknowledge by sending an N4 session establishment response and/or an N4 session modification response.

The SMF may send PDU session management information to the AMF. The PDU session management information may be a session service request (e.g., Namf_Communication_N1N2MessageTransfer) message. The PDU session management information may include the PDU session ID. The PDU session management information may be a NAS message. The PDU session management information may include N1 session management information and/or N2 session management information. The N1 session management information may include a PDU session establishment accept message. The PDU session establishment accept message may include tunneling endpoint information of the UPF and quality of service (QoS) information associated with the PDU session.

The AMF may send an N2 request to the AN. The N2 request may include the PDU session establishment accept message. Based on the N2 request, the AN may determine AN resources for the UE. The AN resources may be used by the UE to establish the PDU session, via the AN, with the DN. The AN may determine resources to be used for the PDU session and indicate the determined resources to the UE. The AN may send the PDU session establishment accept message to the UE. For example, the AN may perform an RRC reconfiguration of the UE. After the AN resources are set up, the AN may send an N2 request acknowledge to the AMF. The N2 request acknowledge may include N2 session management information, for example, the PDU session ID and tunneling endpoint information of the AN.

After the data path for uplink data is set up at 1240, the UE may optionally send uplink data associated with the PDU session. As shown in FIG. 12, the uplink data may be sent to a DN associated with the PDU session via the AN and the UPF.

At 1250, the network may update the PDU session context. The AMF may transmit a PDU session context update request to the SMF. The PDU session context update request may be a Nsmf_PDUSession_UpdateSMContext Request. The PDU session context update request may include the N2 session management information received from the AN. The SMF may acknowledge the PDU session context update. The acknowledgement may be a Nsmf_PDUSession_UpdateSMContext Response. The acknowledgement may include a subscription requesting that the SMF be notified of any UE mobility event. Based on the PDU session context update request, the SMF may send an N4 session message to the UPF. The N4 session message may be an N4 Session Modification Request. The N4 session message may include tunneling endpoint information of the AN. The N4 session message may include forwarding rules associated with the PDU session. In response, the UPF may acknowledge by sending an N4 session modification response.

After the UPF receives the tunneling endpoint information of the AN, the UPF may relay downlink data associated with the PDU session. As shown in FIG. 12, the downlink data may be received from a DN associated with the PDU session via the AN and the UPF.

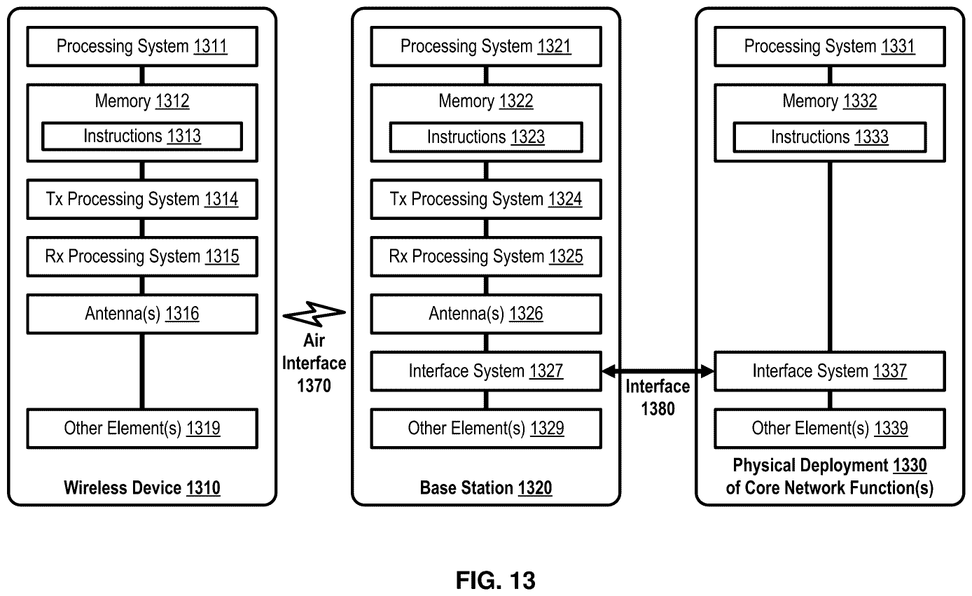

FIG. 13 illustrates examples of components of the elements in a communications network. FIG. 13 includes a wireless device 1310, a base station 1320, and a physical deployment of one or more network functions 1330 (henceforth “deployment 1330”). Any wireless device described in the present disclosure may have similar components and may be implemented in a similar manner as the wireless device 1310. Any other base station described in the present disclosure (or any portion thereof, depending on the architecture of the base station) may have similar components and may be implemented in a similar manner as the base station 1320. Any physical core network deployment in the present disclosure (or any portion thereof, depending on the architecture of the base station) may have similar components and may be implemented in a similar manner as the deployment 1330.

The wireless device 1310 may communicate with base station 1320 over an air interface 1370. The communication direction from wireless device 1310 to base station 1320 over air interface 1370 is known as uplink, and the communication direction from base station 1320 to wireless device 1310 over air interface 1370 is known as downlink. Downlink transmissions may be separated from uplink transmissions using FDD, TDD, and/or some combination of duplexing techniques. FIG. 13 shows a single wireless device 1310 and a single base station 1320, but it will be understood that wireless device 1310 may communicate with any number of base stations or other access network components over air interface 1370, and that base station 1320 may communicate with any number of wireless devices over air interface 1370.

The wireless device 1310 may comprise a processing system 1311 and a memory 1312. The memory 1312 may comprise one or more computer-readable media, for example, one or more non-transitory computer readable media. The memory 1312 may include instructions 1313. The processing system 1311 may process and/or execute instructions 1313. Processing and/or execution of instructions 1313 may cause wireless device 1310 and/or processing system 1311 to perform one or more functions or activities. The memory 1312 may include data (not shown). One of the functions or activities performed by processing system 1311 may be to store data in memory 1312 and/or retrieve previously-stored data from memory 1312. In an example, downlink data received from base station 1320 may be stored in memory 1312, and uplink data for transmission to base station 1320 may be retrieved from memory 1312. As illustrated in FIG. 13, the wireless device 1310 may communicate with base station 1320 using a transmission processing system 1314 and/or a reception processing system 1315. Alternatively, transmission processing system 1314 and reception processing system 1315 may be implemented as a single processing system, or both may be omitted and all processing in the wireless device 1310 may be performed by the processing system 1311. Although not shown in FIG. 13, transmission processing system 1314 and/or reception processing system 1315 may be coupled to a dedicated memory that is analogous to but separate from memory 1312, and comprises instructions that may be processed and/or executed to carry out one or more of their respective functionalities. The wireless device 1310 may comprise one or more antennas 1316 to access air interface 1370.

The wireless device 1310 may comprise one or more other elements 1319. The one or more other elements 1319 may comprise software and/or hardware that provide features and/or functionalities, for example, a speaker, a microphone, a keypad, a display, a touchpad, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, a global positioning sensor (GPS) and/or the like). The wireless device 1310 may receive user input data from and/or provide user output data to the one or more one or more other elements 1319. The one or more other elements 1319 may comprise a power source. The wireless device 1310 may receive power from the power source and may be configured to distribute the power to the other components in wireless device 1310. The power source may comprise one or more sources of power, for example, a battery, a solar cell, a fuel cell, or any combination thereof.

The wireless device 1310 may transmit uplink data to and/or receive downlink data from base station 1320 via air interface 1370. To perform the transmission and/or reception, one or more of the processing system 1311, transmission processing system 1314, and/or reception system 1315 may implement open systems interconnection (OSI) functionality. As an example, transmission processing system 1314 and/or reception system 1315 may perform layer 1 OSI functionality, and processing system 1311 may perform higher layer functionality. The wireless device 1310 may transmit and/or receive data over air interface 1370 using one or more antennas 1316. For scenarios where the one or more antennas 1316 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise a processing system 1321 and a memory 1322. The memory 1322 may comprise one or more computer-readable media, for example, one or more non-transitory computer readable media. The memory 1322 may include instructions 1323. The processing system 1321 may process and/or execute instructions 1323. Processing and/or execution of instructions 1323 may cause base station 1320 and/or processing system 1321 to perform one or more functions or activities. The memory 1322 may include data (not shown). One of the functions or activities performed by processing system 1321 may be to store data in memory 1322 and/or retrieve previously-stored data from memory 1322. The base station 1320 may communicate with wireless device 1310 using a transmission processing system 1324 and a reception processing system 1325. Although not shown in FIG. 13, transmission processing system 1324 and/or reception processing system 1325 may be coupled to a dedicated memory that is analogous to but separate from memory 1322, and comprises instructions that may be processed and/or executed to carry out one or more of their respective functionalities. The wireless device 1320 may comprise one or more antennas 1326 to access air interface 1370.

The base station 1320 may transmit downlink data to and/or receive uplink data from wireless device 1310 via air interface 1370. To perform the transmission and/or reception, one or more of the processing system 1321, transmission processing system 1324, and/or reception system 1325 may implement OSI functionality. As an example, transmission processing system 1324 and/or reception system 1325 may perform layer 1 OSI functionality, and processing system 1321 may perform higher layer functionality. The base station 1320 may transmit and/or receive data over air interface 1370 using one or more antennas 1326. For scenarios where the one or more antennas 1326 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise an interface system 1327. The interface system 1327 may communicate with one or more base stations and/or one or more elements of the core network via an interface 1380. The interface 1380 may be wired and/or wireless and interface system 1327 may include one or more components suitable for communicating via interface 1380. In FIG. 13, interface 1380 connects base station 1320 to a single deployment 1330, but it will be understood that wireless device 1310 may communicate with any number of base stations and/or CN deployments over interface 1380, and that deployment 1330 may communicate with any number of base stations and/or other CN deployments over interface 1380. The base station 1320 may comprise one or more other elements 1329 analogous to one or more of the one or more other elements 1319.

The deployment 1330 may comprise any number of portions of any number of instances of one or more network functions (NFs). The deployment 1330 may comprise a processing system 1331 and a memory 1332. The memory 1332 may comprise one or more computer-readable media, for example, one or more non-transitory computer readable media. The memory 1332 may include instructions 1333. The processing system 1331 may process and/or execute instructions 1333. Processing and/or execution of instructions 1333 may cause the deployment 1330 and/or processing system 1331 to perform one or more functions or activities. The memory 1332 may include data (not shown). One of the functions or activities performed by processing system 1331 may be to store data in memory 1332 and/or retrieve previously-stored data from memory 1332. The deployment 1330 may access the interface 1380 using an interface system 1337. The deployment 1330 may comprise one or more other elements 1339 analogous to one or more of the one or more other elements 1319.

One or more of the systems 1311, 1314, 1315, 1321, 1324, 1325, and/or 1331 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. One or more of the systems 1311, 1314, 1315, 1321, 1324, 1325, and/or 1331 may perform signal coding/processing, data processing, power control, input/output processing, and/or any other functionality that may enable wireless device 1310, base station 1320, and/or deployment 1330 to operate in a mobile communications system.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab and/or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, DSPs, ASICs, FPGAs, and complex programmable logic devices (CPLDs). Computers, microcontrollers and microprocessors may be programmed using languages such as assembly, C, C++ and/or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

The wireless device 1310, base station 1320, and/or deployment 1330 may implement timers and/or counters. A timer/counter may start at an initial value. As used herein, starting may comprise restarting. Once started, the timer/counter may run. Running of the timer/counter may be associated with an occurrence. When the occurrence occurs, the value of the timer/counter may change (for example, increment or decrement). The occurrence may be, for example, an exogenous event (for example, a reception of a signal, a measurement of a condition, etc.), an endogenous event (for example, a transmission of a signal, a calculation, a comparison, a performance of an action or a decision to so perform, etc.), or any combination thereof. In the case of a timer, the occurrence may be the passage of a particular amount of time. However, it will be understood that a timer may be described and/or implemented as a counter that counts the passage of a particular unit of time. A timer/counter may run in a direction of a final value until it reaches the final value. The reaching of the final value may be referred to as expiration of the timer/counter. The final value may be referred to as a threshold. A timer/counter may be paused, wherein the present value of the timer/counter is held, maintained, and/or carried over, even upon the occurrence of one or more occurrences that would otherwise cause the value of the timer/counter to change. The timer/counter may be un-paused or continued, wherein the value that was held, maintained, and/or carried over begins changing again when the one or more occurrence occur. A timer/counter may be set and/or reset. As used herein, setting may comprise resetting. When the timer/counter sets and/or resets, the value of the timer/counter may be set to the initial value. A timer/counter may be started and/or restarted. As used herein, starting may comprise restarting. In some embodiments, when the timer/counter restarts, the value of the timer/counter may be set to the initial value and the timer/counter may begin to run.

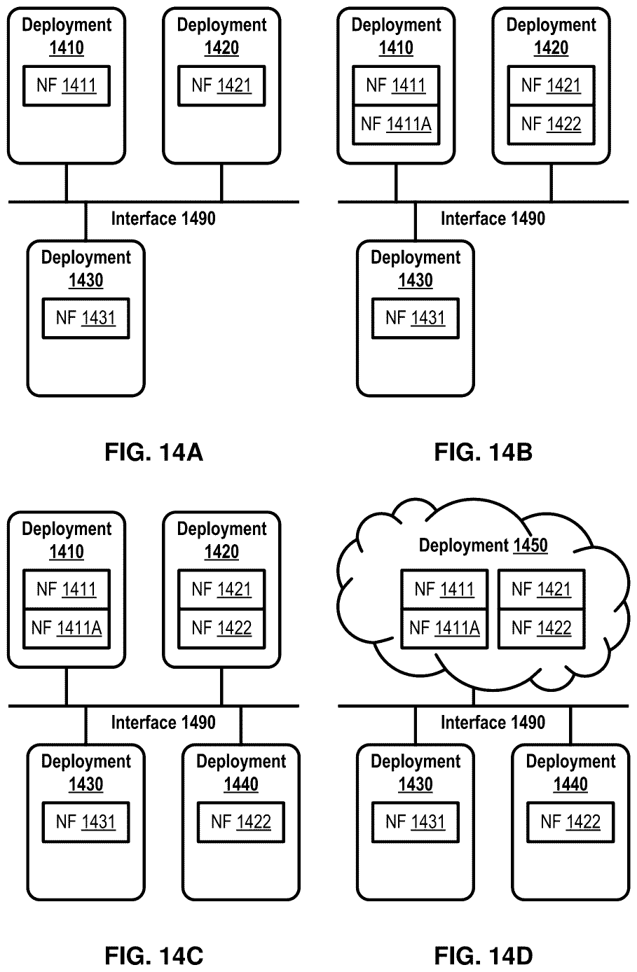

FIGS. 14A, 14B, 14C, and 14D illustrate various example arrangements of physical core network deployments, each having one or more network functions or portions thereof. The core network deployments comprise a deployment 1410, a deployment 1420, a deployment 1430, a deployment 1440, and/or a deployment 1450. Each deployment may be analogous to, for example, the deployment 1330 depicted in FIG. 13. In particular, each deployment may comprise a processing system for performing one or more functions or activities, memory for storing data and/or instructions, and an interface system for communicating with other network elements (for example, other core network deployments). Each deployment may comprise one or more network functions (NFs). The term NF may refer to a particular set of functionalities and/or one or more physical elements configured to perform those functionalities (e.g., a processing system and memory comprising instructions that, when executed by the processing system, cause the processing system to perform the functionalities). For example, in the present disclosure, when a network function is described as performing X, Y, and Z, it will be understood that this refers to the one or more physical elements configured to perform X, Y, and Z, no matter how or where the one or more physical elements are deployed. The term NF may refer to a network node, network element, and/or network device.

As will be discussed in greater detail below, there are many different types of NF and each type of NF may be associated with a different set of functionalities. A plurality of different NFs may be flexibly deployed at different locations (for example, in different physical core network deployments) or in a same location (for example, co-located in a same deployment). A single NF may be flexibly deployed at different locations (implemented using different physical core network deployments) or in a same location. Moreover, physical core network deployments may also implement one or more base stations, application functions (AFs), data networks (DNs), or any portions thereof. NFs may be implemented in many ways, including as network elements on dedicated or shared hardware, as software instances running on dedicated or shared hardware, or as virtualized functions instantiated on a platform (e.g., a cloud-based platform).

FIG. 14A illustrates an example arrangement of core network deployments in which each deployment comprises one network function. A deployment 1410 comprises an NF 1411, a deployment 1420 comprises an NF 1421, and a deployment 1430 comprises an NF 1431. The deployments 1410, 1420, 1430 communicate via an interface 1490. The deployments 1410, 1420, 1430 may have different physical locations with different signal propagation delays relative to other network elements. The diversity of physical locations of deployments 1410, 1420, 1430 may enable provision of services to a wide area with improved speed, coverage, security, and/or efficiency.

FIG. 14B illustrates an example arrangement wherein a single deployment comprises more than one NF. Unlike FIG. 14A, where each NF is deployed in a separate deployment, FIG. 14B illustrates multiple NFs in deployments 1410, 1420. In an example, deployments 1410, 1420 may implement a software-defined network (SDN) and/or a network function virtualization (NFV).

For example, deployment 1410 comprises an additional network function, NF 1411A. The NFs 1411, 1411A may consist of multiple instances of the same NF type, co-located at a same physical location within the same deployment 1410. The NFs 1411, 1411A may be implemented independently from one another (e.g., isolated and/or independently controlled). For example, the NFs 1411, 1411A may be associated with different network slices. A processing system and memory associated with the deployment 1410 may perform all of the functionalities associated with the NF 1411 in addition to all of the functionalities associated with the NF 1411A. In an example, NFs 1411, 1411A may be associated with different PLMNs, but deployment 1410, which implements NFs 1411, 1411A, may be owned and/or operated by a single entity.

Elsewhere in FIG. 14B, deployment 1420 comprises NF 1421 and an additional network function, NF 1422. The NFs 1421, 1422 may be different NF types. Similar to NFs 1411, 1411A, the NFs 1421, 1422 may be co-located within the same deployment 1420, but separately implemented. As an example, a first PLMN may own and/or operate deployment 1420 having NFs 1421, 1422. As another example, the first PLMN may implement NF 1421 and a second PLMN may obtain from the first PLMN (e.g., rent, lease, procure, etc.) at least a portion of the capabilities of deployment 1420 (e.g., processing power, data storage, etc.) in order to implement NF 1422. As yet another example, the deployment may be owned and/or operated by one or more third parties, and the first PLMN and/or second PLMN may procure respective portions of the capabilities of the deployment 1420. When multiple NFs are provided at a single deployment, networks may operate with greater speed, coverage, security, and/or efficiency.

FIG. 14C illustrates an example arrangement of core network deployments in which a single instance of an NF is implemented using a plurality of different deployments. In particular, a single instance of NF 1422 is implemented at deployments 1420, 1440. As an example, the functionality provided by NF 1422 may be implemented as a bundle or sequence of subservices. Each subservice may be implemented independently, for example, at a different deployment. Each subservices may be implemented in a different physical location. By distributing implementation of subservices of a single NF across different physical locations, the mobile communications network may operate with greater speed, coverage, security, and/or efficiency.

FIG. 14D illustrates an example arrangement of core network deployments in which one or more network functions are implemented using a data processing service. In FIG. 14D, NFs 1411, 1411A, 1421, 1422 are included in a deployment 1450 that is implemented as a data processing service. The deployment 1450 may comprise, for example, a cloud network and/or data center. The deployment 1450 may be owned and/or operated by a PLMN or by a non-PLMN third party. The NFs 1411, 1411A, 1421, 1422 that are implemented using the deployment 1450 may belong to the same PLMN or to different PLMNs. The PLMN(s) may obtain (e.g., rent, lease, procure, etc.) at least a portion of the capabilities of the deployment 1450 (e.g., processing power, data storage, etc.). By providing one or more NFs using a data processing service, the mobile communications network may operate with greater speed, coverage, security, and/or efficiency.

As shown in the figures, different network elements (e.g., NFs) may be located in different physical deployments, or co-located in a single physical deployment. It will be understood that in the present disclosure, the sending and receiving of messages among different network elements is not limited to inter-deployment transmission or intra-deployment transmission, unless explicitly indicated.

In an example, a deployment may be a ‘black box’ that is preconfigured with one or more NFs and preconfigured to communicate, in a prescribed manner, with other ‘black box’ deployments (e.g., via the interface 1490). Additionally or alternatively, a deployment may be configured to operate in accordance with open-source instructions (e.g., software) designed to implement NFs and communicate with other deployments in a transparent manner. The deployment may operate in accordance with open RAN (O RAN) standards.

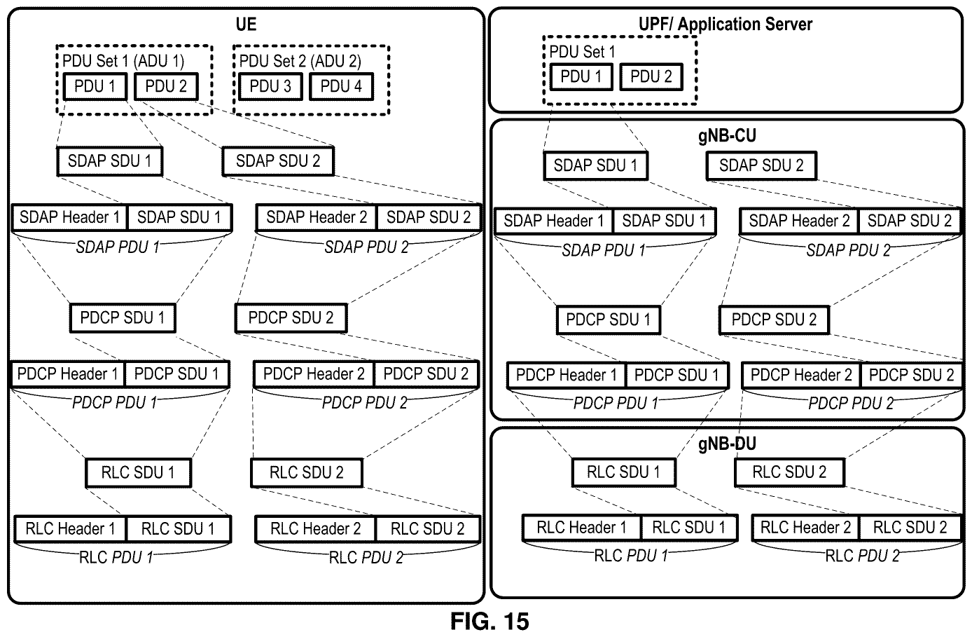

An example embodiment of FIG. 15 illustrates one example of relationship between one or more PDUs and/or one or more SDUs. For example, PDU 1 and PDU 2 may be generated by an application of a sender (a UE or in an application server). The PDU 1 and the PDU 2 may be delivered to a sending SDAP entity as a SDAP SDU 1 and 1 SDAP SDU 2. The sending SDAP entity may construct a SDAP PDU 1 from a SDAP header 1 and the SDAP SDU 1. The sending SDAP entity may deliver the SDAP PDU 1 to a sending PDCP entity. The sending PDCP entity may receive the SDAP PDU 1 as a PDCP SDU 1. The sending PDCP entity may construct a PDCP PDU 1 from a PDCP header 1 and the PDCP SDU 1. The PDCP SDU 1 may be a PDU of a PDU set. The sending PDCP entity may deliver the PDCP PDU 1 to a sending RLC entity. The sending RLC entity may receive the PDCP PDU 1 as a RLC SDU 1. The sending RLC entity may construct a RLC PDU 1 from a RLC header 1 and the RLC SDU 1. The sending RLC entity may deliver the RLC PDU 1 to a receiving RLC entity via a MAC/PHY entity. The receiving RLC entity may receive the RLC PDU 1. The receiving RLC entity may recover the RLC SDU 1 from the RLC PDU 1 and/or may deliver the RLC SDU 1 to a receiving PDCP entity. The receiving PDCP entity may receive the RLC SDU 1 as the PDCP PDU 1. The receiving PDCP entity may recover the PDCP SDU 1 from the PDCP PDU 1 and/or may deliver the PDCP SDU 1 to a receiving SDAP entity. The receiving SDAP entity may receive the PDCP SDU 1 as the SDAP PDU 1.

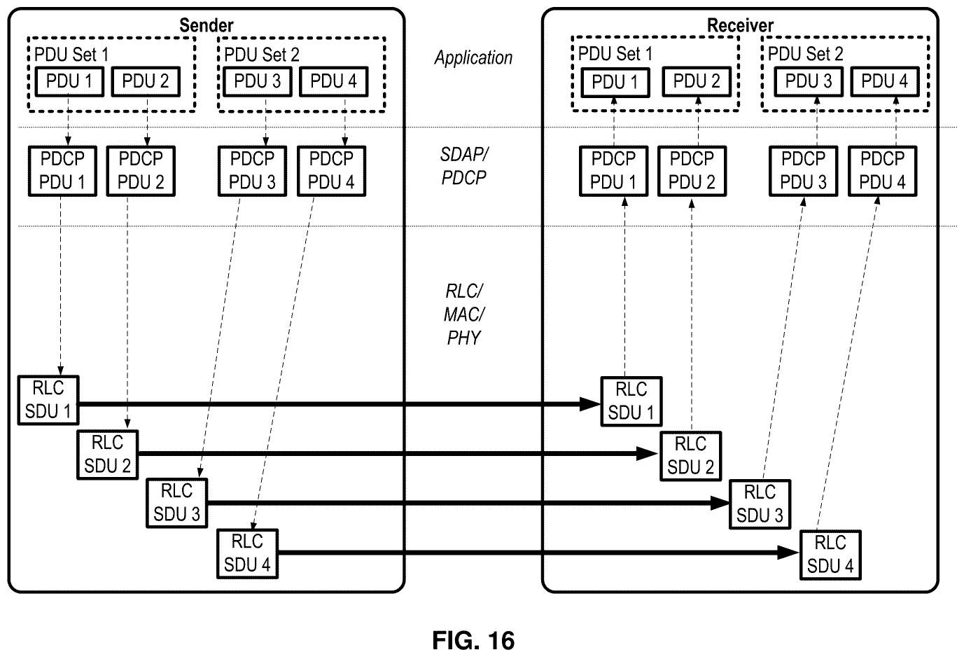

An example embodiment depicted in FIG. 16 illustrates how data generated by an application is delivered from a sender to a receiver. The unit of data generated by the application may be an application data unit (ADU). The ADU may comprise, for example, a picture file, a video frame, text file and so on. The ADU may, for example, be generated and/or created by a first instance of a particular application, for use and/or enjoyment by a second instance of the application, or for processing by an application server of the application. To reliably deliver the ADU and/or to process the ADU efficiently, the ADU may be divided into one or more smaller units. For example, the one or more smaller units may be one or more protocol data units (PDUs). One or more first PDUs (e.g., PDU 1, PDU 2) for a first ADU may be of a first PDU set (e.g., PDU set 1). In an example, the first ADU may be segmented to the one or more first PDUs. The first PDU set may comprise the one or more first PDUs. One or more second PDUs (e.g., PDU 3, PDU 4) for a second ADU may be of a second PDU set (e.g., PDU set 2). In an example, the second ADU may be segmented to the one or more second PDUs. The second PDU set may comprise the one or more second PDUs.

In an example, the application may deliver the one or more first PDUs and/or the one or more second PDUs to an SDAP/PDCP entity (e.g., a SDAP entity, a PDCP entity, and/or both a SDAP entity and a PDCP entity). The first PDU (e.g., PDU 1) may be delivered from the application to the SDAP/PDCP entity. In the SDAP/PDCP entity, the first PDU may correspond to a first SDAP SDU, a first SDAP PDU, a first PDCP SDU, and/or a first PDCP PDU. The second PDU (e.g., PDU 2) may be delivered from the application to the SDAP/PDCP entity. In the SDAP/PDCP entity, the second PDU may correspond to a second SDAP SDU, a second SDAP PDU, a second PDCP SDU, and/or a second PDCP PDU. Similarly, the PDU 3 may be a third PDCP PDU (e.g., PDCP PDU 3) and/or the PDU 4 may be a fourth PDCP PDU (e.g., PDCP PDU 4).

In an example, one or more PDCP PDUs (e.g., PDCP PDU 1, 2, 3, 4) may be delivered from the SDAP/PDCP entity to a RLC entity. The RLC layer may provide functionality of forwarding the one or more packets, for example, over a particular interface, from one node to another, using a MAC entity and/or a PHY entity.

As depicted in FIG. 16, for example, the application in the sender may generate one or more PDU sets. For example, the one or more PDU sets comprise the first PDU set and/or the second PDU set. The application in the sender may deliver the one or more PDU sets to the SDAP/PDCP entity of the sender (or a base station). The SDAP/PDCP entity may classify the one or more PDUs of the one or more PDU sets, may apply header compression to the one or more PDUs to reduce size of headers of the one or more PDUs, may apply ciphering to the one or more PDUs to provide security, and/or may generate one or more PDCP PDUs.

In an example, the SDAP/PDCP entity of the sender delivers the generated one or more PDCP PDUs to the RLC entity. The RLC entity may be responsible for transferring data between a UE and a NG-RAN, using the MAC entity and/or the PHY entity. For example, the RLC entity of the sender may process and generate one or more RLC PDUs for the one or more PDCP PDUs (e.g., RLC SDUs) delivered from the PDCP/SDAP entity. For example, the RLC entity may generate a first RLC PDU from the first PDCP PDU (e.g., the first RLC SDU) and/or the RLC entity may generate a second RLC PDU from the second PDCP PDU (e.g., the second RLC SDU).

In an example, the one or more RLC PDUs generated by the RLC entity of the sender may be delivered to the MAC entity of the sender. The MAC entity of the sender may send the one or more RLC PDUs to a MAC entity of the receiver. The MAC entity of the receiver may deliver the one or more RLC PDUs to a RLC entity of the receiver. For example, the RLC entity of the receiver may receive the one or more RLC PDUs (e.g., RLC PDU 1, 2, 3, 4). The RLC entity of the receiver may recover the one or more RLC SDUs (e.g., PDCP PDUs) using the one or more RLC PDUs. The RLC entity may deliver the one or more recovered PDCP PDUs to a PDCP entity of the receiver. The PDCP entity of the receiver may process the one or more received PDCP PDUs, and/or may recover one or more PDUs (e.g., one or more PDCP SDUs) from the one or more PDCP PDUs. To recover a PDCP SDU from a PDCP PDU may be that the PDCP SDU is extracted from the PDCP PDU.

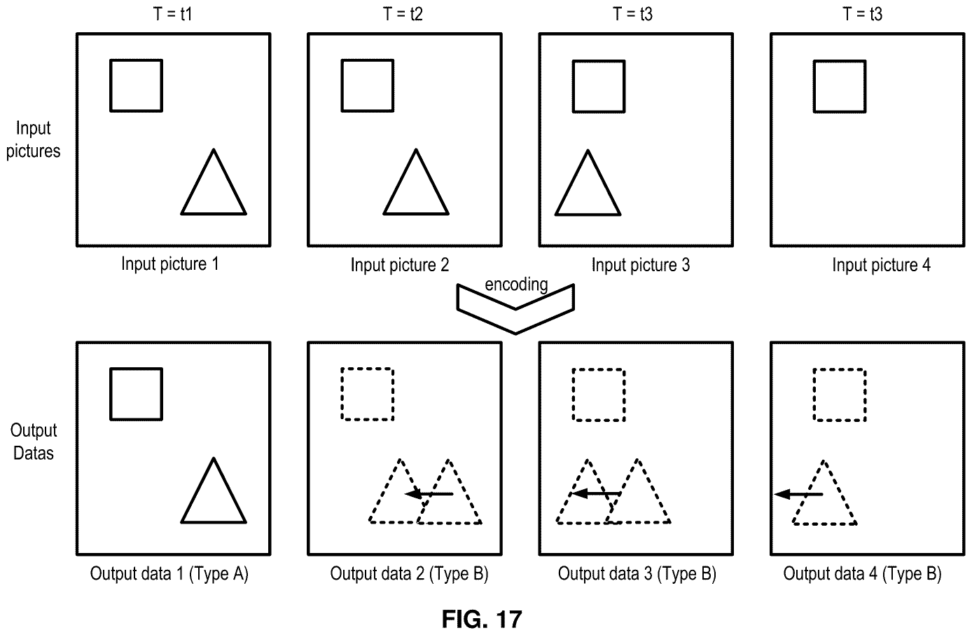

An example embodiment depicted in FIG. 17 may illustrate one example of an advanced application. FIG. 17 may show how video (e.g., sequence of movements) input pictures are represented. For example, in FIG. 17, the input pictures may show that a rectangular object does not move while a triangular object may move from the right of the screen to the left. Based on this sequence of movements, an encoder of the advanced application may generate one or more output data. The first output data (output data 1, Type A) may comprise information that describes details of a first input picture (input picture 1 at T=t1). The second output data (output data 2, Type B) may comprise information that describe difference of the first input picture and a second input picture (input picture 2 at T=t2). For example, the second output data may comprise information that the triangular object moves from the right to the left. Compared to sending the second input picture itself, sending information of changes in the pictures may reduce the amount of data that needs to be transmitted. Likewise, a third output data (output data 3, Type B) may comprise information of changes between the second input picture and a third input picture (input picture 3 at T=t3).

In an example, a sender of the video may transmit one or more output data to a receiver. For example, the one or more output data in FIG. 17 may be transmitted. The receiver may receive one or more data sent by the sender and/or the receiver may not receive one or more data sent by the sender. For example, the receiver may receive the second output data, the third output data and the fourth output data. For example, the receiver may not receive the first output data. Because the second output data includes information of changes between the first input picture and the second picture, for the recovery of the second picture from the second output data, the receiver may need the first input picture. If the first output data comprising the first input picture is not received, the receiver may not be able to recover the second input picture from the received second output data. Likewise, if the receiver does not have information of the second input picture, the receiver may not be able to recover the third input picture from the third output data. The usability of one or more output data (e.g., the second output data, the third output data, the fourth output data, less important data, less important PDU, less important PDU sets, type B data, non-FEC PDUs) may be dependent on the availability of one or more output data (e.g., the first output data, more important data, more important PDU, more important PDU sets, type A data, FEC PDUs).

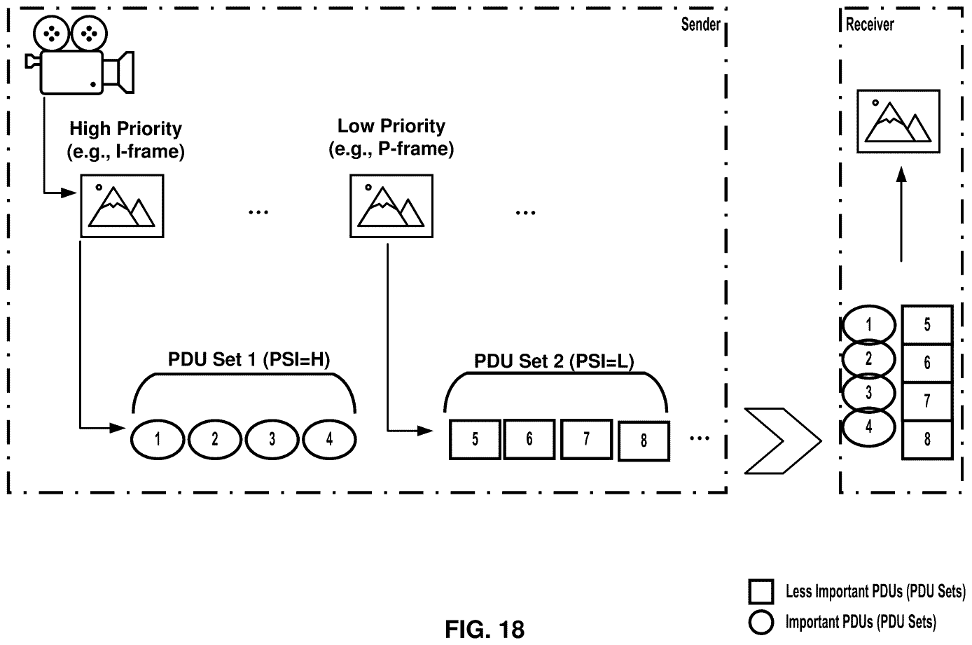

An example embodiment depicted in FIG. 18 may illustrate one or more PDU sets (comprising one or more unit of an application) generated by an application of a UE and/or an application server. In an example, the application may generate one or more PDUs. For example, the one or more PDUs may comprise one or more important (e.g., of higher priority, FEC) PDUs and/or one or more non-important (e.g., of lower priority, non-FEC) PDUs. For example, the application may generate one or more PDU sets. The one or more PDU sets may comprise one or more first PDU sets and/or one or more second PDU sets. For example, the one or more first PDU sets (e.g., comprising data unit of I frame) may be of a first PDU set importance (e.g., 1, H, high, important, PSI=1, type A, more important) and/or the one or more second PDU sets (e.g., comprising data of P frame) may be of a second PDU set importance (e.g., 0, L, low, not important, PSI=0, type B, less important). For example, the one or more PDU sets may comprise the one or more PDUs. For example, a PDU of the one or more PDUs may belong to a PDU set of the one or more PDU sets. For example, the first PDU set may comprise one or more important PDUs (e.g., PDU 1, PDU 2, PDU 3, PDU 4) for one or more important PDU sets. For example, the second PDU set may comprise one or more less-important (non-important) FEC PDUs (e.g., PDU 5, PDU 6, PDU 7, PDU 8) for one or more less-important PDU sets.

In an example, the one or more important PDUs (e.g., base PDUs, PDUs of important PDU sets) may be necessary for a receiver to properly operate and/or to support a service (or QoS) requirement. For example, in a video application, to present a picture frame to a user, the receiver may need to receive the one or more important PDUs of one or more important PDU sets to be able to use and process one or more less-important PDUs of one or more less-important PDU sets. For example, if the one or more important PDUs of the important PDU set is not received, an application of the receiver may not be able to present an adequate picture frame to a viewer, using one or more less-important PDUs of less-important PDU set.

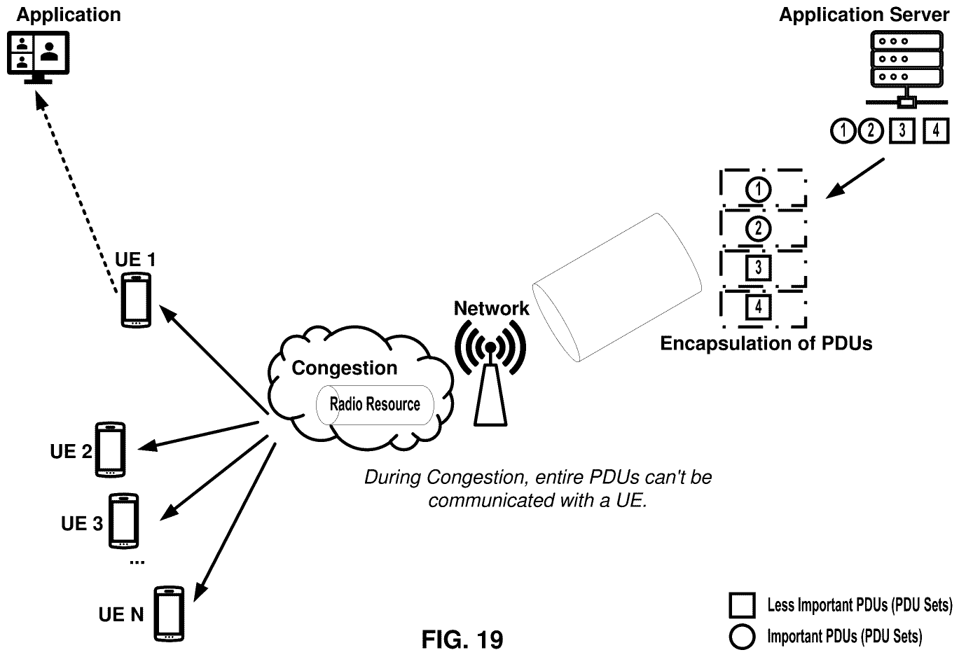

FIG. 19 may illustrate one potential implementation to support one or more applications.

In an example, an application of an application server may generate one or more application data. The one or more application data may be one or more units of information for the application. For example, the one or more application data may comprise a first application data, a second application data, and/or the like. The application may generate one or more PDUs from the one or more application data. For example, the one or more PDUs may comprise a first PDU (e.g., PDU 1), a second PDU (e.g., PDU 2), a third PDU (e.g., PDU 3), a fourth PDU (e.g., PDU 4) and/or the like. For example, the one or more application data may comprise one or more PDU sets. For example, the one or more PDU sets may comprise a first PDU set, a second PDU set, and/or the like. The first PDU set may comprise the first application data, and/or may comprise the first PDU and the second PDU. The second PDU set may comprise the second application data, and/or may comprise the third PDU and the fourth PDU. For example, the first PDU set for the first application data may be important and/or may be of high importance and/or the second PDU set for the second application data may be less important (e.g., non-important) and/or may be of lower (low) importance. The application of the application server may send one or more packets (e.g., IP packets) encapsulating the one or more PDUs, to a network, for delivery of the one or more PDUs to the UE. The network may receive the one or more packets. The network may initiate delivery of the one or more packets to the UE.

In an example, resource of the network may be congested. The resource may be a radio network resource, a computing resource, a network resource, one or more resource blocks of time and frequency, and/or the like. For example, if there are one or more UEs in the network, if the one or more UEs generate lots of data, and/or if a capacity of the network is limited, the resource of the network may be congested. When the resource of the network is congested, one or more first packets may be delivered to one or more first UEs and/or one or more second packets may not be delivered to one or more second UEs. For example, when the resource of the network is congested, the network may discard the one or more second packets. This may help for the network to alleviate the congestion, because amount of data that needs to be delivered to the UE is reduced by discarding the one or more second packets. However, in this case, if the network discards one or more important PDUs and/or PDUs of one or more important PDU sets and/or does not discard one or more less important PDUs and/or PDUs of one or more less important PDU sets, quality of experience may be degraded, because the one or more less important PDUs are not usable when the one or more important PDUs are not available to an application running at the UE.

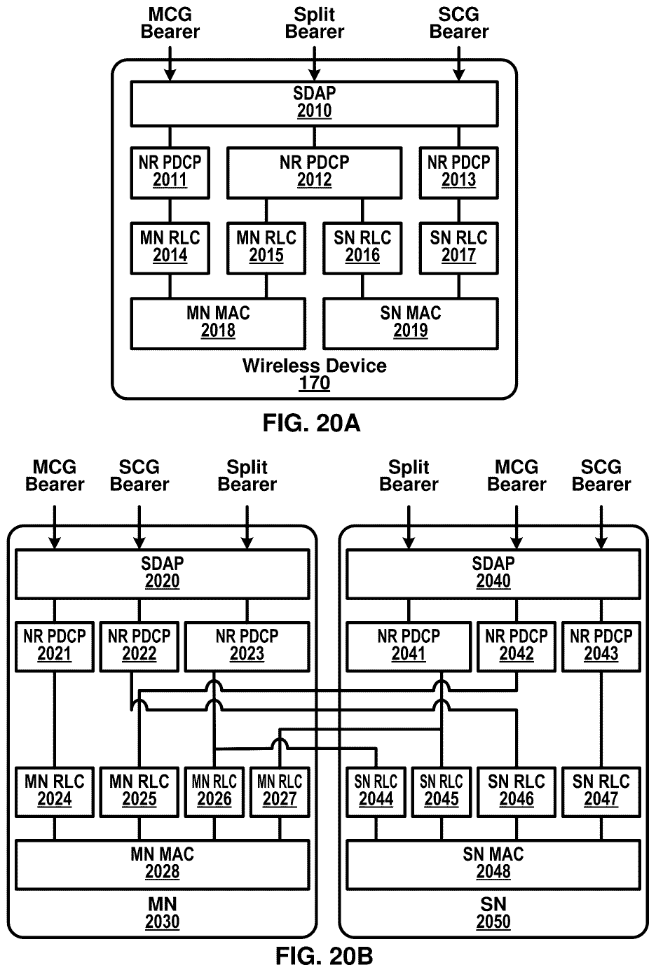

FIG. 20A and FIG. 20B illustrate an example as per an aspect of an embodiment of the present disclosure. FIG. 20A and FIG. 20B show packet flows employing a multi connectivity. The multi connectivity may be dual connectivity, multi connectivity, tight interworking, and/or the like. In multi connectivity, a UE may be served by a plurality of base stations. The plurality of base stations may comprise a master base station and/or a secondary base station. The master base station may be a MN, a master node, master gNB, master eNB, and/or the like. The second base station may be a SN, a secondary node, a secondary gNB, a secondary eNB, and/or the like. FIG. 20A is an example diagram of a protocol structure of a UE, when the multi connectivity is configured, as per an aspect of an embodiment. FIG. 20B is an example diagram of a protocol structure of multiple base stations with multi connectivity as per an aspect of an embodiment. The multiple base stations may be the plurality of base stations, may comprise a master node. A master node and a secondary node may co-work to communicate with the UE.

When the multi connectivity is configured for a UE (e.g., via an RRC reconfiguration message), the UE, which may support multiple reception/transmission functions in an RRC connected state, may be configured to utilize radio resources provided by multiple schedulers of the plurality of base stations. The plurality of base stations may be inter-connected via a non-ideal or ideal backhaul (e.g. Xn interface, X2 interface, and/or the like). Each base station involved in multi connectivity for the UE may perform at least one of two different roles: the each base station may either act as a master base station (e.g., master node, MN) or as a secondary base station (e.g., SN, secondary node). In multi connectivity, the UE may be connected to one master base station and one or more secondary base stations. In an example, the master base station may provide a master cell group (MCG) comprising a primary cell and/or one or more secondary cells for the UE. The secondary base station may provide a secondary cell group (SCG) comprising a primary secondary cell (PSCell) and/or one or more secondary cells for the UE.

In the multi connectivity, a radio protocol architecture that a bearer (e.g., a radio bearer, a logical channel, and/or the like) employs may depend on how the bearer is setup. In an example, three different types of bearer setup options may be supported: an MCG bearer, an SCG bearer, and/or a split bearer. A UE may receive/transmit one or more packets (e.g., PDUs, RLC PDUs, PDCP PDUs, MAC PDUs) of the MCG bearer via one or more cells of the MCG, and/or may receive/transmits packets of the SCG bearer via one or more cells of the SCG. The UE may receive/transmit one or more packets of the split bearer via the one or more cells of the MCG and/or via the one or more cells of the SCG. The multi-connectivity may also be described as having at least one bearer configured to use radio resources provided by the secondary base station. Multi-connectivity may or may not be configured/implemented in some of the example embodiments.

In an example, the UE may transmit and/or receive: packets of the MCG bearer via an SDAP layer (e.g. SDAP 2010), a PDCP layer (e.g. NR PDCP 2011), an RLC layer (e.g. MN RLC 2014), and a MAC layer (e.g. MN MAC 2018); packets of the split bearer via an SDAP layer (e.g. SDAP 2010), a PDCP layer (e.g. NR PDCP 2012), one of a master or secondary RLC layer (e.g. MN RLC 2015, SN RLC 2016), and one of a master or secondary MAC layer (e.g. MN MAC 2018, SN MAC 2019); and/or packets of the SCG bearer via an SDAP layer (e.g. SDAP 2010), a PDCP layer (e.g. NR PDCP 2013), an RLC layer (e.g. SN RLC 2017), and a MAC layer (e.g. SN MAC 2019).

In an example, the master base station (e.g. MN 2030) and/or the secondary base station (e.g. SN 2050) may transmit/receive: packets of the MCG bearer via a master node SDAP layer (e.g. SDAP 2020), or a secondary node SDAP layer (e.g. SDAP 2040), a master PDCP layer (e.g. NR PDCP 2021), a secondary node PDCP layer (e.g. NR PDCP 2042), a master node RLC layer (e.g. MN RLC 2024, MN RLC 2025), and a master node MAC layer (e.g. MN MAC 2028); packets of the SCG bearer via a master node SDAP layer (e.g. SDAP 2020), a secondary node SDAP layer (e.g. SDAP 2040), a master node PDCP layer (e.g. NR PDCP 2022), a secondary node PDCP layer (e.g. NR PDCP 2043), a secondary node RLC layer (e.g. SN RLC 2046, SN RLC 2047), and a secondary node MAC layer (e.g. SN MAC 2048); packets of the split bearer via a master or secondary node SDAP layer (e.g. SDAP 2020, SDAP 2040), a master or secondary node PDCP layer (e.g. NR PDCP 2023, NR PDCP 2041), a master or secondary node RLC layer (e.g. MN RLC 2026, SN RLC 2044, SN RLC 2045, MN RLC 2027), and a master or secondary node MAC layer (e.g. MN MAC 2028, SN MAC 2048).

In multi connectivity, the bearer may be terminated in at least one of the master base station and/or the secondary base station. The bearer may be a MN terminated bearer and/or a SN terminated bearer.

For the MN terminated bearer, a packet is communicated between the MN and a core network. For the MN terminated bearer, the MN may receive an uplink packet from the UE, via the SCG and/or via the MCG, and/or via the SN and/or via the MN. For the MN terminated bearer, the MN may forward and/or deliver the uplink data to the core network. The core network may be a packet anchor and/or a UPF. For the MN terminated bearer, when the MN forwards the uplink data to the core network, a path from the MN to the UPF may not comprise the SN and/or a path from the MN to the UE may comprise the SN. For example, the core network may be an UPF. For the MN terminated bearer, the MN may receive a downlink packet from the UPF. When the downlink packet is delivered from the UPF to the MN, the downlink packet may not be delivered via the SN. The MN may send and/or deliver the downlink packet to the UE, via the SCG and/or via the MCG, and/or via the SN, and/or via the MN. For example, when the MN terminated bearer is used, for communication between a base station and a core network, a data packet is communicated between the MN and the UPF, and may not be delivered via the SN to the UPF. For example, when the MN terminated bearer is used, for communication between a base station and a UE, a data packet is communicated with the MN and the UE, via the MN and/or the SN, via the MCG and/or the SCG, via the MCG bearer and/or via the split bearer.

For the SN terminated bearer, a packet is communicated between the SN and the core network. For the SN terminated bearer, the SN may receive an uplink packet from the UE, via the SCG and/or via the MCG, and/or via the MN and/or via the SN. For the SN terminated bearer, the SN may forward and/or deliver the uplink data to the core network. For the SN terminated bearer, when the SN forwards the uplink data to the core network, a path from the SN to the UPF may not comprise the MN and/or a path from the SN to the UE may comprise the MN. For example, the core network may be an UPF. For the SN terminated bearer, the SN may receive a downlink packet from the UPF. When the downlink packet is delivered from the UPF to the SN, the downlink packet may not pass through the MN. The SN may send and/or deliver the downlink packet to the UE, via the SCG and/or via the MCG, and/or via the SN, and/or via the MN. For example, when the SN terminated bearer is used, for communication between a base station and a core network, a data packet is communicated with the SN and the UPF directly, may not be delivered via the MN. For example, when the SN terminated bearer is used, for communication between a base station and a UE, a data packet is communicated with the SN and the UE, via the MN and/or the SN, via the MCG and/or the SCG, via the SCG bearer and/or via the split bearer.

For example, how a data packet for a UE is delivered between a core network to a RAN (e.g., gNB) determines whether a bearer for the data packet is MN-terminated and/or whether the bearer is SN-terminated.

For example, how a data packet for a UE is delivered between the RAN (e.g., gNB) and the UE determines whether a bearer for the data packet is a SCG bearer, a MCG bearer, a split bearer and/or the like.

For example, a first bearer may be MN-terminated MCG bearer, if a first data packet for the first bearer is communicated from a UPF to a MN and/or not via a SN; if the first data packet is communicated from the MN to a UE, via a first cell of a MCG, and/or not via a second cell of a SCG.

For example, a second bearer may be MN-terminated SCG bearer, if a second data packet for the second bearer is communicated from the UPF to the MN, and/or not via the SN; if the second data packet is communicated, from the MN to the UE, via the second cell, and/or not via the first cell.

For example, a third bearer may be MN-terminated Split bearer, if a third data packet for the third bearer is communicated from the UPF to the MN, and/or not via the SN; if the third data packet is communicated, from the MN to the UE, via the second cell and/or via the first cell.

For example, a fourth bearer may be SN-terminated MCG bearer, if a fourth data packet for the fourth bearer is communicated from the UPF to the SN and/or not via the MN; if the fourth data packet is communicated from the SN to the UE, via the first cell, and/or not via the second cell.

For example, a fifth bearer may be SN-terminated SCG bearer, if a fifth data packet for the fifth bearer is communicated from the UPF to the SN and/or not via the MN; if the fifth data packet is communicated from the SN to the UE, not via the first cell, and/or via the second cell.

For example, a sixth bearer may be SN-terminated split bearer, if a sixth data packet for the sixth bearer is communicated from the UPF to the SN and/or not via the MN; if the sixth data packet is communicated from the SN to the UE, via the first cell, and/or via the second cell.

In multi connectivity, the UE may configure multiple MAC entities: one MAC entity (e.g. MN MAC 2018) for the master base station, and other MAC entities (e.g. SN MAC 2019) for the secondary base station. In multi-connectivity, a configured set of serving cells for a wireless device may comprise two subsets: the MCG comprising one or more serving cells of the master base station, and the SCGs comprising one or more serving cells of the secondary base station. For the SCG, one or more of following configurations may be applied: at least one cell of the SCG has a configured UL CC and at least one cell of the SCG, named as a primary secondary cell (PSCell, PCell of SCG, or sometimes called PCell), is configured with PUCCH resources; when the SCG is configured, there may be at least one SCG bearer or one Split bearer; upon detection of a physical layer problem or a random access problem on a PSCell, or a number of NR RLC retransmissions has been reached associated with the SCG, or upon detection of an access problem on a PSCell during a SCG addition or a SCG change: an RRC connection re-establishment procedure may not be triggered, UL transmissions towards cells of an SCG may be stopped, a master base station may be informed by a wireless device of a SCG failure type, for split bearer, a DL data transfer over a master base station may be maintained; an NR RLC acknowledged mode (AM) bearer may be configured for a split bearer; PCell and/or PSCell may not be de-activated; PSCell may be changed with a SCG change procedure (e.g. with security key change and a RACH procedure); and/or a bearer type change between a split bearer and a SCG bearer or simultaneous configuration of a SCG and a split bearer may or may not supported.

With respect to interaction between a master base station and a secondary base stations for multi-connectivity, one or more of the following may be applied: a master base station and/or a secondary base station may maintain RRM measurement configurations of a wireless device; a master base station may (e.g. based on received measurement reports, traffic conditions, and/or bearer types) may decide to request a secondary base station to provide additional resources (e.g. serving cells) for a wireless device; upon receiving a request from a master base station, a secondary base station may create/modify a container that may result in configuration of additional serving cells for a wireless device (or decide that the secondary base station has no resource available to do so); for a UE capability coordination, a master base station may provide (a part of) an AS configuration and UE capabilities to a secondary base station; a master base station and a secondary base station may exchange information about a UE configuration by employing of RRC containers (inter-node messages) carried via Xn messages; a secondary base station may initiate a reconfiguration of the secondary base station existing serving cells (e.g. PUCCH towards the secondary base station); a secondary base station may decide which cell is a PSCell within a SCG; a master base station may or may not change content of RRC configurations provided by a secondary base station; in case of a SCG addition and/or a SCG SCell addition, a master base station may provide recent (or the latest) measurement results for SCG cell(s); a master base station and secondary base stations may receive information of SFN and/or subframe offset of each other from OAM and/or via an Xn interface, (e.g. for a purpose of DRX alignment and/or identification of a measurement gap). In an example, when adding a new SCG SCell, dedicated RRC signaling may be used for sending required system information of a cell as for CA, except for a SFN acquired from a MIB of a PSCell of a SCG.

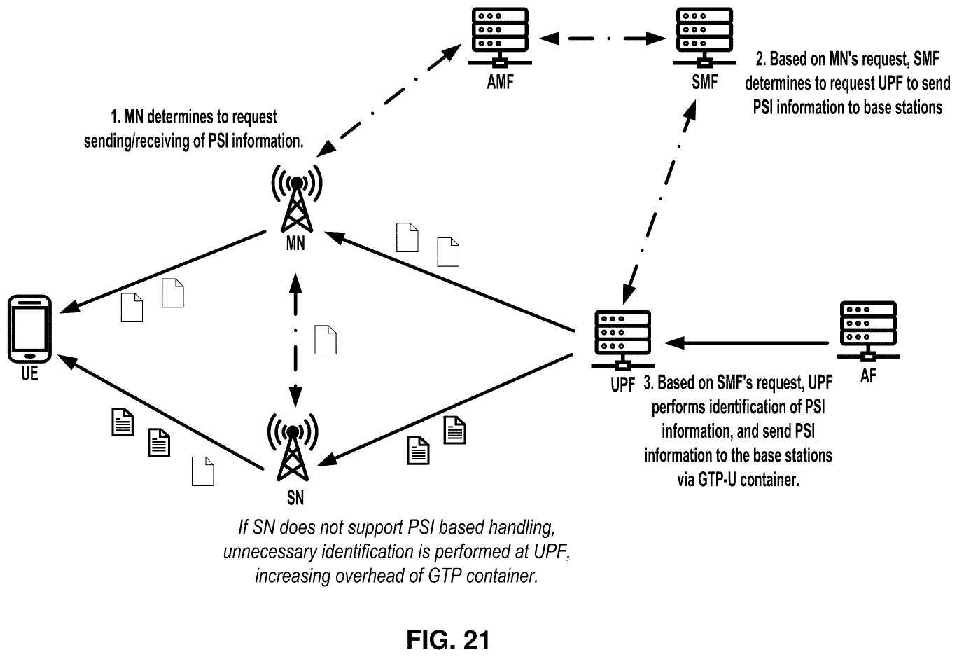

FIG. 21 illustrates an example as per an aspect of an embodiment of the present disclosure.

In an example, a UE may be configured for multi-connectivity. For multi-connectivity, the UE may be configured to communicate with a plurality of base stations. For example, the UE may establish an RRC connection with the plurality of base stations, the UE may exchange one or more RRC messages with the plurality of base stations, and/or the UE may communicate one or more user packets with the plurality of base stations.

In an example, the plurality of base stations may comprise a MN and/or a SN. The MN may be a master base station and/or the SN may be a secondary base station. The MN may be in charge of control signalling exchange between the plurality of base stations and one or more core network nodes. For example, the one or more core network nodes may comprise at least one of a mobility management node, a session management node, and/or the like. The mobility management node may be an AMF, an MME, a 6G mobility node, and/or the like. The session management node may be a SMF, a PGW, an 6G session management node, and/or the like.

In an example, the UE may be configured with one or more bearers. The one or more bearers may comprise a first bearer and/or a second bearer. For example, the first bearer may be a SN-terminated SCG bearer and/or the second bearer may be at least one of MN-terminated MCG bearer, MN-terminated SCG bearer, MN-terminated split bearer, and/or the like.

In an example, when a first downlink data for the first bearer arrives at a network from an application server, a user plane node may receive the first downlink data. For example, the user plane node may be a UPF, a PGW, a 6G gateway node, and/or the like. For example, because the first bearer is a SN-terminated bearer, because the first bearer is the SN-terminated SCG bearer and/or because the user plane node is configured to send the first downlink data to the SN, the user plane node may forward the first downlink data to the SN.

In an example, when a second downlink data for the second bearer arrives at the network from the application server, the user plane node may receive the second downlink data. For example, because the second bearer is a MN-terminated bearer, and/or because the user plane node is configured to send the second downlink data to the MN, the user plane node may forward the second downlink data to the MN.

In an example, a radio resource of the MN may be congested. To alleviate radio resource congestion, the MN may determine to discard one or more PDUs and/or one or more PDU sets. For example, to reduce impact on user experience and/or to handle the radio resource congestion, the MN may determine to deliver to the UE one or more first PDUs of one or more important PDU sets, and/or to discard one or more second PDUs of one or more less important PDU sets.

In an example, to discard the one or more second PDUs and/or not to discard the one or more first PDUs, the MN may determine to use PDU set importance (PSI) information for each PDU. For example, if the MN is not able to determine PSI information of the each PDU, the MN may determine to send to the core network node, a request for delivery of PSI information (e.g., PSI information marking activation indication). For example, the PSI information may be an information indicating importance of a PDU set of a PDU. For example, for a first PDU of the one or more first PDUs, a first PSI information may indicate that a first PDU set to which the first PDU belongs is of high importance. For example, for a second PDU of the one or more second PDUs, a second PSI information may indicate that a second PDU set to which the second PDU belongs is of lower importance.

In an example, when the user plane node sends one or more downlink packets to the MN, if the user plane node sends one or more PSI information for the one or more downlink packets, this may help the MN to determine which downlink packets need to be delivered to the UE and/or which downlink packets can be discarded.

In an example, the MN may send the request for delivery of PSI information to the core network node. For example, the session management node may receive the request. In response to receiving the request, the session management node may send a configuration message to the user plane node. For example, the configuration message may comprise a request that the user plane node identifies the one or more PSI information for one or more downlink packets (e.g., PDUs) and/or that the user plane node sends the one or more PSI information with the one or more downlink packets to the plurality of base stations.

In an example, the user plane node may receive the one or more downlink data packets. The one or more downlink data packets may comprise one or more first downlink data packets and/or one or more second downlink packets. For example, based on receiving the one or more first downlink data packets and/or based on the configuration message, and/or based on the request, the user plane node may send to the SN, one or more first GTP containers. The one or more first GTP containers may comprise the one or more first downlink data packets and/or one or more first PSI information for the one or more first downlink data packets. For example, based on receiving the one or more second downlink data packets and/or based on the configuration message, and/or based on the request, the user plane node may send to the MN, one or more second GTP containers. The one or more second GTP containers may comprise the one or more second downlink data packets and/or one or more second PSI information for the one or more second downlink data packets.

In an example, the plurality of base station may receive the one or more first GTP containers and/or the one or more second GTP containers. In an example, if the MN supports processing of the one or more PSI information and/or if the MN supports discarding on one or more PDUs based on the one or more PSI information, this may help for the MN to alleviate the radio resource congestion. For example, to identify a PSI information for a received downlink packet, the user plane node performs deep packet inspection for the received downlink packet. The deep packet inspection may require a lot of processing at the user plane node and/or may incur delivery delay due to processing, because it requires to analyze one or more headers of one or more protocols of the received downlink packet. In some existing implementation, if the SN does not support processing of the one or more PSI information and/or if the SN does not support discarding on one or more PDUs based on the one or more PSI information, the delivery of the one or more PSI information may cause waste of network resource.

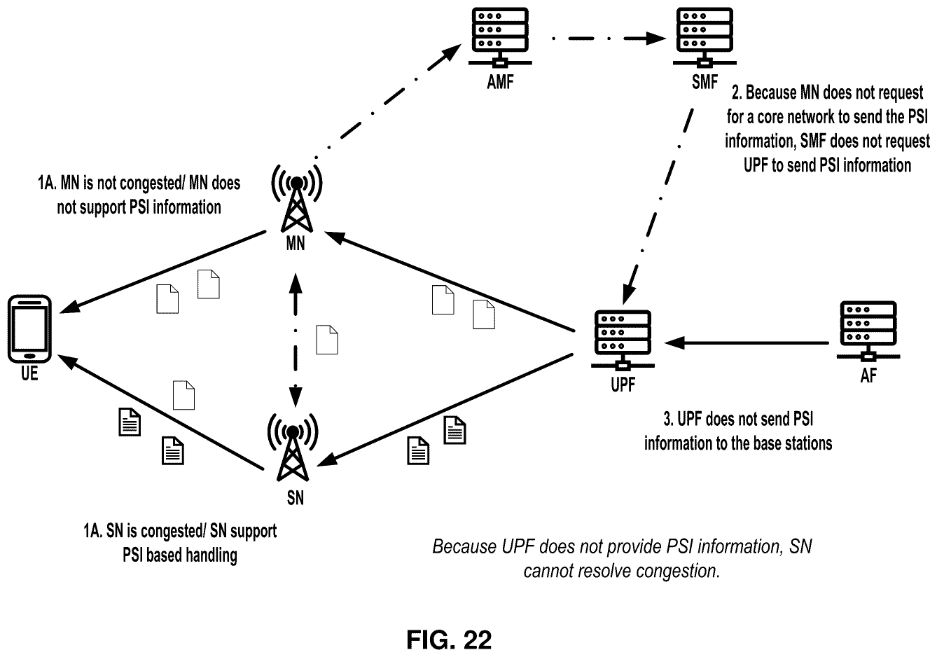

FIG. 22 illustrates an example as per an aspect of an embodiment of the present disclosure.

In an example, a UE may be configured for the multi-connectivity. For example, the UE may be configured with the one or more bearers (as shown in the example of FIG. 21).

In an example, a second radio resource of the SN may be congested and/or the SN may be able to support processing of one or more PSI information. In an example, a first radio resource of the MN may not be congested and/or the MN may not be able to support the processing of the one or more PSI information.

In an example, because the MN does not support the processing of the one or more PSI information and/or the first radio resource of the MN is not congested, the MN may not send to the core network node, the request to deliver the PSI information. Because the core network node does not receive the request, the core network node may not send to the user plane node, the configuration message requesting delivery of the PSI information to the plurality of base stations. Because the user plane node is not configured to send the PSI information, the user plane node may not send the PSI information. For example, the SN cannot receive the PSI information, because the user plane node does not send the PSI information. When a resource of the SN is congested, in existing implementations, the SN may not be able to alleviate congestion of the second radio resource, because the PSI information is not available. When a resource of the SN is congested, in existing implementations, the SN may discard one or more PDUs of high importance, because the PSI information is not available.

Example embodiments of the present disclosure solve the above issues by enhancement in signalling among one or more base stations, a UE, and/or one or more core network nodes. The one or more base stations and/or the one or more core network nodes may exchange capability information indicating support of PSI information delivery and/or request of PSI information delivery, and/or the like. This may help a base station to receive the PSI information when needed. This may help avoiding unnecessary use of network resource for identifying the PSI information, when the one or more base station is not congested. In another example, a source base station may exchange a status information of the PSI information delivery, with a target base station. This may help the target base station to reduce unnecessary signalling to the one or more core network node. In another example, the one or more base station may exchange signalling with the UE, to indicate where the one or more base station perform PSI based handling. This may help for the UE to determine whether one or more PDUs are discarded.

In the specification, the term “network system” may be interpreted as, or may refer to, a communication system, and/or a generation of the communication system. For example, one or more network systems may comprise an EPS, a 5GS, a 6th generation (6G) system, and/or the like. For example, a first network system may be the EPS. The EPS may comprise of one or more UEs, one or more eNB, one or more en-gNBs, and/or one or more EPCs. The one or more EPCs may comprise a MME, a SGW, a PGW (e.g., a PGW-C+SMF, a PGW-U+UPF), HSS, PCRF, and/or the like. For example, a second network system may be the 5GS. The 5GS may comprise of one or more UEs, one or more gNB, one or more ng-eNBs, one or more 5G core networks. The one or more 5G core networks may comprise one or more core network nodes. The one or more core network nodes may comprise an AMF, a SMF, a PCF, a UPF, a UDM, a NEF, and/or the like. In some embodiments, a core network node may be a combination of one or more core network nodes of one or more core networks. For example, a SMF+PGW-C (e.g., PGW-C+SMF) may act as both a SMF and a PGW (e.g., PGW-C). For example, a SMF may act as a 5G core network node and a 6G core network node. For example, a third network system may be a 6th generation (6G) system (6GS). The 6GS may comprise of one or more UEs, one or more 6G-RAN (e.g., a radio access network node of 6G system), one or more 6gNBs (e.g., an equivalent of gNB for 6GS), one or more 6G core networks. The one or more 6G core networks may comprise one or more 6G core network nodes (e.g., 6G core network functions). Each of the one or more core network nodes may support (implement) one or more functions (or services) provided by each of the one or more 5G core network nodes. For example, a node of the 6GS may perform a function of a radio access network and/or one or more roles performed by one or more 6G core network nodes (or by 5G core network nodes).

In the specification, the term “5G System” may be interpreted as, or may refer to, a 3GPP system consisting of at least one of 5G access network (or NG-RAN), 5G core network and/or a UE.

In the specification, the term “EPS” may be interpreted as, or may refer to, a 3GPP system consisting of at least one of EPC, E-UTRAN and/or a UE.

In the specification, the term “network node” may be interpreted as, or may refer to, at least one of a core network node, an access node, a base station, a UE, the like, and/or a combination thereof. A network may comprise one or more network nodes.

In the specification, the term “core network node” may be interpreted as, or may refer to, a core network device, which may comprise at least one of an AMF, a SMF, a NSSF, a UPF, a NRF a UDM, a PCF, a SoR-AF, an AF, an DDNMF, an MB-SMF, an MB-UPF, a MME, a SGW, a PGW, a SMF+PGW-C, a SMF+PGW-U, a UDM+HSS and/or the like. The core network node may be a 5G core network node, a 6G core network node, a 4G core network node, the likes, and/or a combination thereof. One or more names may be used by a core network node. A function performed by a first core network node of 5GS may be performed by a second core network node of 6GS.

In the specification, the term “5G core network” may be interpreted as, or may refer to, a core network connecting to a 5G access network. This may be 5G core (5GC).

In the specification, the term “5G access network” may be interpreted as, or may refer to, an access network comprising at least one of a NG-RAN and/or non-3GPP RAN, and connecting to a 5G core network.

In the specification, the term “3GPP RAN” may be interpreted as, or may refer to, a radio access network using 3GPP RAT. For example, this may comprise at least one of a gNB, an eNB, a ng-eNB, an en-gNB, the like, and/or a combination thereof. For example, this may be at least one of an E-UTRAN, NG-RAN, 6G-RAN (6th generation RAN), the like, and/or a combination thereof. The 3GPP RAN may be 3GPP access node.

In the specification, the term “NG-RAN” may be interpreted as, or may refer to, a base station, which may comprise at least one of a gNB, a ng-eNB, a relay node, a base station central unit (e.g., gNB-CU), a base station distributed unit (e.g., gNB-DU), and/or the like. This may be a radio access network that connects to 5GC, supporting at least one of NR, E-UTRA, and/or a combination thereof.

In the specification, the term “E-UTRAN” may be interpreted as, or may refer to, a base station, which may comprise at least one of an eNB, an en-gNB, and/or the like. This may be a radio access network that connects to evolved packet core (EPC), supporting at least one of NR, E-UTRA, and/or a combination thereof.

In the specification, the term “mobility management node” may be interpreted as, or may refer to, a function and/or a node performing mobility management for a UE. For example, mobility management may be at least one of management of registration status, management of context, management of authorization, management of registration area, management of paging, and/or the like. For example, the mobility management node may comprise at least one of a MME, AMF, and/or the like.

In the specification, a term “procedure” may be interpreted as, or may refer to, comprising sending by a first node to a second node a first message, receiving by the second node from the first node the first message, sending by the second node to the first node a second message, and/or receiving by the first node from the second node the second message. The first node may be one or more first network nodes, and the second node may be a one or more second network nodes. The procedure may comprise a registration procedure, a deregistration procedure, a service request procedure, a notification procedure, a PDU session establishment procedure, a PDU session modification procedure, a UE configuration update procedure, a cell selection procedure, a cell reselection procedure, a random access procedure, a capability update procedure, and/or the like.

In the specification, a term “NAS message” may be interpreted as, or may refer to, a message exchanged between a UE and a core network node. The NAS message may be exchanged via a 3GPP access and/or via a N3GPP access. The NAS message may comprise a MM (mobility management) message, a SM (session management) message, and/or the like. The MM message may comprise a registration request message, a registration accept message, a registration reject message, a UE configuration update message, a UL NAS transport message, a DL NAS transport message, a deregistration message, a service request message, a service accept message, a service reject message, a PDU session establishment request message, a PDU session establishment accept message, a PDU session establishment reject message, a PDU session modification request message, a PDU session modification accept message, a PDU session modification reject message, a PDU session modification command message, a PDU session release request message, a PDU session release command message, and/or the like.

In an example, a timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to change of the value). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a network slice inactivity window timer (e.g., a NS UE monitoring timer, a NS PDU monitoring timer) may be used for measuring a window of time for measuring the network slice inactivity. In an example, instead of starting and expiry of a network slice inactivity window timer, the time difference between two time stamps may be used. When a timer is restarted, a process for measurement of time window may be restarted. Other example implementations may be provided to restart a measurement of a time window.

In an example, indication (e.g., indicate, indicating) may be achieved in various ways. For example, a first indication may be done by including a first field in a first signalling (e.g., a message). Alternatively and/or additional, a second indication may be done by not including the first field in the first signalling. For example, if a first message comprises the first field (e.g., used/assigned for the first indication, e.g., field A), the first indication (e.g., a timer is used) may be done (e.g., achieved, delivered from a sender to a receiver). For example, if the first field in the first message is set to a value A, a third indication (e.g., timer value is value A) may be done. For example, if the first message does not comprise the first field, the second indication (e.g., timer is not used) may be done. In another example, a fourth indication (e.g., a UE is allowed for action C) may be done by sending a second signalling (e.g., a message whose name comprises ‘C’ and/or ‘accept’). Alternatively and/or additionally, a fifth indication (e.g., a UE is not allowed for action C) may be done by not sending the second signalling (e.g., a message, a field (e.g., allowed bit)). For example, the sender can indicate A, by sending a message A1 comprising an indicator (e.g., an information element) indicating A and/or by sending a message A2. For example, the message A2 may be used only to indicate A and/or the message A2 itself may indicate the A. For example, when a first entity indicates to a second entity about first something, the first entity may send to the second entity, an indicator (e.g., an information element) indicating the first something, and/or may send to the second entity, a message comprising the indicator and/or may send a first dedicated message for the first something. In other example, when a first entity does not indicate to a second entity about second something, the first entity may not send to the second entity, a first indicator (e.g., an information element) indicating the second something, may not send to the second entity, a message comprising the first indicator, and/or may send to the second entity, a second indicator indicating that the second something does not apply, and/or may send a message not comprising the first indicator, and/or may send to the second entity, a second dedicated message for indicating the second something. In another example, not sending any message may be interpreted as an indication. In an example, indicate may mean comprise one or more parameter indicating.

In an example, ‘based on a message (one or more messages)’ may be interpreted, or may refer to, as, ‘based on one or more information (one or more parameters) included in the message (the one or more messages)’, ‘using (acting) on one or more information (one or more parameters) included in the message (the one or more messages)’, and/or the like.

In the specification, “protocol entity” may be interpreted, or may refer to, as an entity performing a set of specific functions related to a wireless access (e.g., LTE access, NR access) and/or a wireline access (e.g., Ethernet) and/or communication (e.g., TCP, IP). In an example, an entity (or a layer) may be interpreted as a protocol entity (or a protocol layer). In an example, the protocol entity of LTE and/or NR may be at least one of a SDAP entity, a PDCP entity, a RLC entity, a MAC entity, a RRC entity, a NAS entity, and/or a PHY entity. In an example, a layer (e.g., a SDAP layer, a PDCP layer, a RLC layer, a MAC layer a PHY layer, a RRC layer, a NAS layer) may be interpreted as a protocol entity (e.g., SDAP entity, a PDCP entity, a RLC entity, a MAC entity, a PHY entity, a RRC entity, a NAS entity).

In the specification, “PSI information” may be interpreted, or may refer to importance of a PDU set compared to other PDU sets with a QoS flow or across one or more QoS flows. Each PSI information may indicate a value. Lower values of the each PSI information may indicate a higher importance. Higher values of the each PSI information may indicate a lower importance. Value “0” of the each PSI information may mean that a sender cannot define importance. A PDU Set with the highest importance PDU Set may be indicated by a value “1” and the lowest importance PDU Set may be indicated by a value “15”. PSI information may be a PSI.

In the specification, “PDU Set sequence number (PSSN)” may be interpreted, or may refer to a sequence number of the PDU set to which a PDU belongs. The PSSN may act as an identifier for the PDU Set. In the specification, PDU set sequence number, PDU set sequence, a number of PDU set sequence and/or the like may be a PDU set information. In an example, the PDU set information may comprise at least one of the PSSN, the PSI information, and/or the like.

In the specification, “PDU Set based handling indicator” may be interpreted, or may refer to an indicator indicating whether PDU set based handling is supported.

In the specification, “PDU Set based handling” may be interpreted, or may refer to at least one of identifying a PDU set information for a PDU, using the PDU set information for the PDU, discarding one or more PDUs belongs to a PDU set, supporting PDU set QoS parameters for the one or more PDUs belonging to the PDU set, and/or the like.

In the specification, “PDU Set information” may be interpreted, or may refer to, for a PDU or a PDU set of the PDU, at least one of a PDU set sequence number, indication of End PDU of the PDU set, PDU sequence number within the PDU set, a PDU set size in bytes, a PDU set importance, and/or the like.

In the specification, “PSI based handling” may be interpreted, or may refer to at least one of identifying a PDU set associated with a PDU, identifying a PDU set importance for the PDU, identifying the PDU set importance for the PDU set of the PDU, using the PSI information, processing the PSI information, delivery of the PSI information, determining whether to discard the PDU of the PDU set based on the PSI information, determining priority of the PDU and/or the PDU set based on the PSI information, and/or the like. When a node (e.g., a base station, a UE, a core network node) supports PDU set based handling, the node may support PSI based handling, and/or may not support the PSI based handling. When the node supports the PSI based handling, the node may support PDU set based handling, and/or may not support the PDU set based handling. In an example, support for PSI based handling may be support for PSI information marking, and/or PDU set information marking. In an example, request for PSI information may be support for PSI information marking activation indication, and/or PDU set information marking activation indication.

In the specification, “delivery of PSI information” may be interpreted, or may refer to at least one of identifying a PDU set associated with a PDU, identifying a PDU set importance for the PDU, marking the PSI information, sending the PSI information to other nodes (e.g., UE, a base station, a core network node) via a user plane (e.g., GTP header) and/or a control plane (e.g., configuration signalling)

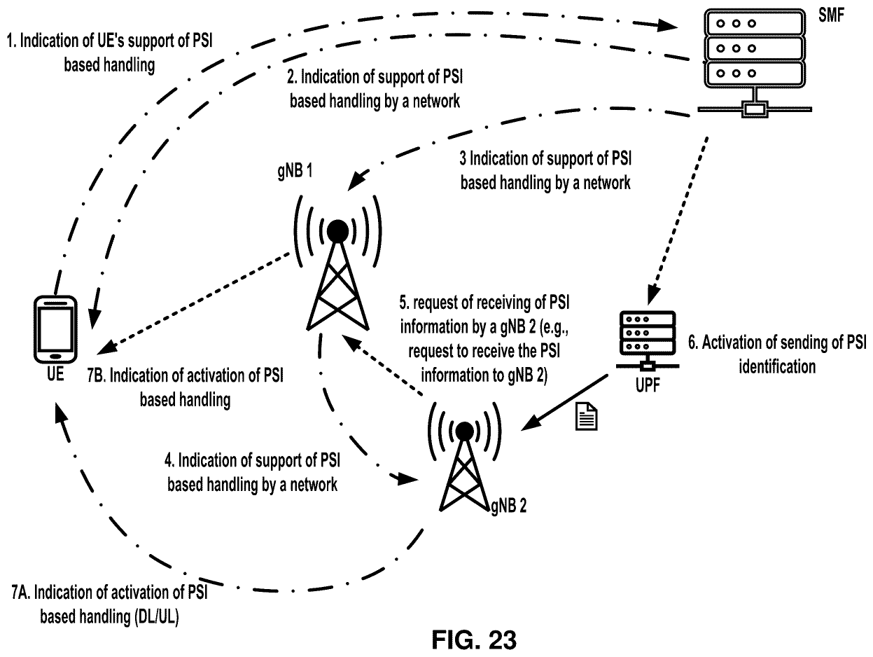

FIG. 23 illustrates an example as per an aspect of an embodiment of the present disclosure. In an example, a UE may indicate whether the UE supports PSI (PDU set importance) based handling. This may help for one or more base stations to determine whether to activate, request and/or support discarding one or more PDUs, based on importance of one or more PDU sets associated with the one or more PDUs. This may help reduce unnecessary activation/deactivation of delivery PSI information, and/or PSI based handling. For brevity, based on the other part of the present disclosure, redundant details will be omitted.

In an example, a UE may send one or more first messages to a core network node. For example, the one or more first messages may be one or more first NAS messages. For example, each of the one or more first NAS messages may be at least one of a registration request message, a PDU session establishment request message for a PDU session, a service request message for the PDU session, a PDU session modification request message for the PDU session, and/or the like. For example, the core network node may be at least one of a session management node, a mobility management node, a policy control node, and/or the like. The session management node may be an SMF and/or the like.

In an example, based on that the UE supports PSI based handling and/or PDU session based handling, a first message of the one or more first messages may comprise one or more first parameters. The one or more first parameters may indicate at least one of a first capability parameter indicating whether the UE supports the PDU set based handling, a second capability parameter indicating whether the UE supports the PSI based handling. The one or more first parameters may help the core network node to determine whether to send PDU set related information or not, and/or whether to configure delivery of the PSI information.

In an example, based on receiving the one or more first messages, the core network node may send one or more second messages to the UE. The one or more second messages may be one or more second NAS messages. The one or more second NAS messages may comprise one or more second parameters. The one or more second parameters may comprise at least one of:
one or more first configuration parameters. Each first configuration parameter of the one or more first configuration parameters may indicate configuration for each PDU session of one or more PDU sessions. The each first configuration parameter may indicate whether a network, a core network and/or the core network node supports the PSI based handling for the each PDU session. Supporting the PSI based handling may be that delivery of the PSI information for the each PDU session from a user plane node (of the core network) to the one or more base stations are supported. Supporting the PSI based handling may be supporting PSI information marking. For example, for a 10^{th} PDU session of the one or more PDU sessions, the one or more first configuration parameter may indicate that the PSI based handling is supported. For example, for a 11^{th} PDU session of the one or more PDU sessions, the one or more first configuration parameter may indicate that the PSI based handling is not supported.
one or more second configuration parameters. Each second configuration parameter of the one or more second configuration parameters may be associated with the each PDU session and/or may be used for the each PDU session. Each second configuration parameter may indicate whether the network, the core network and/or the core network node supports delivery of a PDU set sequence information, and/or the like, for the each PDU session. In some example, the first configuration parameter may be the second configuration parameter. In another example, the first configuration parameter may be different from the second configuration parameter. In some cases, when the core network node supports delivery of the PDU set sequence information, when the core network sends a PDU to a base station, the core network may send the PSI information to the base station. For example, the PDU set sequence information may be a sequence number of a PDU set and/or may be a PDU set information. For example, when the PDU set information marking is supported and/or activated, the core network node may send the PDU set information to the base station. In some implementations, the PDU set information may and/or may not comprise the PSI information.
one or more PDU session identifiers of the one or more PDU sessions.
one or more bearer identifiers of one or more bearers of the one or more PDU sessions. For example, the one or more bearer identifiers may be one or more QoS flow identifiers and/or one or more radio bearer identifiers.

In an example, based on receiving the one or more first messages, the core network node may send one or more first N2 messages to one or more first base stations. The one or more first base stations may comprise a first base station. The one or more first base stations may establish a signalling connection with the core network node. The first base station may be at least one of a MN, a master node, a master base station, and/or the like. The first base station may not be a SN, a secondary node, a secondary base station, and/or the like. The one or more first N2 messages may comprise one or more second parameters. The one or more second parameters may comprise at least one of:
the one or more first configuration parameters. This may be PSI information marking support indicator. This may indicate that DL PSI information marking is supported. That DL PSI information marking is supported may be that a core network (e.g., UPF) supports identifying/sending/delivering PSI information (e.g., to a base station).
the one or more second configuration parameters. This may be PDU set information marking support indicator. This may indicate that DL PDU set information marking is supported. That DL PDU set information marking is supported may be that a core network (e.g., UPF) supports identifying/sending/delivering PDU set information (e.g., to a base station).
the one or more PDU session identifiers.
the one or more bearer identifiers.

In an example, the first base station may determine to use multi-connectivity (e.g., dual connectivity) for the UE. For example, to increase reliability of communication toward the UE, the first base station may use the multi-connectivity. In response to determining to use the multi-connectivity, the first base station may select one or more second base stations. The one or more first base stations may not comprise the one or more second base stations. The one or more second base stations may not have signalling connection to the core network node and/or may have a user plane connection to the user plane node. The one or more second base stations may comprise a second base station. The second base station may be at least one of a SN, a secondary node, a secondary base station, and/or the like.

In an example, the first base station may send to the one or more second base stations, one or more first Xn messages. The one or more first Xn messages may comprise a first Xn message. The first Xn message may be at least one of S-Node addition Request message, S-Node modification request message, S-Node modification confirm message, Handover request message, handover request acknowledge message, Retrieve UE context request message, Retrieve UE context response message and/or the like.

In an example, the first Xn message may comprise at least one of:
the one or more first configuration parameters. The each first configuration parameter of the one or more first configuration parameters may indicate configuration for each PDU session of one or more PDU sessions. The each first configuration parameter may indicate whether the PSI based handling is supported for the each PDU session. Supporting the PSI based handling may be that delivery of the PSI information for the each PDU session to the one or more second base stations are supported. Supporting the PSI based handling may be supporting PSI information marking.
the one or more second configuration parameters. The each second configuration parameter of the one or more second configuration parameters may be associated with the each PDU session and/or may be used for the each PDU session. Each second configuration parameter may indicate whether delivery of a PDU set sequence information (e.g., PDU set information) is supported, and/or the like, for the each PDU session. In some example, the first configuration parameter may be the second configuration parameter. In another example, the first configuration parameter may be different from the second configuration parameter.
the one or more PDU session identifiers.
the one or more bearer identifiers.

In an example, a second base station of the one or more second base stations may receive the first Xn message.

In an example, the second base station may determine whether a second resource managed by the second base station is congested or not, whether PSI information is required, for which PDU session the PSI information is required, whether the second base station needs to request (e.g., activate) delivery of the PSI information, and/or the like. For example, the second resource may be managed by one or more base stations distributed units and/or one or more base station central unit user plane.

In an example, in response to determining one or more PDU sessions for which the PSI information is required, the second base station may send a second Xn message to the first base station. For example, based on that one or more bearers of the one or more PDU sessions are SN-terminated bearers, based on that the one or more bearers are SN-terminated SCG bearers, and/or based on determining that the PSI information is required, the first base station may send the second Xn message. For example, the second Xn message may be sent via the Xn-C (Xn control plane) and/or may not be sent via the Xn-U (Xn user plane) interface. For example, based on that the one or more bearers are not split bearers, and/or based on that the one or more bearers are not MCG bearers, Xn-U (e.g., Xn user plane, PDCP) interface may not be available between the first base station and the second base station. Because the Xn-U interface is not available, the second base station may send the second Xn message via the Xn-C interface (e.g., Xn-AP protocol). For example, the second Xn message may not be sent via a GTP container. For example, the second Xn message may be sent over SCTP protocol. In another example, if the one or more bearers are SN-terminated MCG bearers, a split bearer, a MN terminated bearer, the second XN message may be sent via the Xn-U interface.

For example, the second Xn message may be at least one of S-Node addition Response message, S-Node modification response message, S-node modification required message, Handover request message, handover request acknowledge message, Retrieve UE context request message, Retrieve UE context response message and/or the like.

For example, the second Xn message may comprise at least one of:
one or more third parameters. Each third parameter of the one or more third parameters may be associated with each PDU session. The each third parameter may indicate whether the PSI based handling for the each PDU session is requested, whether the second base station configures the PSI based handling for the each PDU session, whether the second base station supports the PSI based handling for the each PDU session, whether activation of marking of the PSI information is recommended, whether activation of the marking of the PDU set information is recommended, and/or whether delivery of the PSI information is requested for the each PDU session. For example, because the resource of the second base station is congested, because the second base station needs the PSI information, and/or the like, at least one of the one or more third parameters may indicate that delivery of the PSI information is requested for the each PDU session, that PSI based handling is configured, that the PSI based handling is active, that activation of marking of the PSI information is recommended, that the PSI handling starts, and/or the like. For example, the one or more third parameters may indicate that PSI information delivery is required for a 21st PDU session and/or that PSI information delivery is not required for a 22th PDU session. For example, the one or more third parameters may indicate a request for the core network (e.g., the core network node, the user plane node) to send the PSI information to the one or more base stations (e.g., the one or more second base stations), a request for activation of marking of the PSI information, an indication indicating that the second base station supports the PSI based handling, and/or a request for the one or more base stations to receive the PSI information from the core network.
one or more fourth parameters. Each fourth parameter of the one or more fourth parameters may be associated with the each PDU session. Each fourth parameter may indicate whether the PDU set based handling for the each PDU session is requested, whether the second base station configures the PDU set based handling for the each PDU session, whether the second base station supports the PDU set based handling for the each PDU session, whether the second base station requests delivery of the PDU set sequence number delivery, and/or the like. For example, because the second base station is congested, because the second base station needs the PSI information, at least one of the one or more fourth parameters may indicate that delivery of the PDU set information is requested, that PDU set based handling is configured, that the PDU set based handling is active, that the PDU set based handling starts, and/or the like.
one or more indicators indicating whether the second base station is congested or not, for the each PDU session.
the one or more PDU session identifiers, for which PSI information is requested.
the one or more bearer identifiers, for which PSI information is requested. For example, the one or more bearer identifiers may be the one or more QoS flow identifiers and/or the one or more radio bearer identifiers.

In an example, the first base station may receive the one or more second Xn messages. For example, based on the second Xn message of the one or more second Xn messages, the first base station may determine whether to send one or more second N2 messages to the core network node. For example, based on that the second base station requests delivery of PSI information for a first PDU session of the one or more first PDU session, based on that the second base station indicates supports of the PSI information for the first PDU session, based on that the second base station indicates resources congestion for the first PDU session, and/or based on that the second base station configures PSI based handling, the second base station may determine to send to the core network node, the one or more second N2 messages. For example, the one or more second N2 messages may comprise:
one or more fifth parameters. Each fifth parameter of the one or more fifth parameter may indicate whether delivery of the PSI information for one or more first PDU sessions is requested, whether PSI based discarding for the one or more first PDU sessions is activated/deactivated, whether PSI based handling is support for the one or more first PDU sessions, whether activation of PSI information marking is requested, and/or the like. For example, the one or more fifth parameters may be one or more PSI based handling indicators. For example, the one or more fifth parameters may indicate that PSI based handling is required/activated for a 31^{st} PDU session. For example, the one or more fifth parameters may indicate that PSI based handling is not required/activated for a 32nd PDU session. This may be PSI based handling support indication and/or the PSI information marking activation indication.
one or more sixth parameters. Each sixth parameter of the one or more sixth parameters may indicate request for delivery of the PDU set information for the one or more first PDU sessions, support for PDU set based handing for the one or more first PDU sessions, activation of PDU set based handling for the one or more first PDU sessions, and/or the like. For example, the one or more sixth parameters may be one or more PDU set based handling indicators, one or more PDU set information marking activation indicators. In another example, the one or more sixth parameters may and/or may be the one or more fifth parameters. In one example, the one or more fifth parameters may indicate activation of PSI information marking and/or the one or more sixth parameter may indicate activation of PDU set information marking, PDU set sequence marking, and/or may not indicate activation of PSI information marking. In another example, the one or more fifth parameters may indicate activation of PSI information marking and/or the one or more sixth parameter may indicate activation of PDU set information marking, PDU set sequence marking, and/or activation of PSI information marking. For example, the one or more sixth parameters may indicate that PDU set based handling is required/activated for the 31^{st} PDU session. For example, the one or more sixth parameters may indicate that PDU set based handling is not required/activated for the 32nd PDU session. This may be PDU set based handling support indication.
one or more identifiers of the one or more first PDU sessions for which delivery of PSI information is requested. One or more second PDU sessions for which delivery of PSI information is not requested or is deactivated.
one or more seventh parameters indicating whether each of the one or more fifth parameter and/or one or more sixth parameters is for MN (e.g., one or more first base stations) or SN (e.g., one or more second base stations).
one or more indicators indicating whether MN is congested and/or one or more indicators indicating whether SN is congested.

In an example, in response to receiving the one or more second N2 messages, the core network node may configure one or more user plane nodes to identify, mark and send/deliver one or more PSI information of one or more PDUs, for the one or more first PDU sessions, when the one or more user plane nodes send the one or more PDUs to the one or more base stations.

In an example, in response to sending request for delivery of the PSI information, and/or in response to discarding one or more PDU sets based on the PSI information, the second base station may send a first notification message to the UE. For example, the first notification message may indicate that the PSI based handling is applied in downlink direction by the second base station, that the PSI based handling is applied in uplink direction, that the PSI based handling is applied in one or more SCG cells, that the PSI based handling is applied by the one or more second base stations, that the PSI based handling is configured by the one or more second base stations, and/or the like. For example, the first notification message may be a RRC message, a MAC CE, a DCI, and/or the like.

In an example, in response to receiving request for delivery of the PSI information, in response to sending request for delivery of the PSI information, and/or in response to discarding one or more PDU sets based on the PSI information, the first base station may send a second notification message to the UE. For example, the second notification message may indicate that the PSI based handling is applied in downlink direction, that the PSI based handling is applied in uplink direction, that the PSI based handling is applied in one or more SCG cells, that the PSI based handling is applied by the one or more second base stations, the PSI based handling is applied in one or more MCG cells, that the PSI based handling is applied by the one or more first base stations, and/or the like.

Alternatively and/or additionally, when congestion is alleviated and/or when there is no more need to receive the PSI information, the one or more second base stations may send one or more update messages, to one or more first base stations. The one or more updated messages may indicate request to stop delivery of the PSI information for one or more first PDU sessions, deactivation of PSI based discarding for the one or more first PDU sessions, deactivation of PSI information marking, deactivation of PDU set information marking, not supporting for PSI based handing, and/or the like. In this case, the one or more first base stations may send an updated N2 messages to the core network node, indicating deactivation of PSI based handling, deactivation of PSI information marking and/or stop sending the PSI information, for the one or more first PDU sessions.

Alternatively and/or additionally, the one or more second Xn messages may comprise one or more parameters indicating one or more PDU sessions for which delivery of the PSI information is not required, and/or is not configured, and/or is not active, and/or is deactivated. Alternatively and/or additionally, the one or more second N2 messages may comprise one or more parameters indicating one or more PDU sessions for which delivery of the PSI information is not required.

For example, for a PDU session 7, if the PDU session 7 is configured with a SN terminated SCG bearer, the second base station may send the second Xn messages via the Xn-C interface. For example, for a PDU session 8, if the PDU session 8 is configured with a MN terminated SCG bearer, a MN terminated split bearer, a SN terminated split bearer, a SN terminated MCG bearer, the second base station may send the second Xn messages (and/or the GTP-U message) via the Xn-U interface.

Example embodiments of FIG. 23 may help a secondary base station to resolve congestion of radio resource.

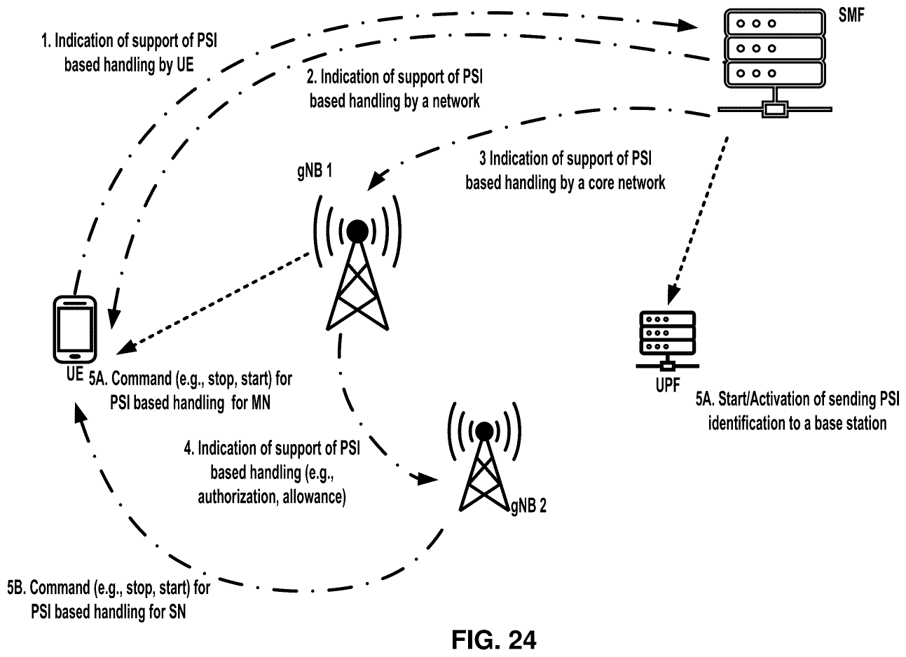

FIG. 24 illustrates an example as per an aspect of an embodiment of the present disclosure. In an example, a UE may be configured with multi connectivity (as shown in FIG. 23). One or more base stations may send a notification to a UE indicating whether PSI based handing is activated. This may help a UE to identify whether PSI based handling is active for MN and/or for SN. For brevity, based on the other part of the present disclosure, redundant details will be omitted.

In an example, the UE may be configured for the multi connectivity. For example, as shown in FIG. 23, the UE may communicate with the one or more first base stations and/or the one or more second base stations, the one or more first base stations and/or the one or more second base stations may exchange one or more messages (e.g., the one or more first Xn messages, the one or more second Xn messages, the one or more first N2 messages, the one or more second N2 messages, and/or the like).

Reverting back to FIG. 24, in an example, based on a first resource of the first base station is congested, based on that delivery of PSI information is activated, the first base station may determine to apply PSI based handing. Based on determining to apply the PSI based handling (e.g., discarding one or more PDUs of one or more less important PDU set), the first base station may send a first command message to the UE. For example, the first command message may be a first RRC configuration message, a first DCI and/or a first MAC CE. The first command message may indicate that PSI based handling is applied for one or more MCG bearers, for one or more MN-terminated bearers, for one or more PDU sessions, and/or for a downlink direction, and/or via the one or more first base stations.

In an example, based on a second resource of the second base station is congested, based on that delivery of PSI information is activated, based on that delivery of PSI information is configured by the second base station, the second base station may determine to apply PSI based handing. Based on determining to apply the PSI based handling, the second base station may send a second command message to the UE. For example, the second command message may be a second RRC configuration message, a second DCI, and/or a second MAC CE. The second command message may indicate that PSI based handling is applied for one or more SCG bearers, for one or more SN-terminated bearers, for one or more PDU sessions, and/or for a downlink direction, and/or via the one or more second base stations. That PSI based handling is applied may be that the PSI based handling is activated, and/or that the PSI based handling is configured, and/or the like.

In an example, the UE may receive the first command message and/or the second command message. Based on the first command message and/or based on receiving the first command message from the first base station, the UE may determine that PSI based handling is applied by the first base station. Based on the second command message and/or based on receiving the second command message from the second base station, the UE may determine that PSI based handling is applied by the second base station. In another example, based on receiving the second command message and/or not receiving the first command message, the UE may not apply PSI based handling for a PDU sent to the first base station and/or the UE may apply PSI based handling for a PDU sent to the second base station. For example, applying the PSI based handling may be using different timer values for one or more PDU sets of different importance. For example, a first timer value may be used for a PDU of an important PDU set and/or a second timer value may be used for a PDU of a less important PDU set.

The example of FIG. 24 may help different base stations to control independently congestions.

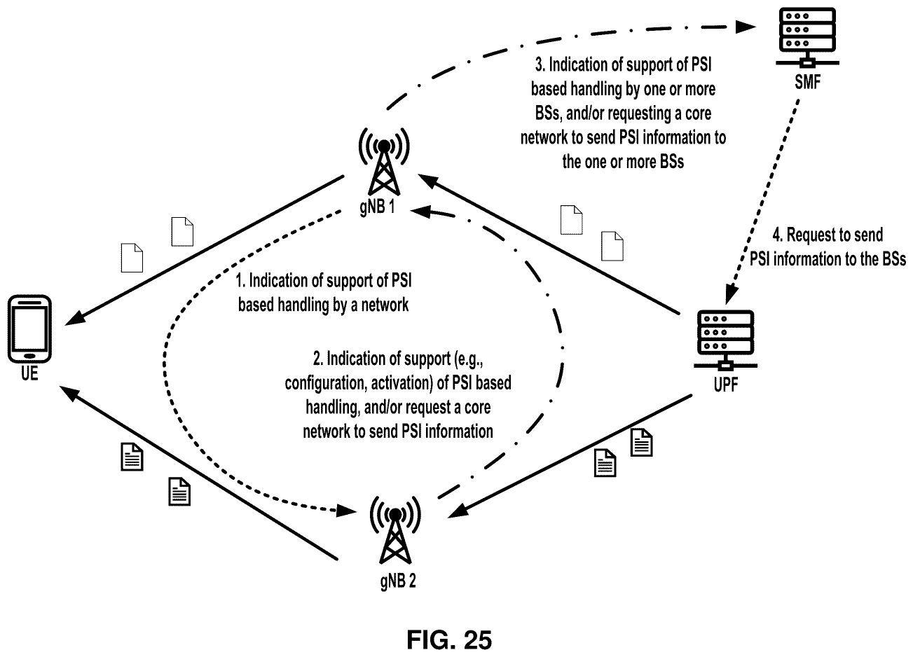

FIG. 25 illustrates an example as per an aspect of an embodiment of the present disclosure. In an example, a first base station may determine to send a first indication of support of the PSI based handling to a second base station, and the second base may send a second indication of requesting the PSI based handling. This may help a core network node to determine when to activate or deactivate delivery of the PSI information to one or more base stations. For brevity, based on the other part of the present disclosure, redundant details will be omitted.

In an example, the core network node may send the one or more first N2 messages to the one or more first base stations (e.g., as shown in the example of FIG. 23). The one or more first N2 messages may comprise the one or more second parameters. For example, the one or more first N2 messages may indicate at least one of:
PSI based handling is supported, by the core network node, for a first PDU session. This may be indication of support of marking of PSI information. For example, the PSI based handling may be the delivery of the PSI information by the core network node to the one or more base stations, sending by the user plane node to the one or more base station the PSI information, and/or the like. When sending the PSI information to the one or more base station is supported, configured and/or activated, when the user plane node sends one or more PDUs to the one or more base stations, the user plane node may send, to one or more base stations, one or more PSI information for the one or more PDUs, with the one or more PDUs.
PSI based handling is not supported, by the core network node, for a second PDU session.

In an example, the first base station of the one or more first base stations may send the one or more first Xn messages to the one or more second base stations. For example, the first Xn messages may comprise the one or more first configuration parameters, the one or more second configuration parameters, the one or more PDU session identifiers, the one or more bearer identifiers. For example, the first Xn messages may indicate:
that PSI based handling is supported, by the core network node, for the first PDU session. This may indicate that marking of the PSI information is supported.
PSI based handling is not supported, by the core network node, for the second PDU session.
Whether delivery of PSI information is activated, configured, requested and/or the like. For example, this may help for the one or more second base station to send a request for delivery (e.g., marking, sending, receiving, and/or the like) of the PSI information, if the delivery is not yet activated, configured, requested, and/or the like.

For example, the first Xn messages may comprise a first PDU session identifier of the first PDU session and/or a second PDU session identifier of the second PDU session.

In an example, the one or more second base stations (e.g., the second base station) may send the one or more second Xn messages. For example, because the second resource of the second base station is congested, because the PSI based handling is supported by the core network node, because the one or more first Xn messages indicate support for the delivery (e.g., marking) of the PSI information by the network to the one or more base stations, because the second base station receives request for delivery of the PSI information from a third base station (e.g., base station CU-UP, base station DU), because the second base station receives congestion indication from the third base station, because the second base station receives indication of the support for the PSI based handling from the third base station, because the second base station receives an activation indication for PSI information marking, and/or because the second base station receives indication of configuration for the PSI information from the third base station, the second base station may send the one or more second Xn messages. For example, the one or more second Xn messages may comprise the one or more third parameters and/or the one or more fourth parameters. For example, the one or more second Xn messages may indicate at least one of:
For the first PDU session, request of delivery of the PSI information, request of activation of the PSI based handling, request (e.g., activation) of marking of the PSI information, configuration of the PSI based handling (e.g., by the second base station), activation (e.g., start) of the PSI based handling and/or the like. For example, this may indicate that the base station (e.g., the second base station, the third base station) requests that the core network node (e.g., user plane node) sends the one or more PSI information to the second base station, that the core network node to mark the PSI information, and/or that the base station request receiving the one or more PSI information from the core network node.
For the second PDU session, indication that delivery of the PSI information is not requested, request of deactivation of the PSI based handling, deactivation of marking of the PSI information, release of configuration of the PSI based handling, deactivation (e.g., stop) of the PSI based handling and/or the like. This may indicate that the second base station requests that the core network does not send the one or more PSI information to the one or more base stations (e.g., the second base station), that the second base station does not need the one or more PSI information, that the resource of the second base station is no more congested, that the second base station does not request receiving the one or more PSI information.

In an example, the first base station may receive the one or more second Xn messages. Based on that the one or more second Xn messages, the first base station may send the one or more second N2 messages, to the one or more core network node. For example, the one or more second N2 messages may comprise the one or more sixth parameters, the one or more fifth parameters, and/or the like. For example, the one or more second N2 messages may indicates at least one of:
For the first PDU session, request of delivery of the PSI information, request of activation of the PSI based handling, request of marking of the PSI information, configuration of the PSI based handling, activation (e.g., start) of the PSI based handling, requesting the core network node to send the one or more PSI information to the base station, requesting the core network node to send the one or more PSI information to the second base station, requesting the core network to send the one or more PSI information to the second base station, requesting that the second base station receives the one or more PSI information from the core network node, and/or the like.
For the second PDU session, de-request of delivery of the PSI information, request of deactivation of the PSI based handling, release of configuration of the PSI based handling, deactivation (e.g., stop) of the PSI based handling, deactivation of marking of the PSI information, and/or the like.

In an example, the request (activation) for the delivery of the PSI information may be or may be not the request (activation) for the delivery of the PDU set information. For example, in one implementation, the request (activation) for the delivery of the PDU set information may be used to activate the delivery of the PSI information and the delivery of the PDU set sequence number, from the core network node to the one or more base stations (e.g., the second base station, the secondary base station). For example, in another implementation, the request (activation) for the delivery of the PDU set information may be used to de-activate (e.g., not to activate) the delivery of the PSI information from the core network node to the second base station (e.g., the secondary base station), and may be used to activate/request the delivery of the PDU set sequence number from the core network node to the second base station. In this case, the first base station may send a first request for the delivery of the PSI information and/or a second request for the delivery of the PDU set sequence information. Similar mechanism may apply for the one or more second Xn messages and/or between the one or more base stations.

In an example, based on receiving the one or more second N2 messages, the core network may configure the user plane node to send the PSI information to the one or more second base stations, for the first PDU session. In an example, based on receiving the one or more second Xn messages, the core network may configure the user plane node not to send the PSI information to the one or more second base stations, for the second PDU session.

Example embodiments of FIG. 25 may help a secondary base station to resolve congestion of radio resource. For example, this may help to handle congestion of a PDU session configured with a SN-terminated bearer.

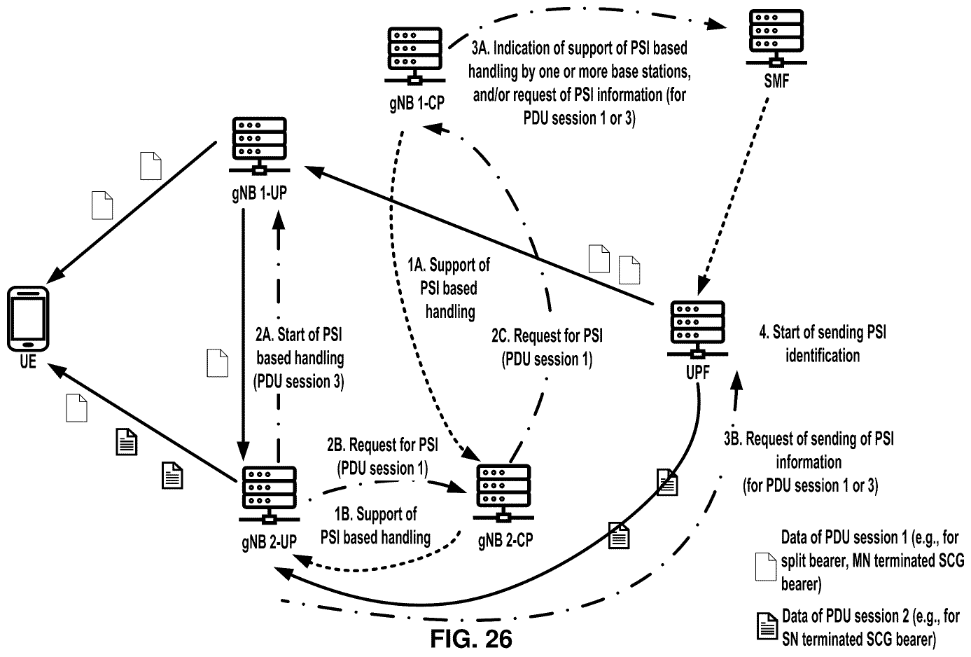

FIG. 26 illustrates an example as per an aspect of an embodiment of the present disclosure. In an example, depending on a type of a bearer, a second base station may determine which interface to use for sending an indication of requesting the PSI based handling. This may help efficient use of resources between one or more base stations. For brevity, based on the other part of the present disclosure, redundant details will be omitted.

In an example, the core network node may send the one or more first N2 messages to the one or more first base stations (e.g., as shown in the example of FIG. 23). The one or more first N2 messages may comprise the one or more second parameters. For example, the one or more first messages may indicate at least one of:
PSI based handling is supported, by the core network node, for one or more PDU sessions. For example, the one or more PDU sessions may comprise a first PDU session and/or a third PDU session. For example, that the PSI based handling is supported by the core network node may be that the core network node can send one or more PSI information for one or more PDUs of the one or more PDU sessions to the one or more base stations, that the PSI based handling is configured by the core network node for the one or more PDU sessions, that marking of the one or more PSI information is supported by the core network, and/or the like. For example, the one or more PDUs may belong to one or more PDU sets.
PSI based handling status. For example, this may indicate whether the core network node is configured to send the one or more PSI information or not, whether the marking of the PSI information is activated, whether the marking of the PDU set information is activated, and/or the like.

In an example, the first base station may receive the one or more first N2 messages. Based on the one or more first N2 messages, based on the one or more QoS parameters for the one or more PDU sessions of the one or more first N2 messages, the first base station may determine one or more types (e.g., radio bearer type) and/or may determine to use multi connectivity, for the one or more PDU sessions and/or for one or more bearers of the one or more PDU sessions. The multi connectivity may be dual connectivity. For example, the one or more types may be one or more configurations. For example, the one or more types may be one or more types of one or more bearers for the one or more PDU sessions and/or one or more types of the one or more PDU sessions. For example, the one or more types may indicate at least one of whether a bearer of the one or more bearers is MN terminated and/or SN terminated. For example, the one or more types may indicate at least one of whether a bearer of the one or more bearers is a SCG bearer, a MCG bearer, a split bearer and/or the like.

In an example, based on determining the one or more types, the first base station may determine whether to send the one or more first Xn messages. For example, based on determining to use one or more SN-terminated bearers, based on determining to use one or more split bearers, based on determining to use one or more SCG cells, and/or the like, the first base station may determine to send the one or more first Xn messages.

For example, the first Xn messages may comprise the one or more first configuration parameters, the one or more second configuration parameters, the one or more PDU session identifiers, the one or more bearer identifiers. For example, the first Xn messages may indicate:
PSI based handling (and/or PSI information marking, PDU set information marking) is supported, by the core network node, for the one or more PDU sessions.
Whether delivery (e.g., marking) of PSI information is activated, configured, requested and/or the like. For example, this may help for the one or more second base station to determine whether to send a request for delivery (e.g., sending, receiving, marking) of the PSI information, if the delivery is not yet activated, configured, requested, and/or the like.
the one or more types of the one or more bearers, and/or the one or more types of the one or more PDU sessions.

For example, the first Xn message may comprise a first identifier associated with the first PDU session and/or a second identifier associated with the third PDU session. For example, the first identifier may be an identifier of a first bearer of the first PDU session and/or an identifier of the first PDU session. For example, the second identifier may be an identifier of a second bearer of the third PDU session and/or an third identifier of the third PDU session.

In an example, the first Xn message may indicate that a first type of the one or more types is associated with the first PDU session and/or the first bearer. The first Xn message may indicate that a second type of the one or more types is associated with the second PDU session and/or the second bearer. The first type may indicate at least one of a SN terminated, a SN terminated bearer, a SN terminated SCG bearer and/or the like. The second type may indicate at least one of a MN terminated, a MN terminated bearer, a MN terminated SCG bearer, a MN terminated split bearer, a SN terminated MCG bearer, a SN terminated split bearer, and/or the like.

In an example, based on that the second type is associated with the third PDU session, the first Xn message may indicate one or more configurations. For example, the one or more configuration may be for Xn-U interface. For example, the one or more configuration for Xn-U may be associated with at least one of a Xn-U interface, a first base station user plane node, a second base station user plane node, and/or the like. For example, the one or more configurations for Xn-U may indicate one or more resources of the first base station and/or information of GTP (e.g., IP address and/or TEID). For example, the information of the GTP may indicate to where the second base station sends one or more GTP packets to the first base station and/or from where the second base station receives one or more GTP packets from the first base station.

In an example, in response to receiving the first Xn messages, and/or in response to receiving information that the second type is associated with the third PDU session, the second base station (e.g., a second base station control plane) may configure a fourth base station (e.g., a second base station user plane), with the one or more configuration for Xn-U.

In an example, based on that the first type is associated with the first PDU session, the first Xn message may not indicate one or more configurations for Xn-U interface, for the first PDU session.

In an example, the second resource of the second base station may be congested. When the second resource is congested, the second base station may determine to apply PSI based handling (and/or PSI based discarding) to one or more PDU sessions. To apply the PSI based handling may be to send a request for activation of marking of PSI information and/or activation of marking of the PDU set information. For example, the one or more PDU sessions may be the first PDU session. For example, based on that the PSI based handling (e.g., PDU set information marking and/or PSI information marking) is supported for the first PDU session, based on that the first PDU session is associated with the first type, and/or the like, the second base station may select the first PDU session, to which the PSI based handling applies. For example, based on receiving the first Xn message, and/or based on receiving that the PSI based handling (e.g., marking of PSI information) is supported/configured/activated, and/or that the core network node can send the one or more PSI information for the first PDU session, the second base station may determine to apply/activate/configure/start PSI based handling (e.g., the PSI based discarding) to the first PDU session. For example, PSI based handling may be that a PDU of one or more important PDU set is not discarded, and/or that a PDU of one or more lower importance PDU set is discarded. For example, based on receiving an information that PSI based handling is configured for the first PDU session, based on the one or more types of the bearer, based on that the one or more bearers are SN terminated SCG bearers, and/or based on not receiving the one or more configurations for Xn-U for the first PDU session, the second base station may determine to apply/activate/configure/start the PSI based handling for the first PDU session. To apply/activate/configure/start the PSI based handling may be to apply/activate/configure PSI information marking and/or may be to apply/activate/configure PDU set information marking.

In an example, a fourth resource of the fourth base station may be congested. When the fourth resource is congested, the fourth base station may determine to apply PSI based handling to one or more PDU sessions. For example, the one or more PDU sessions may be the third PDU session. For example, based on that the PSI based handling is supported for the third PDU session, the fourth base station may select the third PDU session, to which the PSI based handling applies. For example, based on receiving the first Xn message, and/or based on receiving that the PSI based handling is supported/configured/activated, and/or that the core network node can send the one or more PSI information for the third PDU session, the fourth base station may determine to apply/active/configure/start PSI based handling (e.g., the PSI based discarding) to the third PDU session. For example, PSI based handling may be that a PDU of one or more important PDU set is not discarded, and/or that a PDU of one or more lower importance PDU set is discarded. For example, based on receiving an information that PSI based handling is configured for the third PDU session, based on that one or more bearers of the third PDU session are of the second type, and/or based on the one or more configurations for Xn-U are available for the third PDU session, the fourth base station may determine to apply/activate/configure/start the PSI based handling for the third PDU session.

In an example, based on determining to apply PSI based handling for the third PDU session, the fourth base station may send one or more GTP messages to the one or more first base stations. For example, the one or more GTP messages may be one or more GTP headers, one or more GTP containers comprising the one or more GTP headers and/or the like. For example, based on that the second type is associated with the third PDU session, based on that a MN terminated bearer is used for the third PDU session, based on that a GTP-U is available between the first base station and the third base station, based on that SN terminated MCG bearer is configured, based on that a split bearer is used for the third PDU session, based on that the PSI based handling is supported by the core network, based on that the PSI based handling is configured by the first base station, and/or the like, the fourth base station may send the one or more GTP messages. The one or more GTP messages may indicate at least one of that delivery of the PSI information is requested, that the fourth base station requests receiving one or more PSI information for the one or more PDUs of the one or more PDU sets of the third PDU session, that the fourth base station recommends activation of the marking of the PSI information, that the fourth base station recommends activation of marking of the PDU set information, that the fourth base station requests the core network node to send the one or more PSI information to the fourth base station, that the fourth base station requests the first base station to send the one or more PSI information to the fourth base station, that PSI based handling is configured, and/or that PSI based handling starts and/or the like. Alternatively and/or additionally, if GTP-U is not available, the fourth base station may send information (e.g., included in the one or more GTP messages) to the second base station (e.g., using similar mechanisms used by the third base station). For example, the fourth base station may send one or more second E1 messages.

In an example, based on determining to apply PSI based handling for the first PDU session, the one or more second base stations (e.g., the second base station) may send the one or more second Xn messages. For example, the one or more second Xn messages may be one or more Xn-C messages, and/or may not be one or more GTP messages. For example, because the second resource of the second base station is congested, because SN terminated bearer is associated with the first PDU session, because SN terminated SCG bearer is configured, because the PSI based handling is supported by the core network node, because Xn-U interface is not configured for the first PDU session, because the one or more first Xn messages indicate support for the delivery of the PSI information by the network to the one or more base stations, because the second base station receives request for delivery of the PSI information from a third base, because the second base station receives congestion indication from the third base station, because the second base station receives indication of the support for the PSI based handling from the third base station, and/or because the second base station receives indication of configuration for the PSI information from the third base station, the second base station may send the one or more second Xn messages. In an example, the third base station may be at least one of base station CU-UP, base station DU, or the fourth base station. For example, the one or more second Xn messages may indicate at least one of:
For the first PDU session, request of delivery of the PSI information, request of activation of the PSI based handling, request for activation of marking of PSI information, request for activation of marking of PDU set information, configuration of the PSI based handling, activation (e.g., start) of the PSI based handling and/or the like. For example, this may indicate that the second base station requests that the core network node (e.g., user plane node) to send the one or more PSI information to the second base station, that the second base station request receiving the one or more PSI information from the core network node. that the second base station request receiving the one or more PSI information from the core network node, that the PSI based handling is activated by the second base station, that the PSI based handling is configured by the second base station, that the PSI based discarding started by the second base station, that the second base station is congested, and/or the like, and for the first PDU session and/or for the first type bearers, and/or for the first type.

In an example, the first base station may receive the one or more second Xn messages and/or the one or more GTP messages. Based on that the one or more second Xn messages and/or the one or more GTP messages, the first base station may send the one or more second N2 messages, to the one or more core network node. For example, the one or more second N2 messages may indicates at least one of:
For the first PDU session and/or for the third PDU session, request of delivery of the PSI information, request of activation of the PSI based handling, request of activation of marking of PSI information, request of activation of marking of PDU set information, configuration of the PSI based handling, activation (e.g., start) of the PSI based handling, requesting the core network node to send the one or more PSI information to the base station, requesting the core network node to send the one or more PSI information to the second base station, requesting the core network to send the one or more PSI information to the second base station, requesting that the second base station receives the one or more PSI information from the core network node, and/or the like.

In an example, the request of activation for the delivery of the PSI information may be or may be not the request of activation for the delivery of the PSI information. For example, in one implementation, the request of activation for the delivery of the PSI information may be used to activate the delivery of the PSI information and the delivery of the PDU set sequence number, from the core network node to the one or more base stations (e.g., the second base station, the secondary base station). For example, in another implementation, the request of activation for the delivery of the PSI information may be used to activate the delivery of the PSI information from the core network node to the second base station (e.g., the secondary base station), and may not be used to activate/request the delivery of the PDU set sequence number from the core network node to the second base station. In this case, the first base station may send a first request for the delivery of the PSI information and a second request for the delivery of the PDU set sequence information. Similar mechanism may apply for the one or more second Xn messages and/or between the one or more base stations.

In an example, based on receiving the one or more second N2 messages, the core network may configure the user plane node to send (e.g., activate marking of) the PSI information to the one or more second base stations, for the first PDU session. In an example, based on receiving the one or more second Xn messages, the core network may configure the user plane node not to send the PSI information to the one or more second base stations, for the second PDU session.

Additionally and/or alternatively, in an example, when the second base station receives the one or more first Xn messages, the second base station may send one or more first E1 messages to the fourth base station. For example, the fourth base station may be the third base station.

The one or more first E1 messages may comprise the one or more configuration for Xn-U. For example, the one or more first E1 messages may be at least one of Bearer context setup request message, bearer context modification request message, and/or the like. For example, the one or more first E1 messages may comprise the one or more first configuration parameters, the one or more second configuration parameters, the one or more PDU session identifiers, the one or more bearer identifiers. For example, the one or more first E1 messages may indicate:
PSI based handling is supported, by the core network node, for the one or more PDU sessions. This may be an indication of support for marking of PSI information. For example, this may indicate whether the PSI based handling is configured, whether the fourth base station can request receiving of the one or more PSI information and/or the like.

Additionally and/or alternatively, the third base station may be the fourth base station.

Additionally and/or alternatively, in an example, based on receiving one or more second E1 messages from the fourth base station, the second base station may send the one or more second Xn messages to the first base station. For example, the one or more second E1 messages may be at least one of Bearer context setup response message, bearer context modification response message, bearer context modification required messages, notification message, status message, congestion indication message, resource status message, and/or the like. For example, the one or more second E1 messages may comprise the one or more third parameters, the one or more fourth parameters, the one or more PDU session identifiers, the one or more bearer identifiers. For example, the one or more second E1 messages may indicate at least one of:
For the first PDU session, request of delivery of the PSI information, request of activation of the PSI based handling, configuration of the PSI based handling, activation of the marking of PSI information, activation of the marking of PDU set information, activation (e.g., start) of the PSI based handling and/or the like. For example, this may indicate that the fourth base station requests that the core network node (e.g., user plane node) to send the one or more PSI information to the second base station and/or to the fourth base station, that the second base station and/or the fourth base station requests receiving the one or more PSI information from the core network node. that the second base station and/or the fourth base station requests receiving the one or more PSI information from the core network node, that the PSI based handling is activated by the fourth base station, that the PSI based handling is configured at the fourth base station, that the PSI based discarding started by the fourth base station, that the fourth base station is congested, and/or the like, and for the first PDU session and/or for the first type bearers, and/or for the first type.

Additionally and/or alternatively, when the fourth base station determines to request for the core network node to send the one or more PSI information, the fourth base station may send one or more GTP containers to the core network node (e.g., the user plane node). For example, the one or more GTP container may comprise at least one of a QoS flow identifier, a PDU session identifier, an indication of congestion, indication of start of the PSI based handling, indication of activation of the PSI based handling, indication of configuration of the PSI based handling, indication of activation of PSI information marking, indication of activation of PDU set information marking, indication of start of the PSI based discarding, and/or the like.

Example embodiments of FIG. 26 may help a secondary base station to resolve congestion of radio resource. For example, when user plane between the one or more base stations (e.g., the MN and the SN) is not available, for a bearer and/or for a PDU session, and when the SN experiences congestion, control plane signalling between the one or more base station can be used to indicate a request for delivery of the PSI information from the core network node to the one or more base stations.

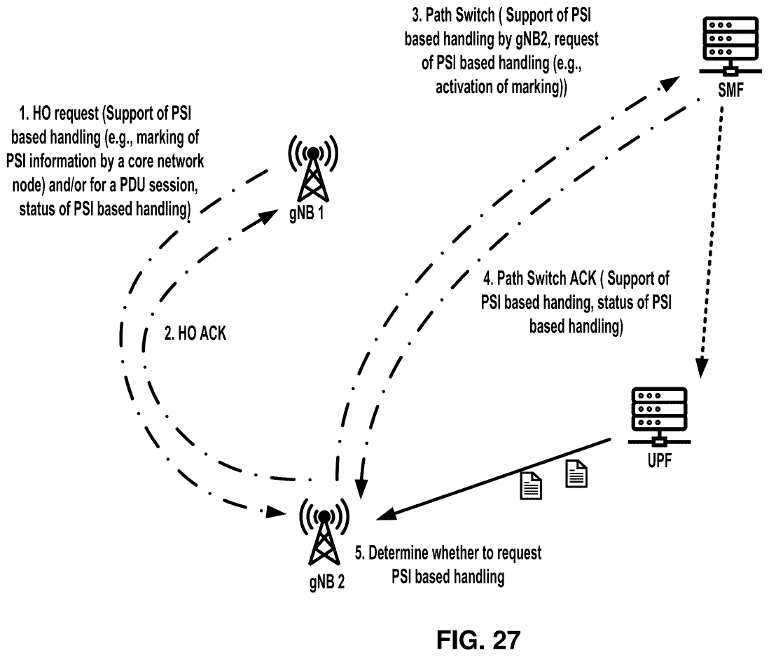

FIG. 27 illustrates an example as per an aspect of an embodiment of the present disclosure. In an example, for a handover procedure, a target base station may determine whether to request delivery of one or more PSI information. For brevity, based on the other part of the present disclosure, redundant details will be omitted.

In an example, the first base station (e.g., as shown in the previous figures, source base station) may determine whether to handover the UE to a target base station. For example, based on signal strength between the first base station and/or the UE, the first base station may determine to handover the UE to the target base station. For example, the target base station may be the second base station.

In an example, in response to determining the handover, the first base station may send one or more third Xn messages to the target base station. For example, the one or more third Xn messages may be the one or more first Xn messages. For example, the one or more third Xn messages may comprise at least one of:
an identifier of the UE.
an identifier of a target cell of the target base station.
the one or more first configuration parameters.
the one or more second configuration parameters.
the one or more PDU session identifiers.
the one or more bearer identifiers.

In an example, the first base station may send to the one or more second base stations, the one or more third Xn messages. The one or more third Xn messages may comprise a third Xn message. The third Xn message may be at least one of S-Node addition Request message, S-Node modification request message, S-node modification confirm message, Handover request message, handover request acknowledge message, handover required message, Retrieve UE context request message, Retrieve UE context response message and/or the like.

For example, the third Xn message may comprise one or more first fields and/or one or more second fields, and/or the like. For example, the one or more first fields may comprise an indicator indicating that the PSI based handling (e.g., PSI information marking) is supported, an indicator indicating that the PDU set based handling (e.g., PDU set information marking) is supported, an identifier of a first PDU session. For example, that the PSI based handling is supported may be that the core network supports sending the one or more PSI information to the first base station and/or to the target base station, that the PSI based handling is supported by the core network, that the PSI based handling is supported for the first PDU session. For example, the one or more second fields may comprise an indicator indicating a status of the PSI based handling. The status of the PSI based handling may indicate whether the one or more PSI information is delivered from the core network node to the first base station and/or to the target base station, for the first PDU session, and/or whether PSI based handling (e.g., marking of the PSI information, marking of the PDU set information) is activated or not. Additionally and alternatively, the third Xn message may indicate whether the first base station configures the PSI based handling for the UE. For example, that the first base station configures the PSI based handling may be that PSI based discarding is configured, that PSI based discarding is configured for the secondary node, that PDU set information marking is activated for the secondary node, that PDU set information marking is activated for one or more bearers of the first type for the secondary node, that the secondary node configures PSI based handling, that the second node configures PDU set based handling, that the PSI based discarding is allowed, that one or more base stations (e.g., the second base stations, the third base stations, the fourth base stations) are configured for the PSI based handling, that receiving of the one or more PSI information is requested, and/or the like. For example, the secondary node may be a fifth base station. If the target base station determines to use the secondary node, the information described above may help in reducing signalling between the target base station and/or the secondary node.

In an example, in response to receiving the one or more third Xn messages, the target base station may send one or more fourth Xn messages, For example, a fourth Xn messages of the one or more Xn messages may comprise at least one of:
the one or more third parameters. Each third parameter of the one or more third parameters may be associated with each PDU session. The each third parameter may indicate whether the PSI based handling for the each PDU session is requested, whether the target base station configures the PSI based handling for the each PDU session, whether the target base station supports the PSI based handling for the each PDU session, whether delivery of the PSI information is requested for the each PDU session, and/or whether delivery of the PSI information needs to be started or stopped for the each PDU session. For example, because the resource of the target base station is congested, because the target base station needs the PSI information, and/or the like, at least one of the one or more third parameters may indicate that delivery of the PSI information is requested for the each PDU session, that PSI based handling is configured, that the PSI based handling is active, that the PSI handling starts, and/or the like. In another example, because the resource of the target base station is not congested, because the target base station does not need the PSI information, because the target base station does not support the PSI based handling, and/or the like, at least one of the one or more third parameters may indicate that delivery of the PSI information is not requested for the each PDU session, that PSI based handling is not configured, that the PSI based handling is not active, that the PSI handling needs to be stopped, and/or the like. For example, the one or more third parameters may indicate that PSI information delivery is required for a 21st PDU session and/or that PSI information delivery is not required for a 22nd PDU session. For example, the one or more third parameters may indicate a request for the core network (e.g., the core network node) to send the PSI information to the one or more base stations (e.g., the target base stations), and/or a request for the one or more base stations to receive the PSI information from the core network.
one or more fourth parameters. Each fourth parameter of the one or more fourth parameters may be associated with the each PDU session. Each fourth parameter may indicate whether the PDU set based handling for the each PDU session is requested, whether the target base station configures the PDU set based handling for the each PDU session, whether the target base station supports the PDU set based handling for the each PDU session, whether the target base station requests delivery of the PDU set sequence number delivery, and/or the like. For example, because the target base station is congested, because the target base station needs the PSI information, at least one of the one or more fourth parameters may indicate that delivery of the PDU set information is requested, that PDU set based handling is configured, that the PDU set based handling is active, that the PDU set based handling starts, and/or the like.
one or more indicators indicating whether the target base station is congested or not, for the each PDU session.
the one or more PDU session identifiers, for which PSI information is requested.
the one or more bearer identifiers, for which PSI information is requested.

For example, the fourth Xn message may be at least one of S-Node addition Response message, S-Node modification response message, S-node modification required message, Handover request message, handover request acknowledge message, Retrieve UE context request message, Retrieve UE context response message and/or the like.

In an example, the target base station may receive one or more signals and/or one or more messages from the UE. For example, the UE may send the one or more signals and/or the one or more messages, after receiving handover command from the one or more first base station.

In an example, in response to receiving the one or more signals and/or the one or more messages from the UE, the target base station may send one or more third N2 messages to the core network node. For example, the core network may be the mobility management node and/or the session management node. For example, a third N2 messages of the one of more third N2 messages may be at least one of a Path switch request message, a PDU session resource messages, a UE context message, a NAS transport messages, and/or the like.

For example, the third N2 messages may comprise at least one of:
the one or more fifth parameters. The one or more fifth parameters may indicate capability/request/configuration of one or more base stations. The one or more fifth parameters may be indication of activation request for marking of PSI information. For example, the one or more base stations may be the target base station. Each fifth parameter of the one or more fifth parameter may indicate whether delivery of the PSI information for one or more first PDU sessions from the core network node to the target base station is requested by the target base station, whether PSI based discarding for the one or more first PDU sessions is activated/deactivated by the target base station, whether PSI based handling is support for the one or more first PDU sessions by the target base station, and/or the like. For example, the one or more fifth parameters may be one or more PSI based handling indicators. For example, the one or more fifth parameters may indicate that PSI based handling is required/activated for a 31^{st} PDU session. For example, the one or more fifth parameters may indicate that PSI based handling is not required/activated for a 32nd PDU session.
one or more sixth parameters. Each sixth parameter of the one or more sixth parameters may indicate request for delivery of the PDU set information for the one or more first PDU sessions, support for PDU set based handing for the one or more first PDU sessions, activation of PDU set based handling for the one or more first PDU sessions, and/or the like. For example, the one or more sixth parameters may be one or more PDU set based handling indicators. In another example, the one or more sixth parameters may be the one or more fifth parameters. For example, the one or more sixth parameters may indicate that PDU set based handling is required/activated for the 31^{st} PDU session. For example, the one or more sixth parameters may indicate that PDU set based handling is not required/activated for the 32nd PDU session. For example, the PDU set based handling may be sending by the core network node to the target base station, one or more PDU set sequence number of one or more PDUs for the one or more PDU sessions. This may help for a base station to identify which PDUs belong to which PDU set. The PSI may help for a base station to identify which one or more PDUs of a PDU set is important or not.
one or more seventh parameters indicating whether each of the one or more fifth parameter and/or one or more sixth parameters is for MN (e.g., the target base station) or SN (e.g., one or more second base stations).
one or more indicators indicating whether MN (e.g., the target base station) is congested and/or one or more indicators indicating whether SN is congested.

Additionally and alternatively, the third N2 message may indicate whether the target base station configures the PSI based handling for the UE, whether the target base station requests activation of marking of PSI information, for a PDU session. For example, that the target base station configures the PSI based handling may be that PSI based discarding is configured, that the PSI based discarding is allowed, that one or more base stations (e.g., the second base stations, the third base stations, the fourth base stations) are configured for the PSI based handling, that receiving of the one or more PSI information is requested, that marking of the one or more PSI information is requested, that marking of the one or more PDU set information is requested, and/or the like, for the PDU session.

In an example, the core network node may receive the one or more third N2 messages. In response to receiving the one or more third N2 messages, the core network node may send one or more fourth N2 messages. For example, a fourth N2 messages of the one or more fourth N2 messages may be a Path switch acknowledge message and/or the like.

For example, the fourth N2 message may comprise:
The one or more first configuration parameters. Each first configuration parameter of the one or more first configuration parameters may indicate configuration for each PDU session of one or more PDU sessions. The each first configuration parameter may indicate whether a network, a core network and/or the core network node supports the PSI based handling for the each PDU session. Supporting the PSI based handling may be that delivery of the PSI information for the each PDU session from a user plane node (of the core network) to the one or more base stations are supported. For example, for a 10^{th} PDU session of the one or more PDU sessions, the one or more first configuration parameter may indicate that the PSI based handling is supported. For example, for a 11th PDU session of the one or more PDU sessions, the one or more first configuration parameter may indicate that the PSI based handling is not supported.
one or more second configuration parameters. Each second configuration parameter of the one or more second configuration parameters may be associated with the each PDU session and/or may be used for the each PDU session. Each second configuration parameter may indicate whether the network, the core network and/or the core network node supports delivery of a PDU set sequence information, and/or the like, for the each PDU session. For example, when the core network node supports delivery of the PDU set sequence information, when the core network sends a PDU to a base station, the core network also sends the PDU set sequence The codepoint “start” means that UL PSI based discarding is (re)configured, identifiers of the one or more PDU sessions.
one or more bearer identifiers of one or more bearers of the one or more PDU sessions.

For example, the fourth N2 message may comprise one or more first fields and/or one or more second fields, and/or the like. For example, the one or more first fields may comprise an indicator indicating that the PSI based handling (e.g., marking of the PSI information, marking of PDU set information) is supported, an identifier of a first PDU session. For example, that the PSI based handling is supported may be that the core network supports sending the one or more PSI information to the target base station, that the PSI based handling is supported by the core network, that the PSI based handling is supported for the first PDU session. For example, the one or more second fields may comprise an indicator indicating a status of the PSI based handling. The status of the PSI based handing may indicate whether the one or more PSI information is delivered from the core network node to the target base station, for the first PDU session.

In an example, based on the one or more fourth N2 messages and/or based on the one or more third Xn messages, the target base station may determine whether to request delivery of the one or more PSI information from the core network to the target base station, whether to configure the PSI based handling, and/or the like. For example, when the target base station experiences congestion of at least one of a MN and/or a SN, the target base station may send a fifth N2 messages to the core network node. For example, the fifth N2 message may be similar to the third N2 message and/or the second N2 message. For example, the fifth N2 message may comprise one or more parameters and/or one or more fields described for the third N2 message and/or the second N2 message.

Example embodiments of FIG. 27 may help a target base station to resolve congestion of radio resource.

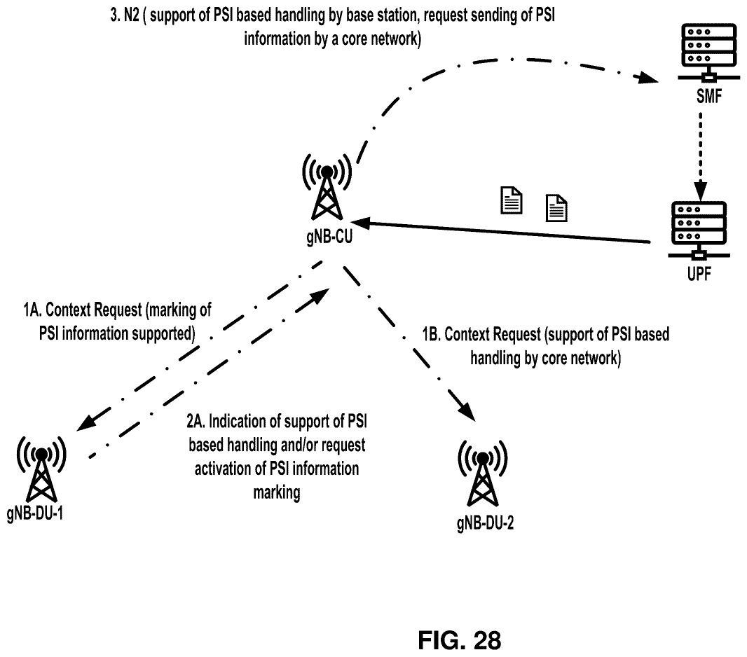

FIG. 28 illustrates an example as per an aspect of an embodiment of the present disclosure. In an example, a base station central unit may exchange signalling with a base station distributed unit, information associated with a PSI based handling. For brevity, based on the other part of the present disclosure, redundant details will be omitted.

In an example, the second base station (e.g., as shown in the previous figures) may be the base station central unit (BS-CU). For configuration of a multi-connectivity, the second base station may determine the one or more third base stations (e.g., as shown in the previous figures). For example, the one or more third base stations may be the base station distributed unit (BS-DU).

In an example, based on receiving the one or more first Xn messages, the second base station may determine to send one or more F1 messages to the one or more third base stations. For example, the one or more third base stations may handle one or more protocols. For example, the one or more protocols may be at least one of a PHY protocol, a MAC protocol, a RLC protocol, and/or the like. For example, the one or more third base stations may receive one or more downlink packets (PDUs) from the one or more first base stations.

For example, the one or more F1 messages may be at least one of F1 setup request message, F1 setup response message, resource status response message, resource status request message, resource status update message, UE context setup request message, UE context setup response message, UE context modification request message, UE context modification required message, UE context response message, UE context modification confirmation message, notify message, and/or the like.

For example, the one or more F1 messages may comprise at least one of:
The one or more first configuration parameters. Each first configuration parameter of the one or more first configuration parameters may indicate configuration for each PDU session of one or more PDU sessions. For example, the each configuration parameter may be for a downlink. The each first configuration parameter may indicate whether a network, a core network and/or the core network node supports the PSI based handling (e.g., marking of PSI information) for the each PDU session. Supporting the PSI based handling may be that delivery of the PSI information for the each PDU session from a user plane node (of the core network) to the one or more base stations (e.g., the third base station) are supported. Supporting the PSI based handling may be that delivery of the PSI information for the each PDU session to the one or more third base stations are supported. Supporting the PSI based handling may be that the PSI based handling is configured for the each PDU session. For example, for a 10^{th} PDU session of the one or more PDU sessions, the one or more first configuration parameter may indicate that the PSI based handling is supported. For example, for a 11^{th} PDU session of the one or more PDU sessions, the one or more first configuration parameter may indicate that the PSI based handling is not supported.
one or more second configuration parameters. Each second configuration parameter of the one or more second configuration parameters may be associated with the each PDU session and/or may be used for the each PDU session. Each second configuration parameter may indicate whether the network, the core network and/or the core network node supports delivery of a PDU set sequence information, and/or the like, for the each PDU session. For example, when the core network node supports delivery of the PDU set sequence information, the core network marks one or more PDU set information for a PDU, sends the PDU to a base station, and/or the core network (and/or the second base station, the fourth base station) may send the one or more PDU set information (e.g., PDU set sequence information) to the base station (e.g., the third base station). In some example, the first configuration parameter may be the second configuration parameter. In another example, the first configuration parameter may be different from the second configuration parameter.
one or more PDU session identifiers of the one or more PDU sessions.
one or more bearer identifiers of one or more bearers of the one or more PDU sessions.
one or more indicators indicating whether PSI based SDU (and/or PDU) discard is started (e.g., activated) and/or stopped (deactivated) for uplink. This may indicate whether uplink PSI based SDU (and/or PDU) discard is configured or released for one or more bearers (e.g., DRBs). A codepoint “stop” may mean that UL PSI based discarding is released. Up to 8 DRBs can be set as “start”. The codepoint “start” means that UL PSI based discarding is (re)configured.
one or more indicators indicating whether PSI based SDU discard is configured or not configured for downlink direction. This may be the one or more first configuration parameters.
one or more QoS parameters indicating at least one of a UL PDU set QoS information and/or a DL PDU set QoS information. For example, the one or more QoS parameters may indicate a PSER (PDU set error rate) and/or a PSDB (PDU set delay budget) for the one or more PDU sets. For example, this may indicate whether PDU set integrated handling is required or not. For example, the PDU set integrated handling may indicate whether all PDUs of a PDU set need to be delivered or not.

In an example, the third base station of the one or more third base station may receive the one or more first F1 messages. When a third resource of the third base station is congested, the third base station may determine whether to send one or more report messages to the second base station (e.g., base station central unit, base station central unit user plane, base station central unit control plane). Because the third base station receives the one or more first configurations parameters, the one or more second configuration parameters, the one or more indicators indicating whether PSI based SDU discard is started, the one or more indicators indicating whether PSI based discard is configured for downlink, and/or because the third resource is congested, the third base station may determine to send the one or more report messages. For example, the one or more report messages may be at least one of one or more second F1 messages and/or one or more GTP containers. For example, the one or more second F1 messages may be at least one of F1 setup request message, F1 setup response message, resource status response message, resource status request message, resource status update message, UE context setup request message, UE context setup response message, UE context modification request message, UE context modification required message, UE context response message, UE context modification confirmation message, notify message, and/or the like. For example, the one or more GTP containers may comprise at least one of a QoS flow identifier, a PDU session identifier, an indication of congestion, indication of start of the PSI based handling, indication of activation of the PSI based handling, indication of configuration of the PSI based handling, DL PSI based discard activation suggestion, indication of start of the PSI based discarding, indication of recommendation to activate PSI information marking, and/or the like. For example, the one or more report messages may indicate whether PSI based discarding needs to be activated and/or deactivated.

For example, the one or more report messages may comprise at least one of:
one or more third parameters. Each third parameter of the one or more third parameters may be associated with each PDU session and/or the bearer (e.g., the SN terminated SCG bearer) of the each PDU session. The each third parameter may indicate whether the PSI based handling for the each PDU session and/or the bearer is requested, whether the third base station configures the PSI based handling for the each PDU session and/or the bearer, whether the third base station supports the PSI based handling for the each PDU session and/or the bearer, whether activation of PSI information marking is recommended, whether activation of PDU set information marking is recommended, and/or whether delivery of the PSI information is requested for the each PDU session and/or the bearer. For example, because the resource of the third base station is congested, because the third base station needs the PSI information, and/or the like, at least one of the one or more third parameters may indicate that delivery of the PSI information is requested for the each PDU session and/or the bearer, that PSI based handling is configured and/or the bearer, that the PSI based handling for the bearer is active, that the third base station supports the PSI based handling, that the PSI handling starts, that marking of the PSI information is recommended, that activation of the PSI based handling is recommended, and/or the like. For example, the one or more third parameters may indicate that PSI information delivery is required for a 21st PDU session and/or that PSI information delivery is not required for a 22th PDU session. For example, the one or more third parameters may indicate a request for the core network (e.g., the core network node) and/or the first base station to send the PSI information to the one or more base stations (e.g., the one or more third base stations), and/or a request for the one or more base stations to receive the PSI information from the core network.
one or more fourth parameters. Each fourth parameter of the one or more fourth parameters may be associated with the each PDU session. Each fourth parameter may indicate whether the PDU set based handling for the each PDU session is requested, whether the third base station configures the PDU set based handling for the each PDU session, whether the third base station supports the PDU set based handling for the each PDU session, whether the third base station requests delivery of the PDU set sequence number delivery, and/or the like. For example, because the third base station is congested, because the third base station needs the PSI information, at least one of the one or more fourth parameters may indicate that delivery of the PDU set information is requested, that PDU set based handling is configured, that the PDU set based handling is active, that the PDU set based handling starts, and/or the like.
one or more indicators indicating whether the third base station is congested or not, for the each PDU session.
the one or more PDU session identifiers, for which PSI information is requested.
the one or more bearer identifiers, for which PSI information is requested.

In an example, the second base station may receive the one or more report messages. In response to receiving the one or more report messages, the second base station may send to the core network, the one or more second Xn messages (as shown in previous figures) and/or the one or more second N2 messages.

Additionally and/or alternatively, the second base station may be the SN and/or the first base station may be the MN. In this case, toward the core network node, a signalling between the second base station and the core network node may not be supported. When the MN decides to use the second base station as the SN, the first base station and/or the second base station may exchange signalling as shown in previous figures. In this case, the second base station may exchange the one or more report messages and/or the one or more first F1 messages with the third base station. In this case, based on receiving the one or more report messages, the second base station may send the one or more second Xn messages to the first base station. The first base station may send the one or more second N2 messages, based on receiving the one or more second Xn messages.

Example embodiments of FIG. 28 may help for one or more base stations to determine whether one or more radio resource is congested, and send a request for the PSI.

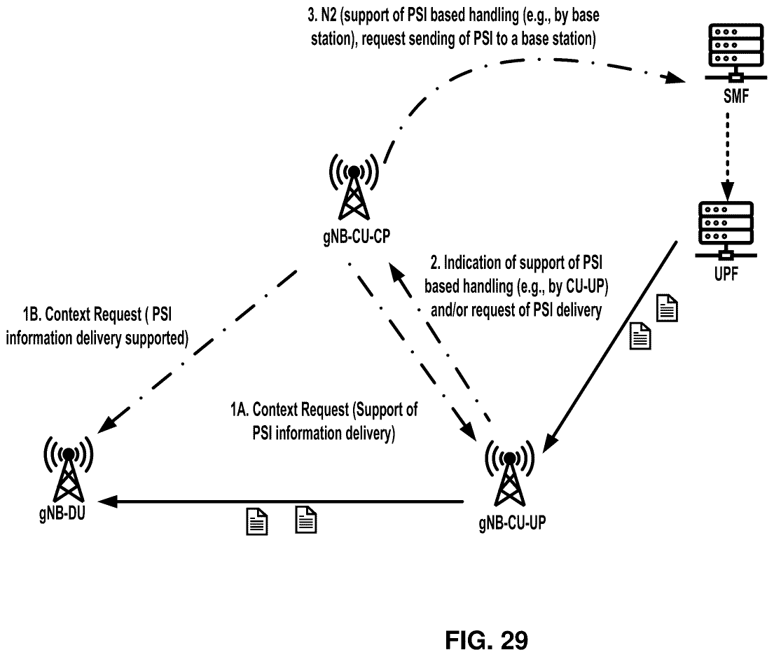

FIG. 29 illustrates an example as per an aspect of an embodiment of the present disclosure. In an example, a base station central unit control plane may exchange signalling with a base station central unit user plane, information associated with a PSI based handling. For brevity, based on the other part of the present disclosure, redundant details will be omitted.

In an example, the second base station (e.g., as shown in the previous figures) may be the base station central unit control plane (BS-CU-CP). For configuration of a multi-connectivity, the second base station may determine the one or more third base stations (e.g., as shown in the previous figures). For example, the one or more third base stations may be the base station central unit user plane (BS-CU-CP).

In an example, based on receiving the one or more first Xn messages, the second base station may determine to send one or more E1 messages to the one or more third base stations. For example, the one or more third base stations may handle one or more protocols. For example, the one or more protocols may not include at least one of a PHY protocol, a MAC protocol, a RLC protocol, and/or may include a PDCP protocol, and/or the like. For example, the one or more third base stations may receive one or more downlink packets (PDUs) from the one or more core network nodes. For example, the one or more core network nodes may comprise the user plane node.

For example, the one or more E1 messages may be at least one of gNB-CU-UP E1 setup request message, gNB-CU-UP E1 setup response message, gNB-CU-UP status indication message, gNB-CU-UP configuration update message, resource status response message, resource status request message, resource status update message, bearer context setup request message, bearer context setup response message, bearer context modification request message, bearer context modification required message, bearer context response message, bearer context modification confirmation message, notify message, data usage report, DL data notification message, and/or the like.

For example, the one or more E1 messages may comprise at least one of:
The one or more first configuration parameters. Each first configuration parameter of the one or more first configuration parameters may indicate configuration for each PDU session of one or more PDU sessions, and/or for each bearer of one or more bearers of the one or more PDU sessions. For example, the one or more bearer may be one or more SN terminated bearers, one or more SN terminated SCG bearers, and/or the like. For example, the each first configuration parameter may be for a downlink. The each first configuration parameter may indicate whether a network, a core network and/or the core network node supports the PSI based handling for the each PDU session and/or for the each bearer. Supporting the PSI based handling may be that delivery of the PSI information (e.g., marking of PSI information, and/or marking of PDU set information) for the each PDU session and/or for the each bearer from a user plane node (of the core network) to the one or more base stations (e.g., the third base station) are supported. Supporting the PSI based handling may be that delivery (e.g., sending by the user plane node and/or receiving by the third base station) of the PSI information for the each PDU session and/or for the each bearer to the one or more third base stations are supported. For example, for a 10^{th} PDU session of the one or more PDU sessions (and/or the one or more bearers), the one or more first configuration parameter may indicate that the PSI based handling is supported. For example, for a 11^{th} PDU session of the one or more PDU sessions (and/or the one or more bearers), the one or more first configuration parameter may indicate that the PSI based handling is not supported.
one or more second configuration parameters. Each second configuration parameter of the one or more second configuration parameters may be associated with the each PDU session and/or the each bearer of the one or more bearers of the each PDU session. Each second configuration parameter may indicate whether the network, the core network and/or the core network node supports delivery of a PDU set sequence information (e.g., PDU set information), and/or the like, for the each PDU session and/or for the each bearer. For example, when the core network node supports delivery of the PDU set sequence information, when the core network sends a PDU to a base station, the core network also sends the PDU set sequence information to the base station (e.g., the third base station). In some example, the first configuration parameter may be the second configuration parameter. In another example, the first configuration parameter may be different from the second configuration parameter.
one or more PDU session identifiers of the one or more PDU sessions.
one or more bearer identifiers of the one or more bearers of the one or more PDU sessions.
one or more timer values for PSI based discarding timer.
one or more indicators indicating whether PSI based SDU (and/or PDU) discard is started (e.g., activated) and/or stopped (deactivated) for uplink. This may indicate whether uplink PSI based SDU (and/or PDU) discard is configured or released for one or more bearers (e.g., DRBs). A codepoint “stop” may mean that UL PSI based discarding is released. Up to 8 DRBs can be set as “start”. The codepoint “start” means that UL PSI based discarding is (re)configured.
one or more indicators indicating whether PSI based SDU discard is configured or not configured for downlink direction. This may be the one or more first configuration parameters.
one or more QoS parameters indicating at least one of a UL PDU set QoS information and/or a DL PDU set QoS information. For example, the one or more QoS parameters may indicate a PSER (PDU set error rate) and/or a PSDB (PDU set delay budget) for the one or more PDU sets. For example, this may indicate whether PDU set integrated handling is required or not. For example, the PDU set integrated handling may indicate whether all PDUs of a PDU set need to be delivered or not.

In an example, the third base station of the one or more third base station may receive the one or more first E1 messages. When the third resource of the third base station is congested, the third base station may determine whether to send one or more report messages to the second base station (e.g., base station central unit, base station central unit control plane). Because the third base station receives the one or more first configurations parameters, the one or more second configuration parameters, the one or more indicators indicating whether PSI based SDU discard is started, the one or more indicators indicating whether PSI based discard is configured for downlink, and/or because the third resource is congested, the third base station may determine to send the one or more report messages. For example, the one or more report messages may be at least one of one or more second E1 messages. For example, the one or more second E1 messages may be at least one of gNB-CU-UP E1 setup request message, gNB-CU-UP E1 setup response message, gNB-CU-UP status indication message, gNB-CU-UP configuration update message, resource status response message, resource status request message, resource status update message, bearer context setup request message, bearer context setup response message, bearer context modification request message, bearer context modification required message, bearer context response message, bearer context modification confirmation message, notify message, data usage report, DL data notification message, and/or the like. For example, the one or more report messages may indicate whether PSI based discarding needs (e.g., suggested) to be activated and/or deactivated. Whether PSI based discarding needs (e.g., suggested) to be activated and/or deactivated may be whether activation of marking of PSI information is recommended or not, and/or whether activation of marking of PDU set information is recommended or not.

For example, the one or more report messages may comprise at least one of:
one or more third parameters. Each third parameter of the one or more third parameters may be associated with each PDU session and/or the bearer (e.g., the SN terminated SCG bearer) of the each PDU session. The each third parameter may indicate whether the PSI based handling for the each PDU session and/or the bearer is requested (e.g., marking of PSI information is recommended to be activated), whether the third base station configures the PSI based handling for the each PDU session and/or the bearer, whether the third base station supports the PSI based handling for the each PDU session and/or the bearer, and/or whether delivery of the PSI information is requested for the each PDU session and/or the bearer. For example, the third parameter may be used for downlink. For example, because the resource of the third base station is congested, because the third base station needs the PSI information, and/or the like, at least one of the one or more third parameters may indicate that delivery (marking) of the PSI information is requested (e.g., recommended) for the each PDU session and/or the bearer, that PSI based handling is configured and/or the bearer, that the PSI based handling for the bearer is active, that the third base station supports the PSI based handling, that the PSI handling starts (e.g., is activated), and/or the like. For example, the one or more third parameters may indicate that PSI information delivery is required for a 21st PDU session and/or that PSI information delivery is not required for a 22th PDU session. For example, the one or more third parameters may indicate a request for the core network (e.g., the core network node) and/or the second base station to send the PSI information to the one or more base stations (e.g., the one or more third base stations), and/or a request for the one or more base stations (e.g., the third base station) to receive the PSI information from the core network.
one or more fourth parameters. Each fourth parameter of the one or more fourth parameters may be associated with the each PDU session and/or the each bearer. Each fourth parameter may indicate whether the PDU set based handling for the each PDU session (and/or the each bearer) is requested, whether the third base station configures the PDU set based handling for the each PDU session (and/or the each bearer), whether the third base station supports the PDU set based handling for the each PDU session (and/or the each bearer), whether activation of marking of PDU set information is recommended, whether the third base station requests delivery of the PDU set sequence number delivery, and/or the like. For example, because the third base station is congested, because the third base station needs the PSI information, at least one of the one or more fourth parameters may indicate that delivery of the PDU set information is requested, that PDU set based handling is configured, that the PDU set based handling is active, that the PDU set based handling starts, and/or the like. In one example, the one or more fourth parameters may be the one or more third parameters.
one or more indicators indicating whether the third base station is congested or not, for the each PDU session (and/or the each bearer).
the one or more PDU session identifiers, for which PSI information is requested.
the one or more bearer identifiers, for which PSI information is requested.

In an example, the second base station may receive the one or more report messages. In response to receiving the one or more report messages, the second base station may send to the first base station (and/or to the core network), the one or more second Xn messages (as shown in previous figures).

In an example, the first base station may receive the second Xn message. In response to receiving the second Xn message, the first base station may send the second N2 message to the core network node.

Additionally and/or alternatively, in response to receiving the one or more second E1 messages, the second base station may send the second N2 message to the core network node.

Example embodiments of FIG. 29 may help for one or more base stations to determine whether one or more radio resource is congested, and whether to send a request for the PSI.

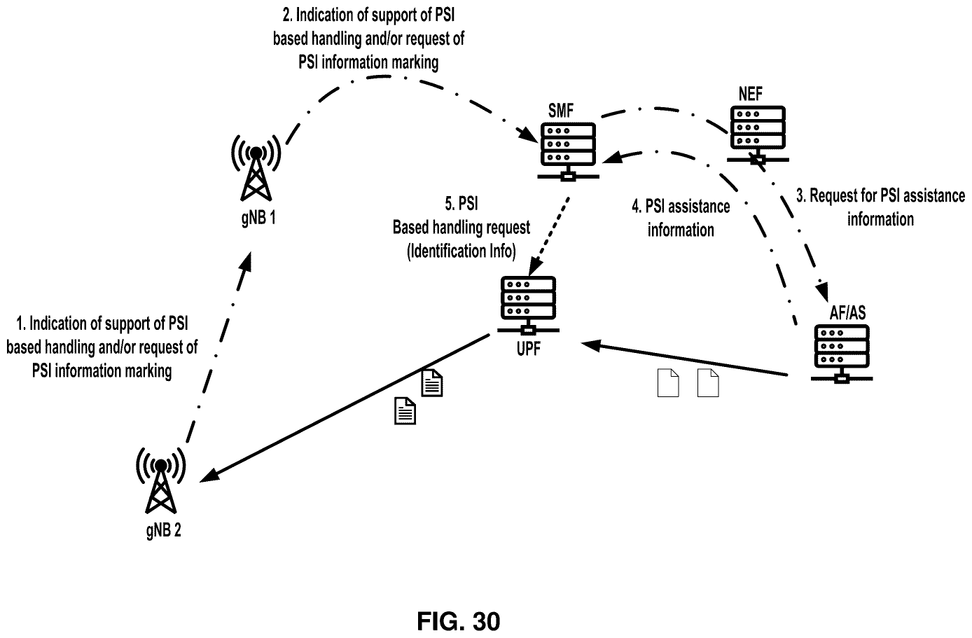

FIG. 30 illustrates an example as per an aspect of an embodiment of the present disclosure.

In an example, when the core network node (e.g., SMF) receives a request to deliver the one or more PSI information, the core network node may send a request for information for determining the one or more PSI information. For example, the information for determining the one or more PSI information may be a protocol description information. For example, the protocol description information may indicate one or more transport protocols, one or more fields of the one or more transport protocols, and/or whether one or more packets includes one or more fields for identifying the one or more PSI information.

For example, when the core network node receives the one or more second N2 messages, the core network node may not have information for determining the one or more PSI information. In this case, the core network node may send to a second node, a request for the protocol description information. In response to sending the request, the core network may receive the protocol description information. For example, the second node may be at least one of a NEF, a PCF, a UDM, an AF (application function). In an example, based on receiving the protocol description information, the core network node may send the protocol description information, to the user plane node. For example, the core network node may send a message to the user plane node. The message may comprise the protocol description information and/or a request to send the one or more PSI information to the one or more base stations. When the user plane node receives a packet (e.g., a PDU), the user plane node may determine a PSI information for the packet, based on the protocol description information. This may help for the one or more base stations acquires the one or more PSI information.

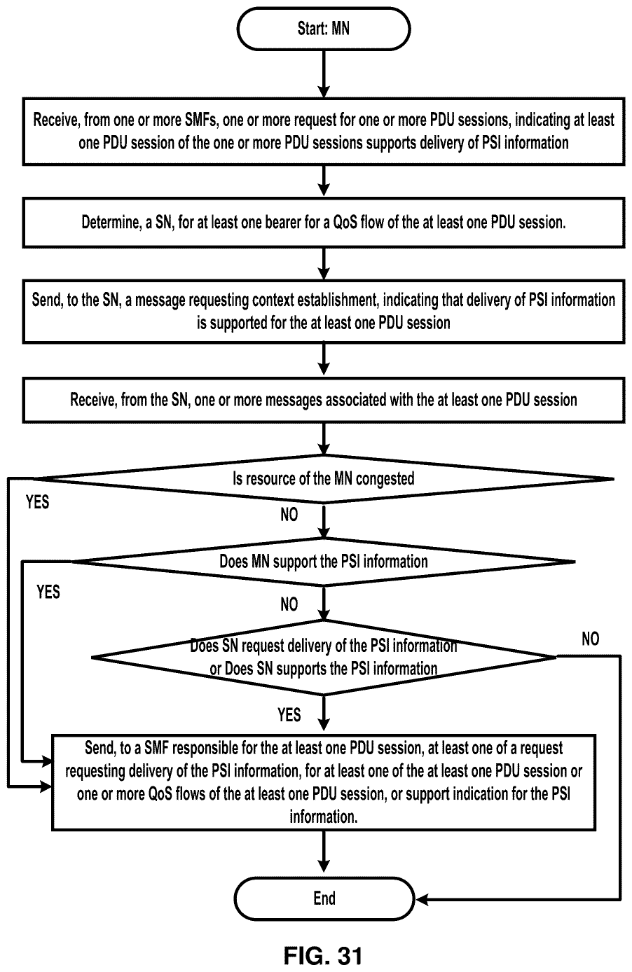

FIG. 31 illustrates an example as per an aspect of an embodiment of the present disclosure.

In an example, a first base station may receive, from one or more session management nodes, one or more request messages requesting resources for one or more sessions for a UE. For example, the first base station may be at least one of a gNB, an eNB, a 6G radio node, a base station central unit, a master node, and/or the like. For example, the one or more session management nodes may be at least one of one or more session management functions, one or more 6G session management nodes, and/or the like. For example, the one or more sessions may be at least one of one or more PDU sessions, one or more PDN connections, one or more sessions for data transfer, and/or the like. For example, the one or more request messages may comprise at least one of one or more identifiers of the one or more sessions, one or more first indicators, and/or the like. Each indicator of the one or more first indicators may be associated with each session of the one or more sessions. For example, each indicator may indicate whether delivery (e.g., marking) of the PSI information from a core network to one or more base stations are supported. For example, delivery of the PSI information may be delivering one or more GTP PDUs to an access network, wherein each GTP PDU of the one or more GTP PDUs may comprise a PDU (packet) of the each session and/or each PSI information for the PDU. For example, the each PSI information may be a PDU set information. For example, the each PDU set information may be for a PDU set of the PDU. For example, the each GTP PDU may comprise the each PDU set information. The each PDU set information may comprise the each PSI information. For example, at least one first indicator of the one or more first indicators may indicate that delivery (marking) of the PSI information is supported for a first session of the one or more sessions.

In an example, the first base station may configure a dual connectivity (e.g., multi connectivity) for the UE. For example, the first base station may determine to add, configure, and/or modify a second base station. For example, the second base station may be at least one of a second gNB, an second eNB, a second 6G radio node, a second base station central unit, a secondary node, and/or the like. For example, based on determining to add, configure and/or modify the second base station, the first base station may determine and/or select the second base station. In an example, the first base station may determine one or more bearers for the one or more sessions. For example, the one or more bearers may be a SN-terminated bearer, a SN-terminated SCG bearer and/or the like. For example, the one or more bearers may be a MN-terminated bearer, a MN-terminated SCB bearer, a MN-terminated split bearer, and/or the like. For example, the one or more bearers may be associated with one or more QoS flows of the one or more sessions. For example, the one or more bearers may be associated with one or more QoS flows of the first session.

In an example, based on determining the second base station and/or the one or more bearers, the first base station may send to the second base station, a message requesting at least one of addition of a SN, modification of the SN, context establishment, and/or the like. For example, the message may comprise one or more identifiers of the one or more bearers, one or more identifiers of the one or more session, the one or more first indicators, one or more second indicators and/or the like. For example, each second indicator may be associated with the each bearer of the one or more bearers. For example, each second indicator may indicate whether delivery (e.g., marking) of the PSI information is supported for each bearer. For example, the message may indicate that delivery of the PSI information is supported for a first bearer of the one or more bearers and/or the first session of the one or more sessions. For example, that delivery of the PSI information is supported may be that PSI based handling is supported, configured, and/or active. For example, that delivery of the PSI information is supported may be that delivery (e.g., marking) of a PDU set information is supported, and/or that the core network node supports delivery of the PSI information.

In an example, the first base station may receive from the second base station, one or more second messages. For example, the one or more second messages may be associated with at least one of the one or more bearers, and/or at least one of the one or more sessions. For example, a second message of the one or more second messages may indicate at least one of that the second base station requests delivery of the PSI information for the at least one of the one or more bearers and/or at least one of the one or more sessions, that the second base station supports handling of the PSI information, and/or that the second base station recommends activation of marking of the PSI information, that the second base station configures the PSI based handling and/or the like. That the second base station requests delivery of the PSI information may be that the second base station requests the core network node (the core network, the user plane node) sends one or more PSI information for one or more PDUs to the second base station. That the second base station requests delivery of the PSI information may be that the second base station requests receiving the one or more PSI information for the one or more PDUs from the core network node. That the second base station supports handling of the PSI information may be that the second base station is able to receive and/or send the one or more PSI information. That the second base station recommends activation of marking of the PSI information may be that the second base station recommends the first base station to request delivery of the PSI information, and/or to send request to the core network node, the delivery (marking) of the PSI information. In an example, delivery of the PSI information may be delivery of the PDU set information. In another example, delivery of the PDU set information may be different from the delivery of the PSI information. For example, when the first base station sends to the core network a first request requesting the PSI information and/or not send a second request requesting the PDU set information, the user plane node may provide the PSI information and/or may not provide e.g., PDU set sequence number information. In other example, when the first base station does not send to the core network the first request requesting the PSI information and/or sends the second request requesting the PDU set information, the user plane node may provide the PSI information and/or the PDU set sequence number information. That the second base station configures the PSI based handling may be that the second base station is able to receive the PSI information and/or that the second base station requests delivery of the PSI information and/or the like.

In an example, the first base station may receive the one or more second message.

In an example, if the first base station determines that a first resource of the first base station is congested, and/or based on the one or more second messages, the first base station may send to the core network node, a request message. For example, the request message may indicate at least one of that the second base station requests delivery (e.g., marking) of the PSI information for the at least one of the one or more bearers and/or at least one of the one or more sessions, that the second base station supports handling of the PSI information, that the second base station recommends activation of marking of the PSI information, that the second base station configures the PSI based handling, that the first base station requests delivery of the PSI information for the at least one of the one or more bearers and/or at least one of the one or more sessions, that the first base station supports handling of the PSI information, that the first base station recommends activation of marking of the PSI information, that the first base station configures the PSI based handling, that the one or more base stations (e.g., the first base station, the second base station, and/or the like) requests delivery of the PDU set information, that the one or more base stations supports PDU set based handling, that PDU set based handling is configured for the one or more base station, an identifier of the second base station, a resource information (e.g., IP address of the second base station, TEID) of the second base station, an identifier of the first base station, and/or a resource information (e.g., IP address, TEID) of the first base station, and/or the like.

In an example, if the first resource is not congested, if the first base station supports the delivery of the PSI information, if the first base station determines to request the delivery of the PSI information, and/or the like, the first base station may send the request message.

In an example, if the first resource is not congested, and/or based on the one or more second messages, the first base station may send the request message. In an example, if the first resource is not congested, if the first base station supports delivery of the PSI information (e.g., receiving the PSI information), and/or based on the one or more second messages, the first base station may send the request message.

In an example, if the second message indicates at least one of that the second base station requests delivery of the PSI information for the at least one of the one or more bearers and/or at least one of the one or more sessions, that the second base station supports handling of the PSI information, and/or that the second base station recommends activation of the PSI information, that the second base station configures the PSI based handling and/or the like, the first base station may send the request message.

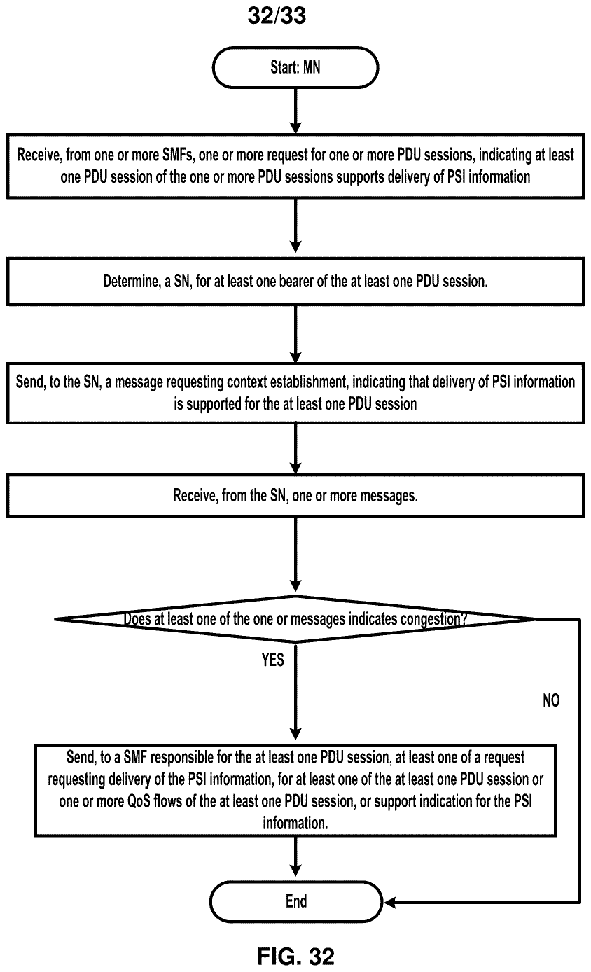

FIG. 32 illustrates an example as per an aspect of an embodiment of the present disclosure.

In an example, a master node (MN) may receive from one or more SMFs, one or more establishment requests for one or more resources for one or more PDU sessions. The one or more establishment requests may indicate at least one PDU session of the one or more PDU sessions supports delivery of a PSI information.

In an example, the MN may determine a secondary node (SN) for the at least one PDU session and/or for at least one bearer (e.g., radio bearer, data bearer, logical channel) of the at least one PDU session.

In an example, the MN may send to the SN, a message requesting context establishment (and/or SN addition, SN modification) for a UE. The message may indicate that the delivery of the PSI information (e.g., from core node to base station) is supported for the at least one PDU session and/or for the at least one bearer.

In an example, the MN may receive from the SN, one or more messages. For example, the MN may determine whether the one or more messages indicates at least one of congestion of the SN, recommendation for delivery of the PSI information, configuration of the delivery of the PSI information, configuration of PSI based discarding, support of the SN for the PSI based handling, and/or the like.

For example, based on the one or more messages, the MN may send a request message to the SMF. For example, the request message may be a PDU session resource modification request, status report, and/or the like. For example the request message may indicate at least one of that, for the at least one PDU session and/or for the at least one bearer, that the MN (and/or the SN) requests a core network (and/or a UPF) to send one or more PSI information for the one or more PDUs, to the MN (and/or the SN), that the MN (and/or the SN) request the core network to send one or more PDU set information for the one or more PDUs to the MN (and/or the SN), that MN (and/or the SN) supports the PSI based handling, that the MN (and/or the SN) supports PDU set based handling, that MN (and/or the SN) requests activation of PSI information marking, and/or the like.

In one example, using a first indication for the PDU set based handling and a second indication for the PSI based handling may help for a node to determine whether to send PSI information and/or whether to send the PDU set information (e.g., PDU set sequence number). In another example, using a third indication for the PDU set based handling and for the PSI based handling may help in reducing signalling and/or when a node wants to request both information.

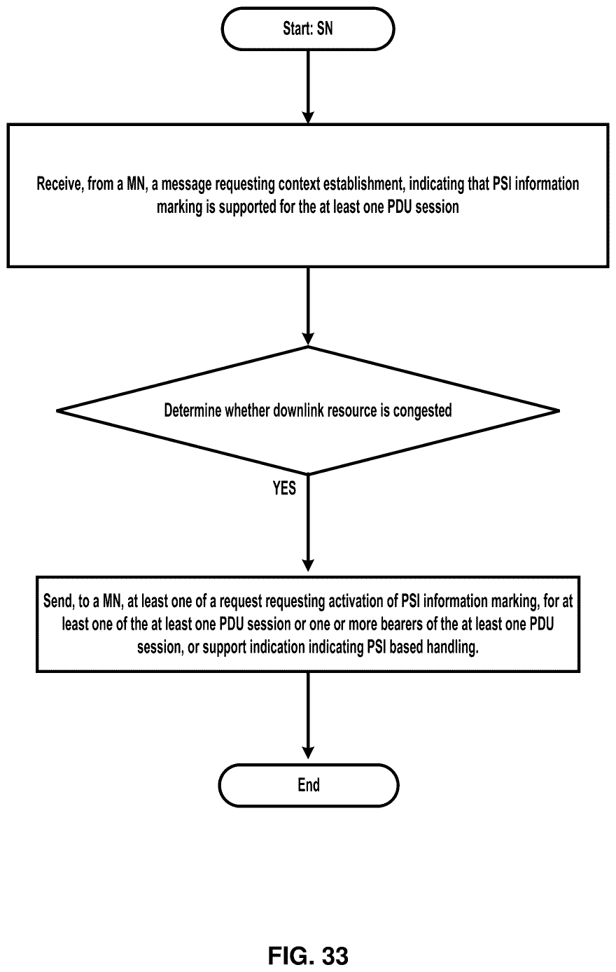

FIG. 33 illustrates an example as per an aspect of an embodiment of the present disclosure.

In an example, a second base station may receive from a first base station, a first message. For example, the second base station may be at least one of a SN, a BS-CU-UP, a BS-DU. For example, the first base station may be a MN, a BS-CU-CP, BS-CU. For example, the first message may be at least one of SN addition request, a SN modification request message, a context establishment request message, a context modification message, and/or the like. For example, the first message may comprise at least one of a PSI information marking support indicator, a PDU set information marking support indicator, a PDU set sequence number marking support indicator, and/or the like. In an example, the PSI information marking support indicator may be the PDU set information marking support indicator.

In an example, the second base station may determine whether the second base station supports PSI based handling, whether PSI based handling is configured, and/or the like. For example, based on the determination, the second base station may send to the first base station, a response message to the first message. The response message may indicate at least one of that the second base station supports requesting activation/deactivation of PSI marking, that the second base station supports requesting activation/deactivation of the PDU set information marking, that the second base station configures PSI based handling for one or more bearers for one or more PDU session, that the second base station configures PDU set based handling for one or more bearers for one or more PDU session, and/or the like.

In an example, the second base station may determine whether a resource of the second base station is congested. For example, if the second base station determines that the resource of the second base station is congested, the second base station may send to the first base station, a second message indicating at least one of a PSI information marking activation request indicator, a PDU set information marking activation request indicator, a PDU set sequence number marking activation request indicator, and/or the like. In an example, the PSI information marking activation request indicator may be the PDU set information marking activation request indicator. For example, the second message may be for a bearer. For example, the bearer may be a SCG bearer, a SN terminated bearer, a SN terminated SCG bearer, and/or the like. For example, the second message may be sent via a Xn-C interface, a Xn-AP interface, a Xn-AP protocol, and/or the like.

In an example, the second base station may determine whether a resource of the second base station is congested. For example, if the second base station determines that the resource of the second base station is no more congested, the second base station may send to the first base station, a third message indicating at least one of a PSI information marking deactivation request indicator, a PDU set information marking deactivation request indicator, a PDU set sequence number marking deactivation request indicator, and/or the like.

In one example, an embodiment may comprise; receiving, by a first base station (BS) from a second BS, a message requesting addition of a secondary node, wherein the message: comprises one or more parameters for one or more protocol data unit (PDU) sessions; and indicates that PDU set importance (PSI) information marking is supported by a core network node for at least one PDU session of the one or more PDU sessions; determining, by the first BS, that downlink resources of the first BS are congested; and in response to the determining, sending by the first BS to the second BS, one or more messages comprising at least one of: a first indication indicating that the first BS requests activation of the PSI information marking; or a second indication indicating the PSI based handling is configured.

In one example, an embodiment may comprise; determining, by a first base station (BS), that resources of the first BS is congested; and sending, by the first BS to a second BS and based on the determining, one or more messages comprising at least one of: a first indication indicating that the first BS requests activation of the PSI information marking; or a second indication indicating the PSI based handling is configured..

In one example, an embodiment may comprise; sending, by a first base station (BS), one or more messages comprising a first indication indicating that the first BS supports handling of protocol data unit (PDU) set importance (PSI) information.

In one example, an embodiment may comprise; receiving, by a first base station (BS) from a second BS, a message requesting addition of a secondary node, wherein the message: comprises one or more parameters for one or more protocol data unit (PDU) sessions; and indicates that delivery of PDU set importance (PSI) information is supported by a core network node for at least one PDU session of the one or more PDU sessions; determining, by the first BS, that downlink resources of the first BS are congested; and in response to the determining, sending by the first BS to the second BS, one or more messages comprising at least one of: a first indication indicating that the first BS supports the PSI information; or a second request to receive the PSI information of the at least one PDU session.

In one example, an embodiment may comprise; determining, by a first base station (BS), that resources of the first BS is congested; and sending, by the first BS to a second BS and based on the determining, one or more messages comprising at least one of: a first indication indicating that the first BS supports protocol data unit (PDU) set importance (PSI) information; and a second request to receive the PSI information.

In one example, an embodiment may comprise; sending, by a first base station (BS) to a second BS, one or more messages comprising a first indication indicating that the first BS supports protocol data unit (PDU) set importance (PSI) information.

In an example, the embodiment may further comprises receiving by the first BS, a first message comprising one or more parameters for one or more PDU sessions. In the embodiment, the one or more parameters may indicate that the PSI information is supported for at least one PDU session of the one or more PDU sessions. In the embodiment, the first message may be at least one of a secondary node (SN) addition request message, SN modification request message. In the embodiment, t one or more parameters may further comprise at least one of a first parameter indicating whether a PDU set handling is supported, a second parameter indicating a PDU set quality of service (QoS). In the embodiment, the one or more parameters may indicate that a second PDU session does not support the PSI information and that a first PDU session supports the PSI information. In the embodiment, the PSI information may be supported for a first quality of service (QoS) flow of the one or more PDU sessions and may not be supported for a second QoS flow of the one or more PDU sessions.

In an example, the embodiment may further comprise determining by the first BS, that downlink resources of the first BS is congested.

In the embodiment, the first BS may determine, based on the one or more parameters, to request the PSI information for the at least one PDU session.

The embodiment may further comprise receiving by the first BS from a third BS, one or more interface messages, wherein the one or more interface messages comprise an indication indicating that the third BS supports protocol data unit (PDU) set importance (PSI) information or a request requesting the PSI information.

In the embodiment, the first BS may determine to request the PSI information, based on the one or more interface messages.

In the embodiment, the second BS may be at least one of a BS distributed unit (DU) or a BS central unit (CU) user plane (UP) and the first BS is a BS CU control plane (CP). the first BS may receive one or more second PDUs of a second PDU set of the second PDU session.

In the embodiment, the first BS may not receive a second PSI information for the one or more second PDUs. The first BS may receive the first PSI information from at least one of a user plane function (UPF) and a 6G gateway.

In the embodiment, the first BS may receive one or more second PDUs of a second PDU set of the second PDU session.

In the embodiment, the first BS may discard the one or more first PDUs based on the first PSI information.

In an example, in the embodiment, the one or more messages may further comprise an information indicating whether a PDU set integrated handling information is supported. When the PDU set integrated handling information is supported, the first BS may receive a PDU with a PDU set information indicating the PDU set to which the PDU belong.

In an example, the embodiment may further comprise, receiving by the first BS and based on sending the one or more messages, one or more first PDUs of a first PDU set with a first PSI information of the first PDU set, for the at least one PDU session. The first PSI information may comprise a value indicating an importance of the first PDU set. The first BS may receive one or more GTP containers comprising the one or more first PDUs and the first PSI information.

In an example, in the embodiment, that the first BS supports the PSI information may be at least one of that the first BS supports the PSI information based handling, that the first BS configures the PSI information based handling, that the first BS configures the PSI information based discarding, that the first BS supports the PSI information based discarding, that the first BS supports the PSI information based congestion control, that the first BS requests delivery of the PSI information.

In one example, an embodiment may comprise; sending, by a second base station (BS) to a first BS, one or more messages comprising a third support indication indicating that delivery of a protocol data unit (PDU) set importance (PSI) information is supported for at least one PDU session of the one or more PDU sessions of a wireless device.

In an example, the embodiment may further comprise receiving by the second BS, a message requesting delivery of the PSI information.

In an example, the embodiment may further comprise sending by the second BS to a node managing the at least one PDU session, a request message requesting delivery of the PSI information.

In an example, an embodiment may comprise: sending, by a second base station (BS) to a third BS, a message requesting handover preparation for at least one protocol data unit (PDU) session of the one or more PDU sessions of a wireless device; and receiving, by the second BS from the third BS, a response message acknowledging the handover, wherein the response message indicates whether the third BS supports PDU set importance (PSI) information.

In one example, in the embodiment, the message may comprise an indication indicating whether delivery of the PSI information is activated.

In one example, an embodiment may comprise: receiving, by a third base station (BS) from a second BS, a message requesting handover preparation for at least one protocol data unit (PDU) session of the one or more PDU sessions of a wireless device; and sending, by the third BS to a core network node, a request message requesting switch of a path, wherein the request message indicates whether the third BS supports PDU set importance (PSI) information.

In one example, the embodiment may comprise: receiving by the third BS from the core network node, a response message indicating acknowledgment of the switch of the path, wherein the response message indicates whether delivery of the PSI information is supported.

In one example, in the embodiment, the request message may comprise a second request requesting delivery of the PSI information.

In one example, in the embodiment, the message may comprise an indication indicating whether delivery of the PSI information is activated.

In one example, in the embodiment, the response message may indicate whether the delivery of the PSI information is activated.

In one example, the embodiment may comprise: sending, by a base station (BS) central unit (CU) to one or more BS distributed units (DUs), one or more message requesting establishment of one or more contexts, for at least one protocol data unit (PDU) session of one or more PDU sessions of a wireless device; and receiving, by the BS-CU from at least one BS-DU of the one or more BS-DUs, a message comprising at least one of: a first indication indicating that the at least one BS-DU supports PDU set importance information; and a second request requesting activation of delivery of the PSI information for the at least one PDU session.

In one example, in the embodiment, the one or more messages may indicate that marking of the PSI information is supported for the at least one PDU session.

In one example, the embodiment may comprise: sending, by a base station (BS) central unit (CU) control plane (CP) to one or more BS CU user plane (UPs), one or more message requesting establishment of one or more contexts, for at least one protocol data unit (PDU) session of one or more PDU sessions of a wireless device; and receiving, by the BS-CU-CP from at least one BS-CU-UP of the one or more BS-CU-UPs, a message comprising at least one of: a first indication indicating that the at least one BS-CU-UP supports PDU set importance information; and a second request requesting activation of delivery of the PSI information for the at least one PDU session.

In one example, the embodiment may comprise: sending, by a first base station (BS) to a second BS, one or more messages comprising a first indication indicating that the first BS recommends activation of marking of protocol data unit (PDU) set importance (PSI) information.

In one example, the embodiment may comprise receiving by the first BS, a first message comprising one or more parameters for one or more PDU sessions.

In the embodiment, the one or more parameters may indicate that marking of the PSI information is supported for at least one PDU session of the one or more PDU sessions.

In the embodiment, the first message may be at least one of a secondary node (SN) addition request message, SN modification request message.

In the embodiment, the one or more parameters may further comprise at least one of a first parameter indicating whether a PDU set handling is supported, a second parameter indicating a PDU set quality of service (QoS).

In the embodiment, the first BS may send the one or more messages via inter base station control plane interface.

In the embodiment, the one or more messages further may comprise one or more identifiers of one or more bearers.

In the embodiment, the one or more bearers may be at least one of one or more SN-terminated bearers, one or more SN-terminated SCG bearers, and/or the like.

In the embodiment, the one or more messages may indicate that marking of the PSI information is supported for the at least one PDU session.

In the present disclosure, any two or more than two of the following sentences, paragraphs, (sub)-bullets, points, actions, behaviors, terms, alternatives, aspects, examples, or claims described in the following invention(s) may be combined logically, reasonably, and properly to form a specific method.

In the present disclosure, any sentence, paragraph, (sub)-bullet, point, action, behaviors, terms, alternatives, aspects, examples, or claims described in the following invention(s) may be implemented independently and separately to form a specific method.

In the present disclosure, dependency, such as “based on”, “more specifically”, “preferably”, “in one embodiment”, “in one alternative”, “in one example”, “in one aspect”, “in one implementation”, etc., in the present disclosure is just one possible example which would not restrict the specific method.

In the present disclosure, it should be understood that any discussion of operations from the perspective of wireless device may also be applied to a base station. Reciprocal operations may not be stated explicitly for each and every operation, although it is implied and a part of the present disclosure. For example, when the present disclosure describes one or more embodiments in which a transmitter device (e.g., a wireless device or a base station) transmits a signal, a receiver device (e.g., a wireless device or a base station) receives the signal. Reciprocal determinations and/or timer operations may occur to ensure alignment between operations of the transmitter device and receiver device. Furthermore, as an example of reciprocal operations, a wireless device may determine a time to transmit a signal based on a grant and a base station may determine the time to receive the signal and/or determine the time to schedule the signal for the wireless device to transmit via the grant. Similarly, as another reciprocal operation, if a receiver device (e.g., a wireless device or a base station) monitors for a signal or monitors a channel, a transmitter device (e.g., a wireless device or a base station) transmits the signal or transmits the channel.

1. A method comprising:
sending, by a first base station (BS), a first parameter indicating that the first BS configures protocol data unit (PDU) set importance (PSI) based discarding, for a PDU session, of a wireless device, terminated at the first BS;
determining, by the first BS, that resources of the first BS are congested, for the PDU session; and
sending, by the first BS to a second BS and based on the determining, a general packet radio service tunneling protocol (GTP) message comprising a second parameter indicating activation of PSI based discarding for the PDU session.

2. The method of claim 1, further comprising receiving by the first BS, one or more first messages comprising one or more parameters for the PDU session, among one or more PDU sessions of the wireless device, wherein the PDU session is terminated at the first BS.

3. The method of claim 2, wherein the one or more first messages is at least one of a secondary node (SN) addition request message, SN modification request message, a handover request message, XN-U address indication.

4. The method of claim 2, wherein the one or more parameters further comprises one or more PDU set quality of service (QoS) parameters, wherein the one or more PDU set QoS parameters comprises at least one of PDU set error rare or PDU set delay budget, associated with the PDU session.

5. The method of claim 2, wherein the one or more PDU sessions comprises a second PDU session terminated at the second BS.

6. The method of claim 1, wherein the PSI based discarding is discarding one or more second PDUs of a second PDU for a downlink, based on a second PSI information of the second PDU set.

7. The method of claim 1, wherein a PDU set is one or more PDUs comprising one data unit, one or more data units, generated by an application.

8. A first base station (BS) comprising one or more processors and memory storing instructions that, when executed by the one or more processors, cause the first BS to:
send a first parameter indicating that the first BS configures protocol data unit (PDU) set importance (PSI) based discarding, for a PDU session, of a wireless device, terminated at the first BS;
determine that resources of the first BS are congested, for the PDU session; and
sending, by the first BS to a second BS and based on the determining, a general packet radio service tunneling protocol (GTP) message comprising a second parameter indicating activation of PSI based discarding for the PDU session.

9. The first BS of claim 8, wherein the operations further cause the first BS to receive one or more first messages comprising one or more parameters for the PDU session, among one or more PDU sessions of the wireless device, wherein the PDU session is terminated at the first BS.

10. The first BS of claim 9, wherein the one or more first messages is at least one of a secondary node (SN) addition request message, SN modification request message, a handover request message, XN-U address indication.

11. The first BS of claim 9, wherein the one or more parameters further comprises one or more PDU set quality of service (QoS) parameters, wherein the one or more PDU set QoS parameters comprises at least one of PDU set error rare or PDU set delay budget, associated with the PDU session.

12. The first BS of claim 9, wherein the one or more PDU sessions comprises a second PDU session terminated at the second BS.

13. The first BS of claim 8, wherein the PSI based discarding is discarding one or more second PDUs of a second PDU for a downlink, based on a second PSI information of the second PDU set.

14. The first BS of claim 8, wherein a PDU set is one or more PDUs comprising one data unit, one or more data units, generated by an application.

15. A non-transitory computer readable medium storing instructions that, when executed by one or more processors of a first base station (BS), cause the first BS to:
send a first parameter indicating that the first BS configures protocol data unit (PDU) set importance (PSI) based discarding, for a PDU session, of a wireless device, terminated at the first BS;
determine that resources of the first BS are congested, for the PDU session; and
sending, by the first BS to a second BS and based on the determining, a general packet radio service tunneling protocol (GTP) message comprising a second parameter indicating activation of PSI based discarding for the PDU session.

16. The non-transitory computer readable medium of claim 15, wherein the operations further cause the first BS to receive one or more first messages comprising one or more parameters for the PDU session, among one or more PDU sessions of the wireless device, wherein the PDU session is terminated at the first BS.

17. The non-transitory computer readable medium of claim 16, wherein the one or more first messages is at least one of a secondary node (SN) addition request message, SN modification request message, a handover request message, XN-U address indication.

18. The non-transitory computer readable medium of claim 16, wherein the one or more parameters further comprises one or more PDU set quality of service (QoS) parameters, wherein the one or more PDU set QoS parameters comprises at least one of PDU set error rare or PDU set delay budget, associated with the PDU session.

19. The non-transitory computer readable medium of claim 16, wherein the one or more PDU sessions comprises a second PDU session terminated at the second BS.

20. The non-transitory computer readable medium of claim 15, wherein the PSI based discarding is discarding one or more second PDUs of a second PDU for a downlink, based on a second PSI information of the second PDU set.
